(19) United States
(12) Patent Application Publication
(10) Pub. No.: US 2025/0244566 A1
(43) Pub. Date: Jul. 31, 2025

(54) ZOOM LENS

(71) Applicant: SIGMA CORPORATION, Kanagawa (JP)

(72) Inventor: Hiromichi OCHIAI, Tokyo (JP)

(73) Assignee: SIGMA CORPORATION, Kanagawa (JP)

(21) Appl. No.: 19/032,663

(22) Filed: Jan. 21, 2025

(30) Foreign Application Priority Data
Jan. 29, 2024 (JP) 2024-010824

(51) Int. Cl. G02B 15/14

(52) U.S. Cl. CPC G02B 15/1441

(57) ABSTRACT

Provided is a zoom lens that has a large aperture ratio, has a suppressed total length, has a small center of gravity movement during zooming or focusing, and can perform quiet auto focus, and that is suitable for video capturing. A zoom lens has, in order from an object side: a first lens group G1 having a negative refractive power; a middle lens group GM having a positive refractive power as a whole; a rear lens group GR; and a final lens group GN. The middle lens group GM includes three or more lens groups and includes a focus lens group that moves along an optical axis during focusing from infinity to a short distance. The rear lens group GR includes one or more lens groups. A distance between each of the groups changes during zooming from a wide-angle end to a telephoto end.

### TECHNICAL FIELD

The present invention relates to a zoom lens used in a digital camera, a video camera, or the like.

### BACKGROUND ART

In recent years, capturing of a video using an interchangeable lens camera has become common. In order to perform comfortable video capturing, it is desirable that a movement of a center of gravity in the lens during zooming or focusing is small. In addition, since the motor sound may be recorded in a case where the driving sound of the motor during the auto focus is loud, it is also important to be able to perform quiet auto focus.

As an interchangeable lens for a single-lens camera, a zoom lens with large aperture ratio having a bright maximum aperture is popular because it has both the convenience of a zoom lens and a bright maximum aperture. In addition, in recent years, a large format camera having a large sensor size and excellent image quality has been popular, and a zoom lens with large aperture ratio compatible with the large format camera is desired.

Examples of the zoom lens having a large aperture ratio include zoom lenses disclosed in the following Patent Documents.

### RELATED ART DOCUMENT

### Patent Document

[Patent Document 1] WO2016/121939A
[Patent Document 2] JP2019-015956A

### SUMMARY OF THE INVENTION

### Problem that the Invention is to Solve

Patent Document 1 discloses a negative dominant zoom lens with large aperture ratio in which a maximum aperture is brightened to about F2.8. However, since the number of lenses in the focus lens group is large and the lenses are heavy, it is difficult to realize quick and quiet auto focus. In addition, in a case where the total length of the optical system is long and further increase in aperture ratio is pursued, the zoom lens would become huge, which is not practical.

Patent Document 2 discloses a positive-dominant zoom lens with large aperture ratio in which a maximum aperture is brightened to about F2. However, since the first lens group having a large diameter and a heavy weight is extended due to the zooming, the movement of the center of gravity is large, which affects the operability during the video capturing, which is not preferable.

The present invention has been made in view of such circumstances, and an object of the present invention is to provide a zoom lens that has a suppressed total length while having a large aperture ratio, has a small movement of the center of gravity during zooming and focusing, is capable of quiet auto focus, and is suitable for video capturing.

### Means for Solving the Problem

A zoom lens includes, in order from an object side: a first lens group G1 having a negative refractive power; a middle lens group GM having a positive refractive power as a whole; a rear lens group GR; and a final lens group GN, in which the middle lens group GM includes three or more lens groups and includes a focus lens group that moves along an optical axis during focusing from infinity to a short distance, the rear lens group GR includes one or more lens groups, a distance between each of the groups changes during zooming from a wide-angle end to a telephoto end, the middle lens group GM moves toward the object side, and a distance between the middle lens group GM and the rear lens group GR is widened, and the first lens group G1 and the final lens group GN are fixed in any of zooming and focusing.

### Advantage of the Invention

According to the present invention, it is possible to provide a zoom lens that has a large aperture ratio while having a suppressed total length, has a small movement of the center of gravity during zooming or focusing, is capable of quiet auto focus, and is suitable for video capturing.

### BRIEF DESCRIPTION OF THE DRAWINGS

FIG. 1 is a lens configuration diagram at a wide-angle end and during focusing on infinity in Example 1.

FIG. 2 is a longitudinal aberration diagram at a wide-angle end and during focusing on infinity in Example 1.

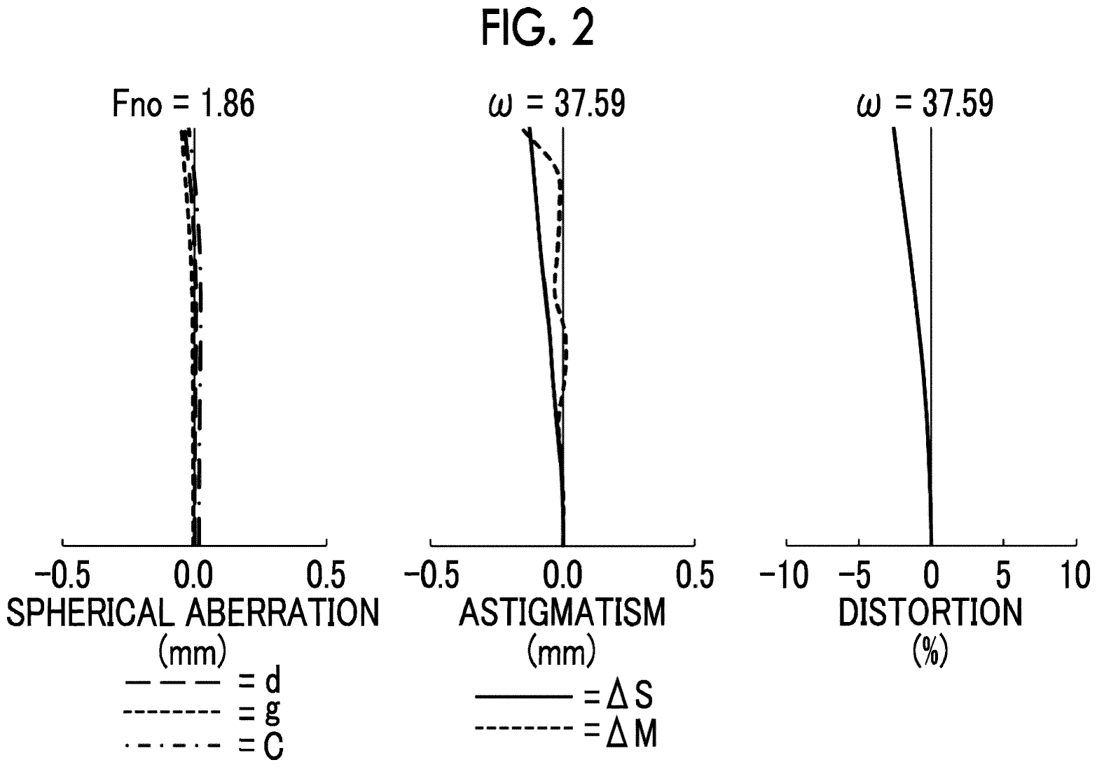

FIG. 3 is a longitudinal aberration diagram at a wide-angle end and a focusing distance of 1275 mm in Example 1.

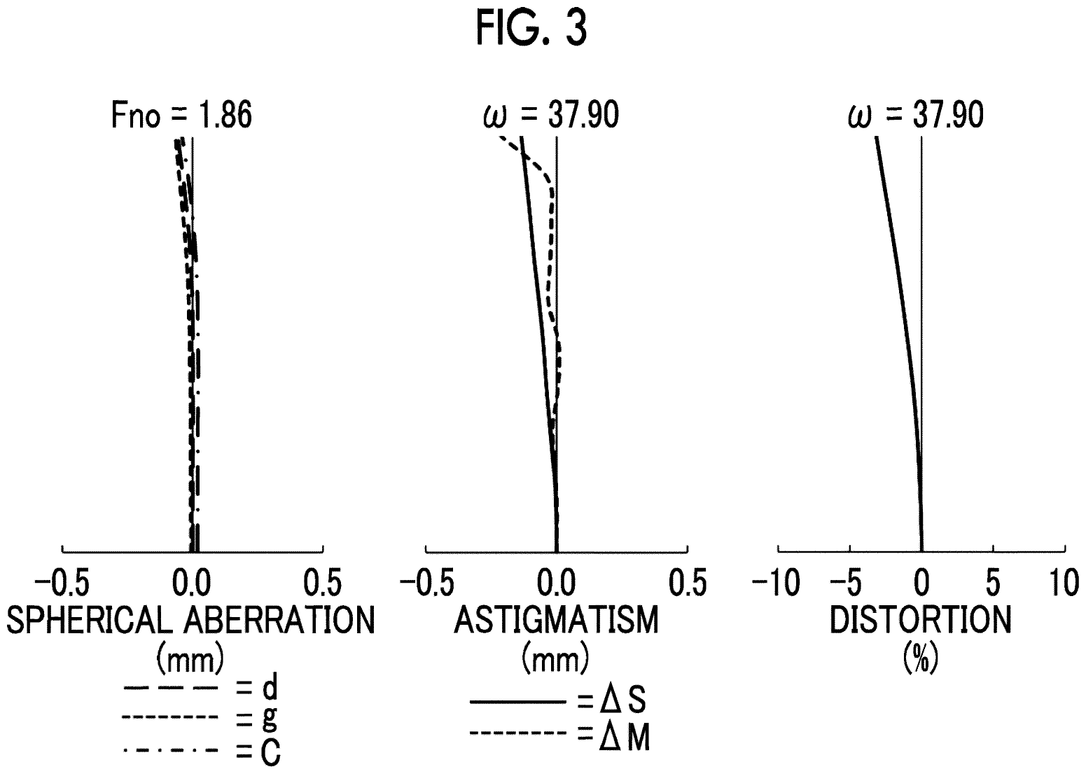

FIG. 4 is a lateral aberration diagram at a wide-angle end and during focusing on infinity in Example 1.

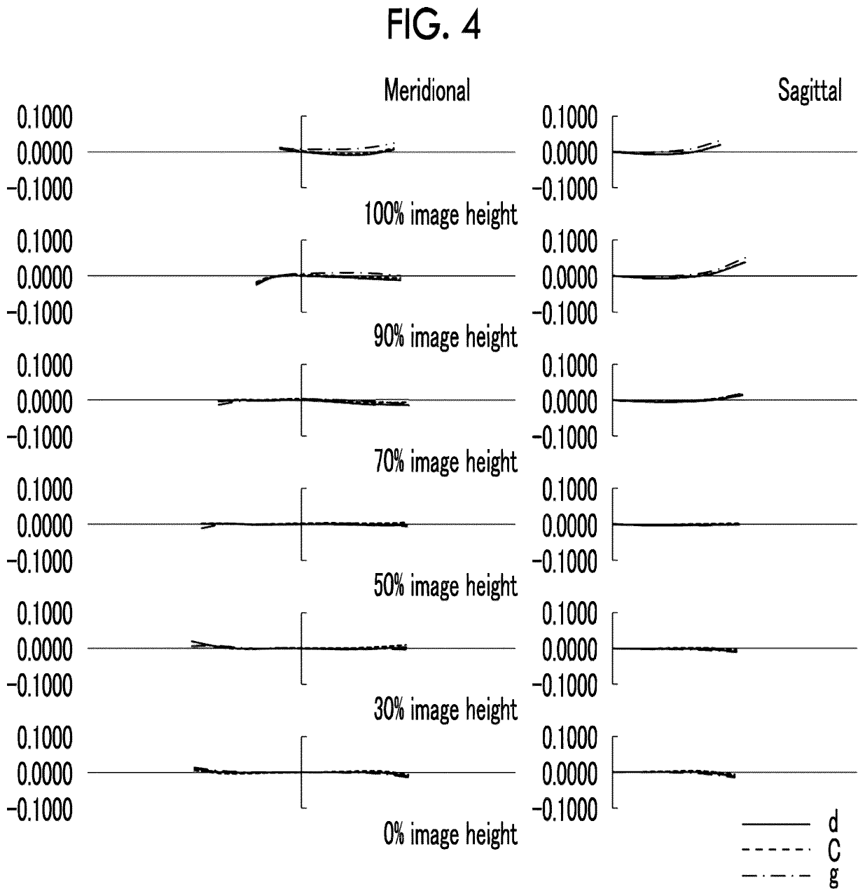

FIG. 5 is a lateral aberration diagram at a wide-angle end and a focusing distance of 1275 mm in Example 1.

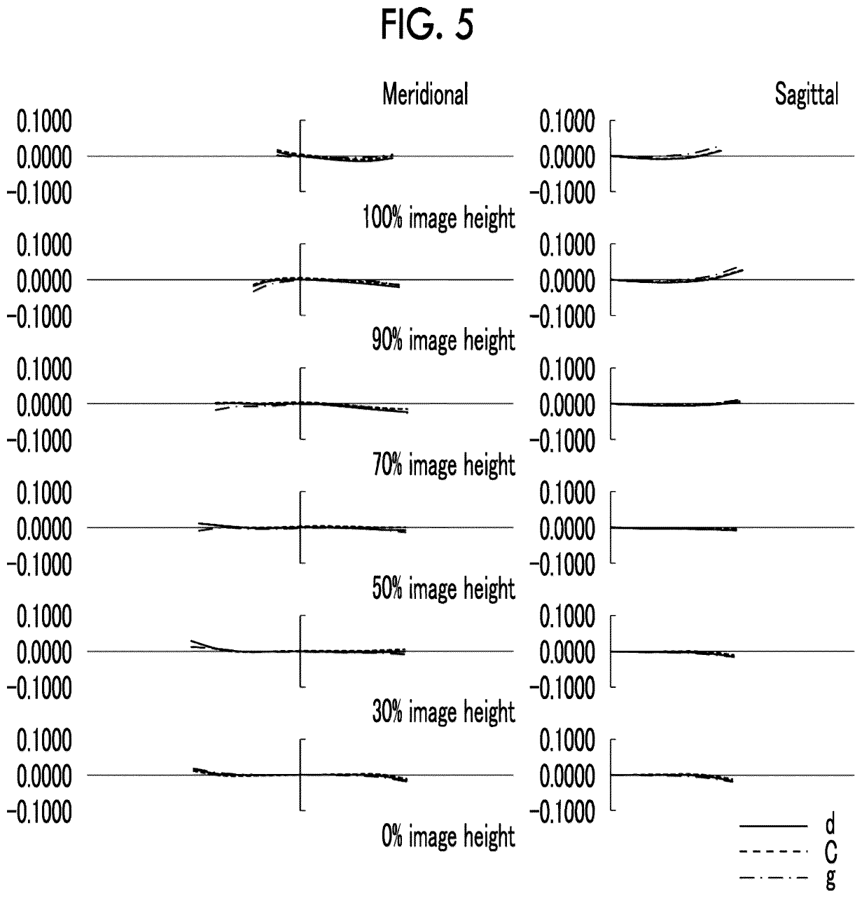

FIG. 6 is a longitudinal aberration diagram at a middle focal length and during focusing on infinity in Example 1.

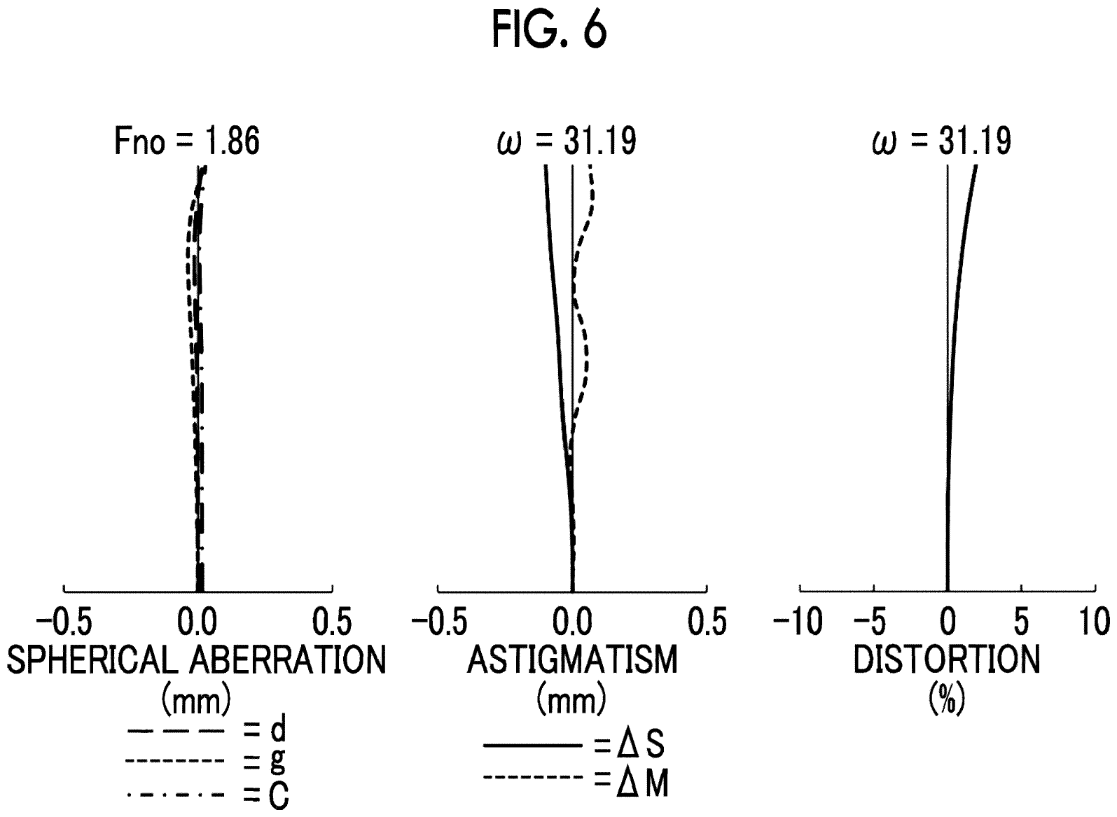

FIG. 7 is a longitudinal aberration diagram at the middle focal length and a focusing distance of 1523 mm in Example 1.

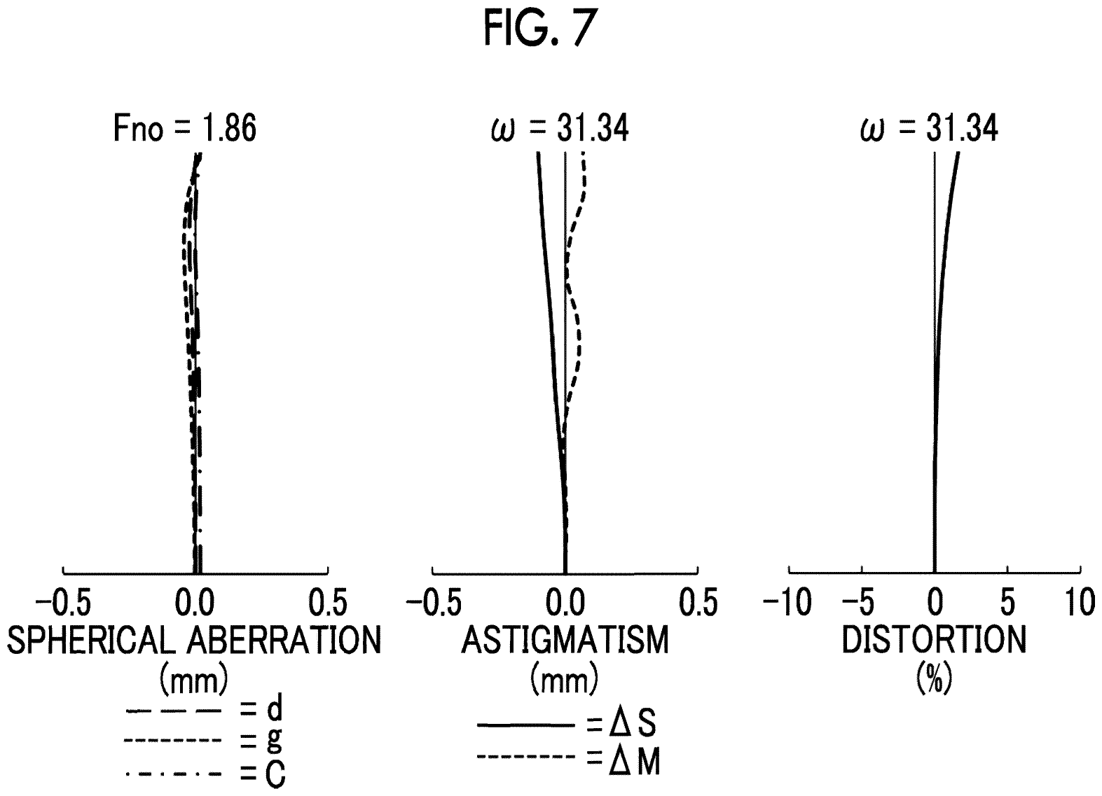

FIG. 8 is a lateral aberration diagram at the middle focal length and during focusing on infinity in Example 1.

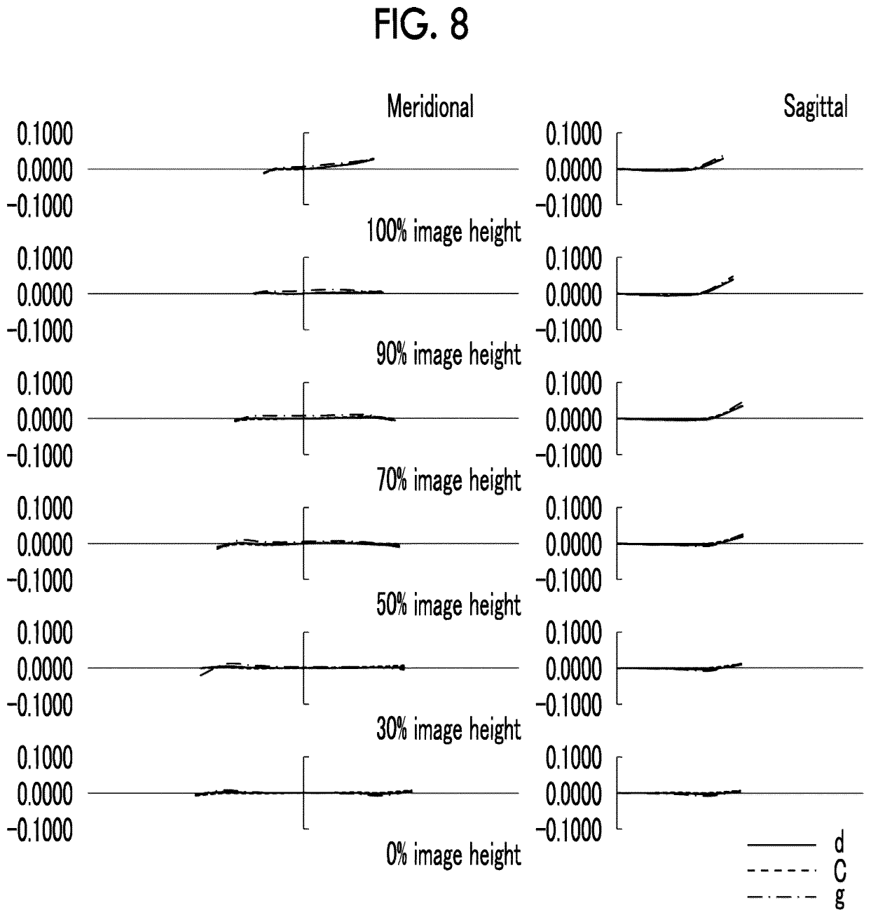

FIG. 9 is a lateral aberration diagram at the middle focal length and a focusing distance of 1523 mm in Example 1.

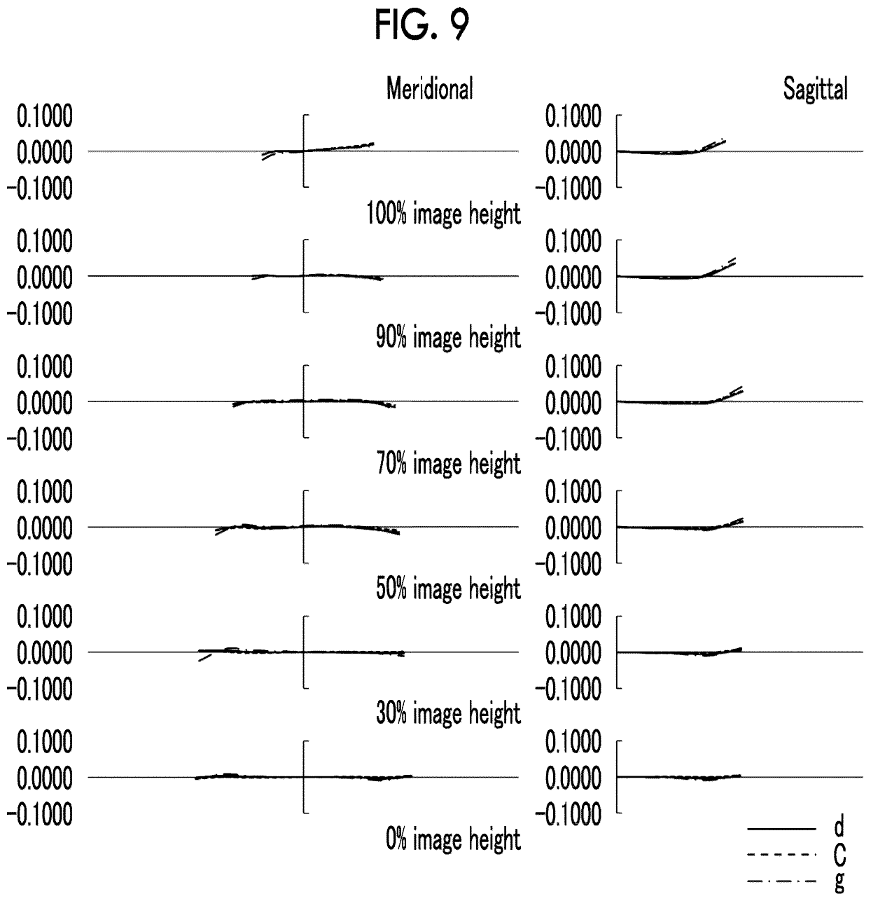

FIG. 10 is a longitudinal aberration diagram at a telephoto end and during focusing on infinity in Example 1.

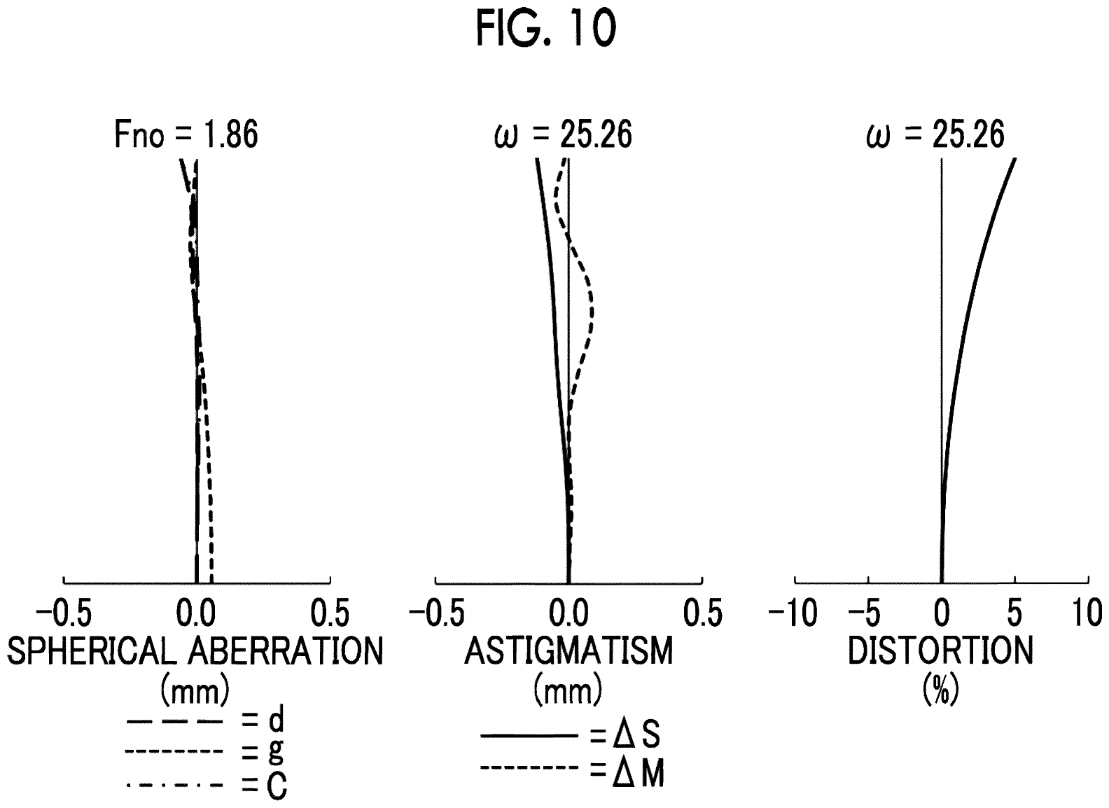

FIG. 11 is a longitudinal aberration diagram at the telephoto end, a focusing distance of 1869 mm in Example 1.

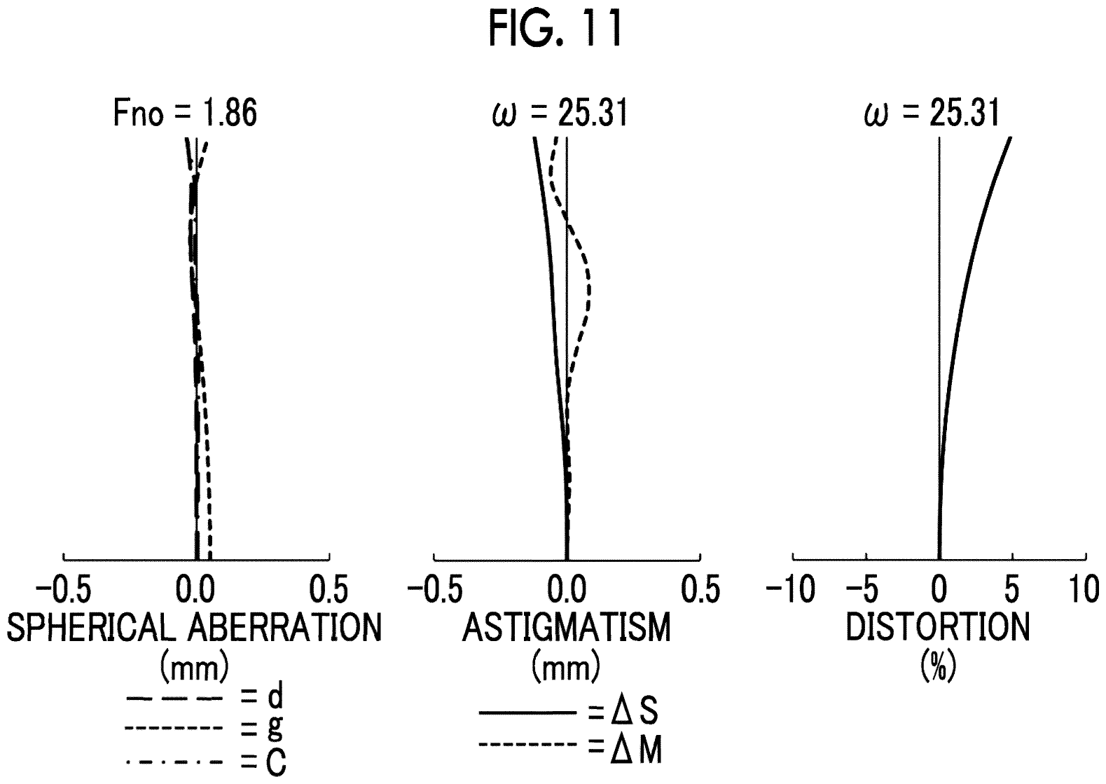

FIG. 12 is a lateral aberration diagram at the telephoto end and during focusing on infinity in Example 1.

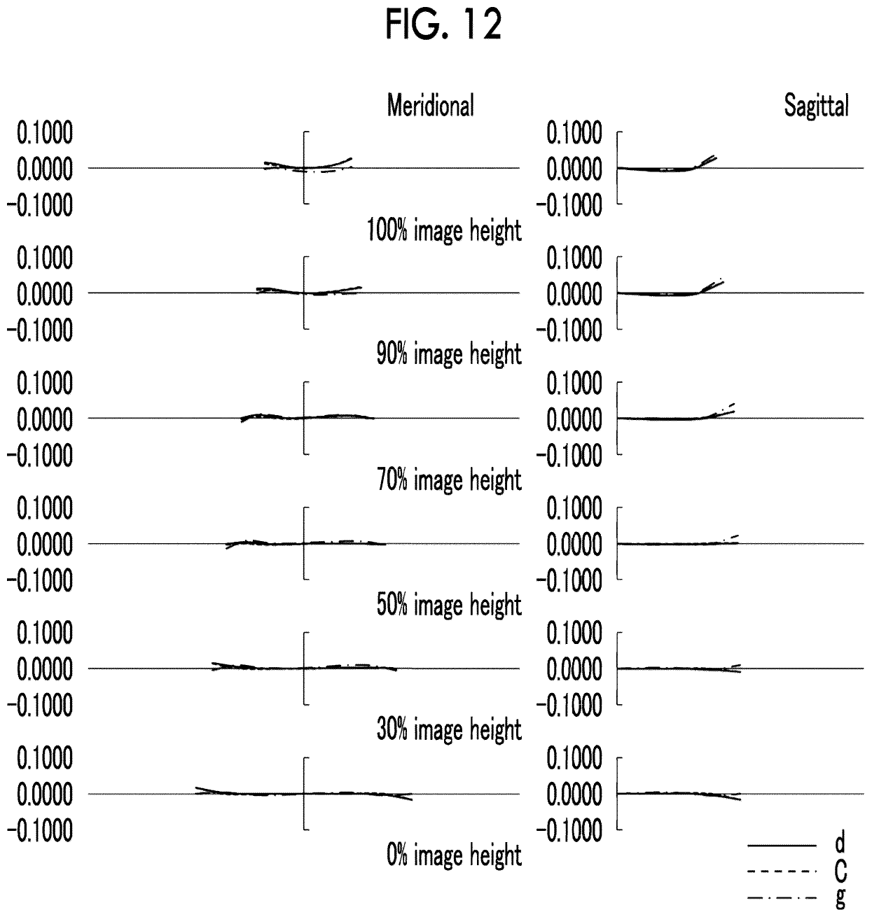

FIG. 13 is a lateral aberration diagram at the telephoto end, a focusing distance of 1869 mm in Example 1.

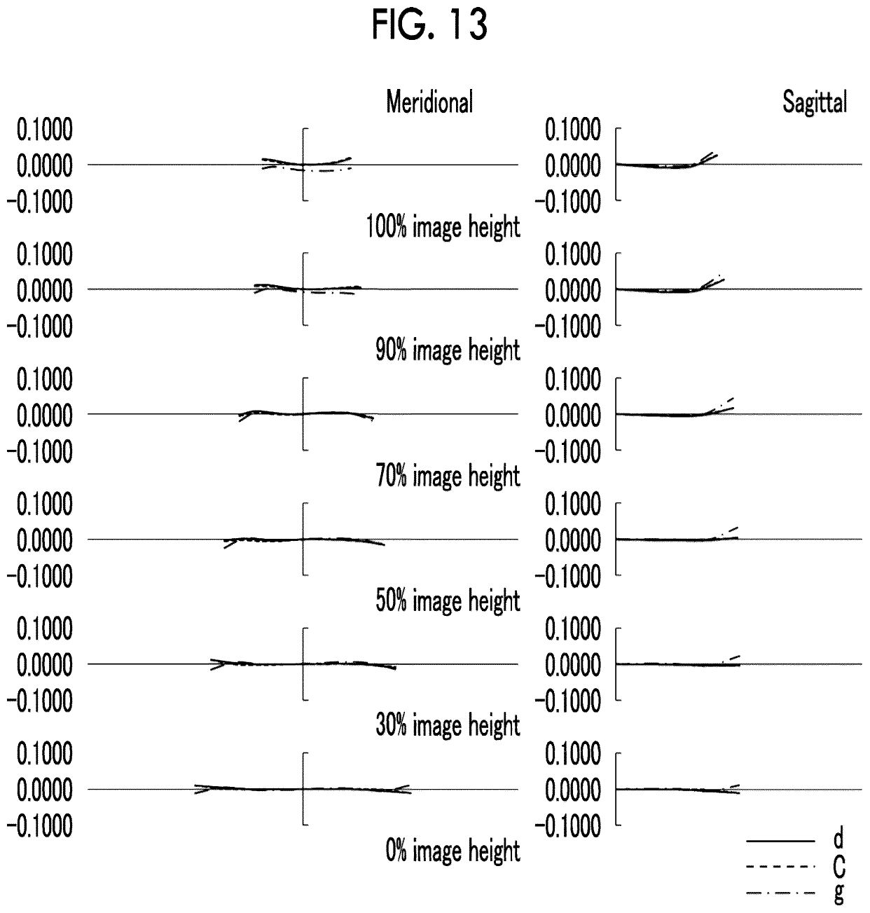

FIG. 14 is a lens configuration diagram at a wide-angle end and during focusing on infinity in Example 2.

FIG. 15 is a longitudinal aberration diagram at the wide-angle end and during focusing on infinity in Example 2.

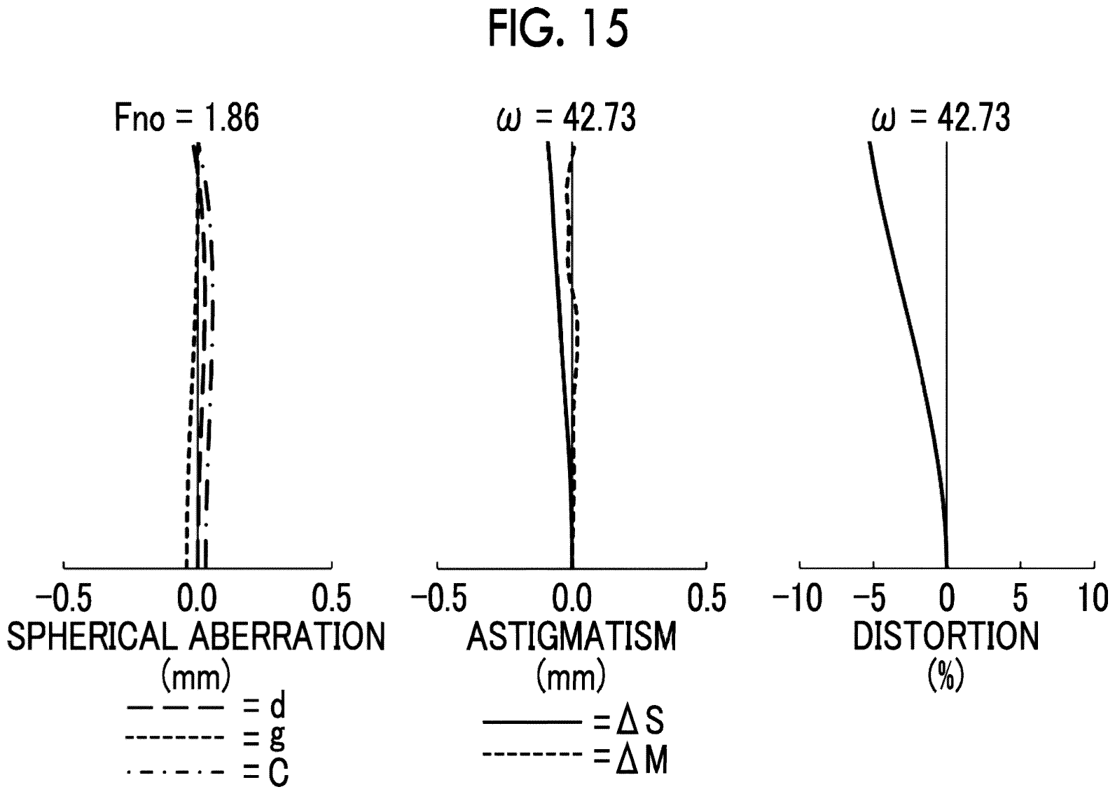

FIG. 16 is a longitudinal aberration diagram at the wide-angle end and a focusing distance of 1111 mm in Example 2.

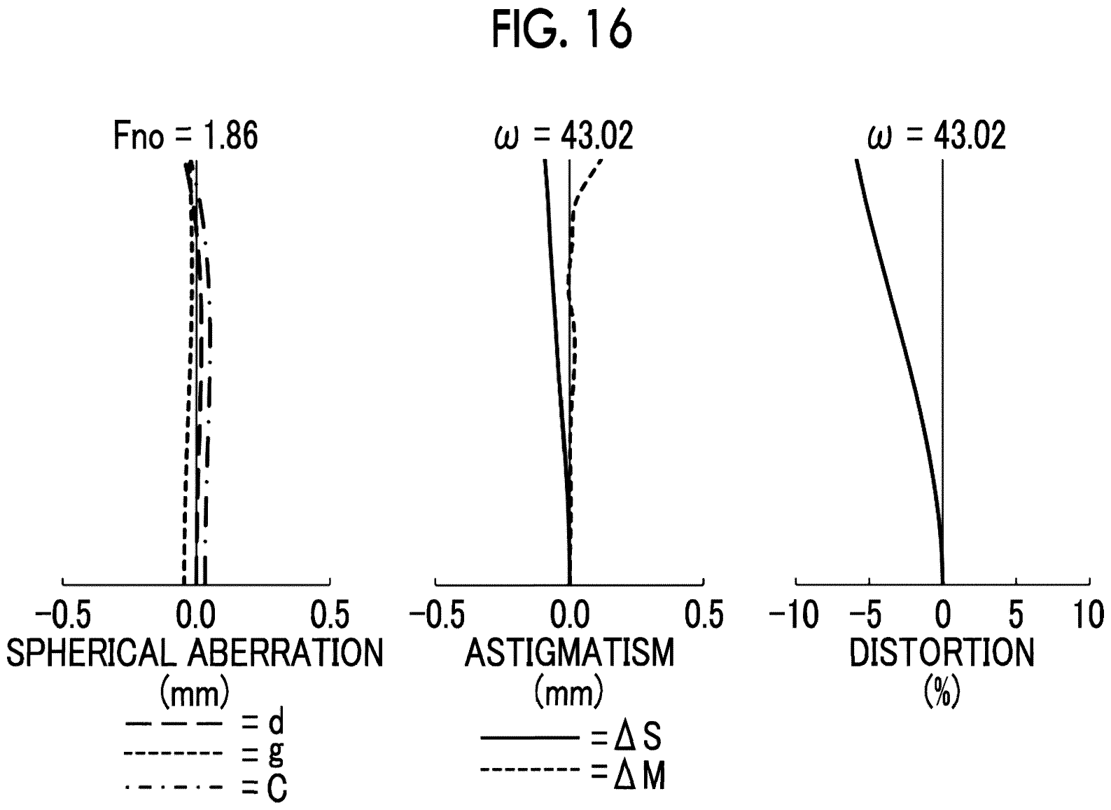

FIG. 17 is a lateral aberration diagram at the wide-angle end and during focusing on infinity in Example 2.

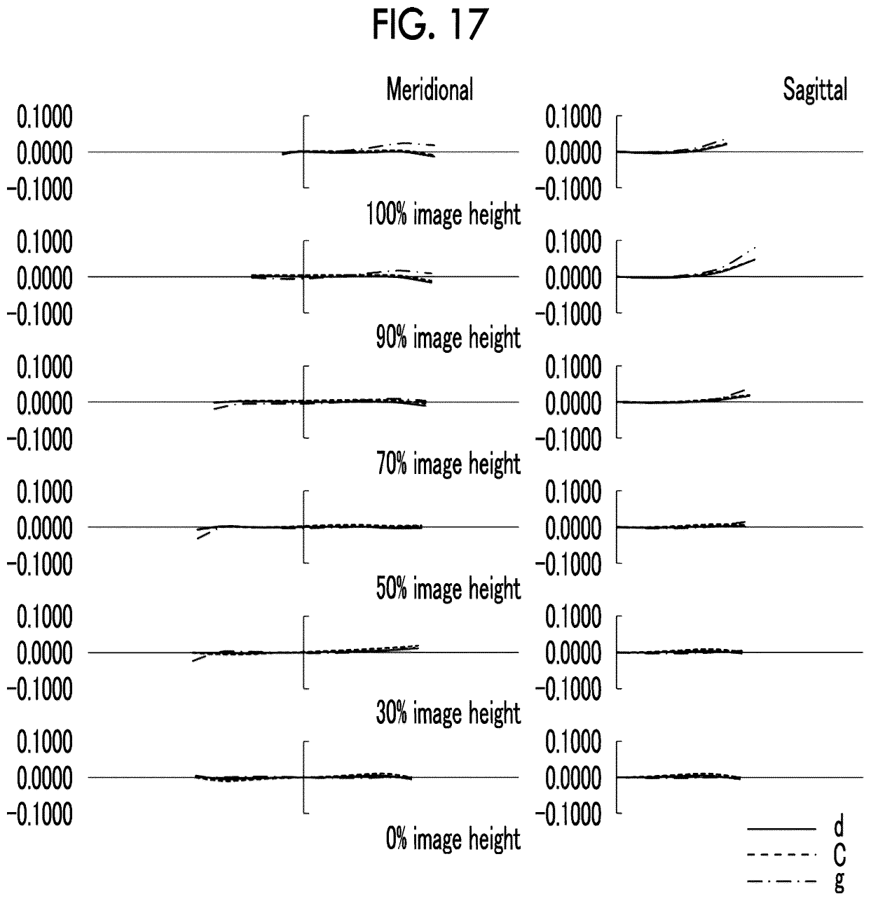

FIG. 18 is a lateral aberration diagram at the wide-angle end and a focusing distance of 1111 mm in Example 2.

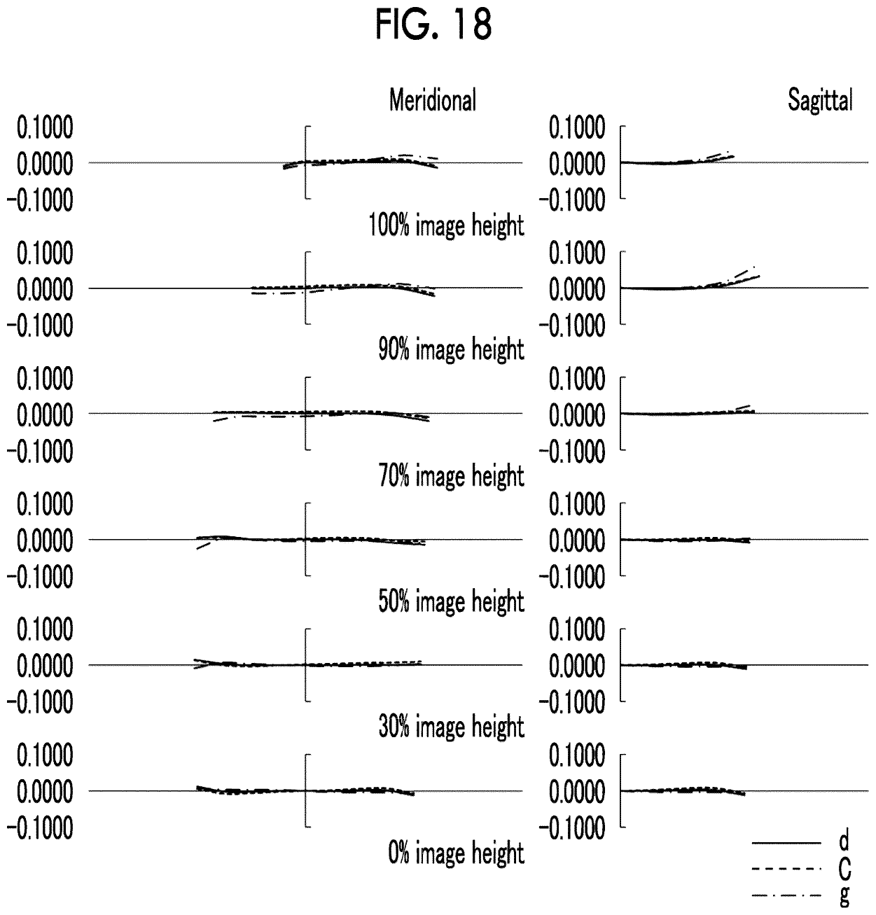

FIG. 19 is a longitudinal aberration diagram at a middle focal length and during focusing on infinity in Example 2.

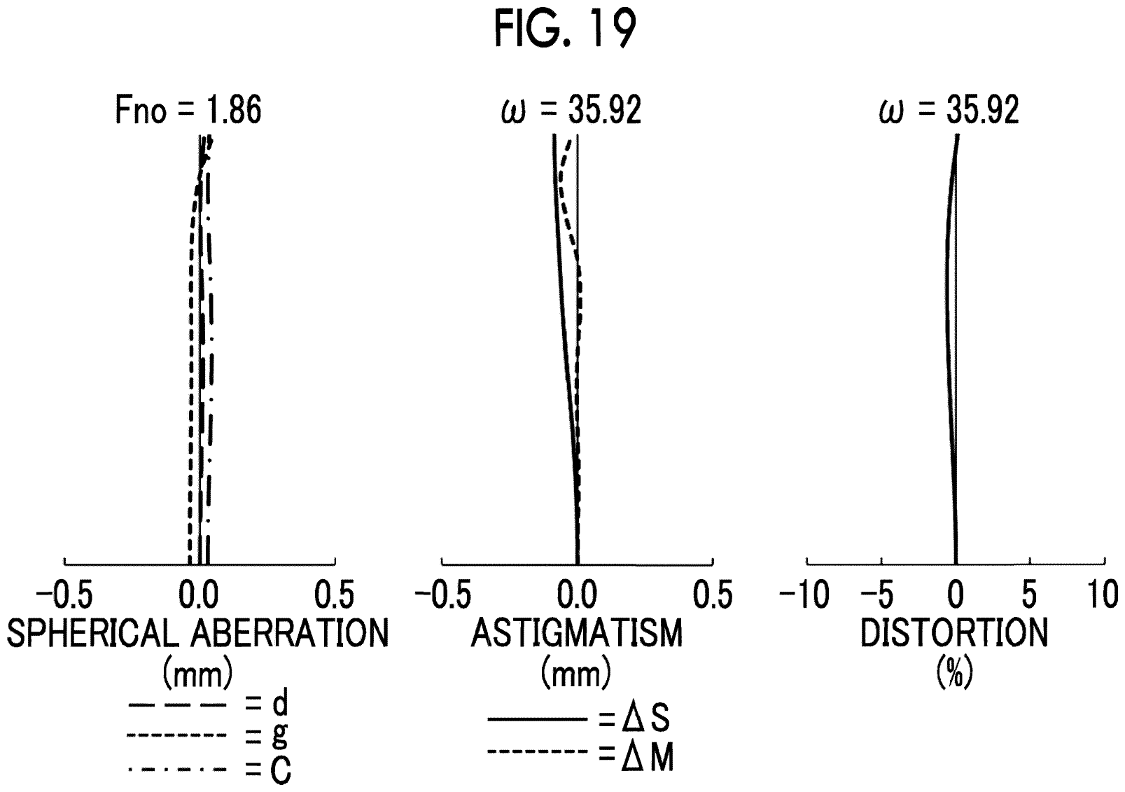

FIG. 20 is a longitudinal aberration diagram at the middle focal length and a focusing distance of 1315 mm in Example 2.

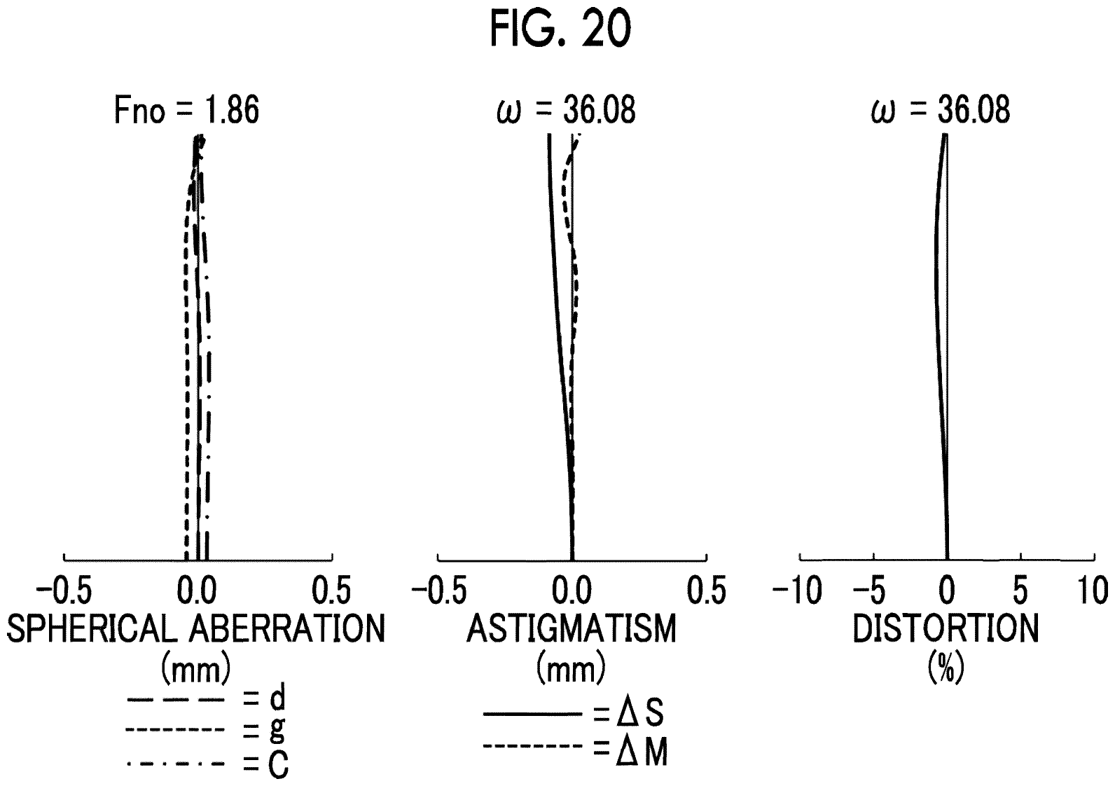

FIG. 21 is a lateral aberration diagram at the middle focal length and during focusing on infinity in Example 2.

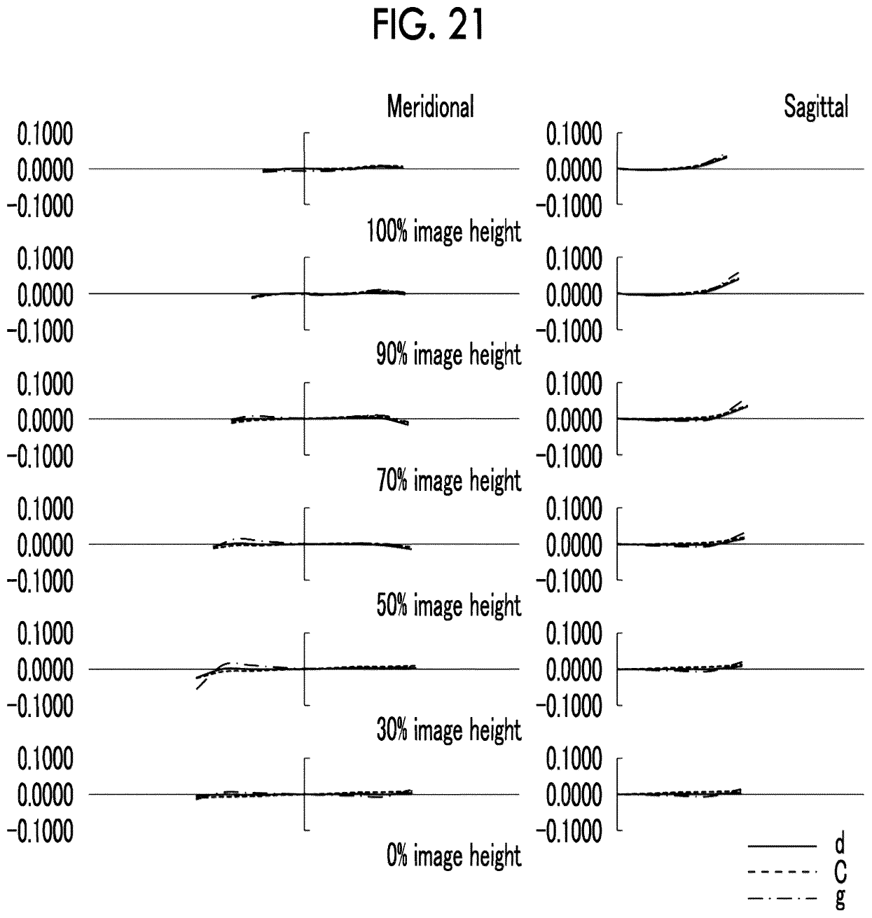

FIG. 22 is a lateral aberration diagram at the middle focal length and a focusing distance of 1315 mm in Example 2.

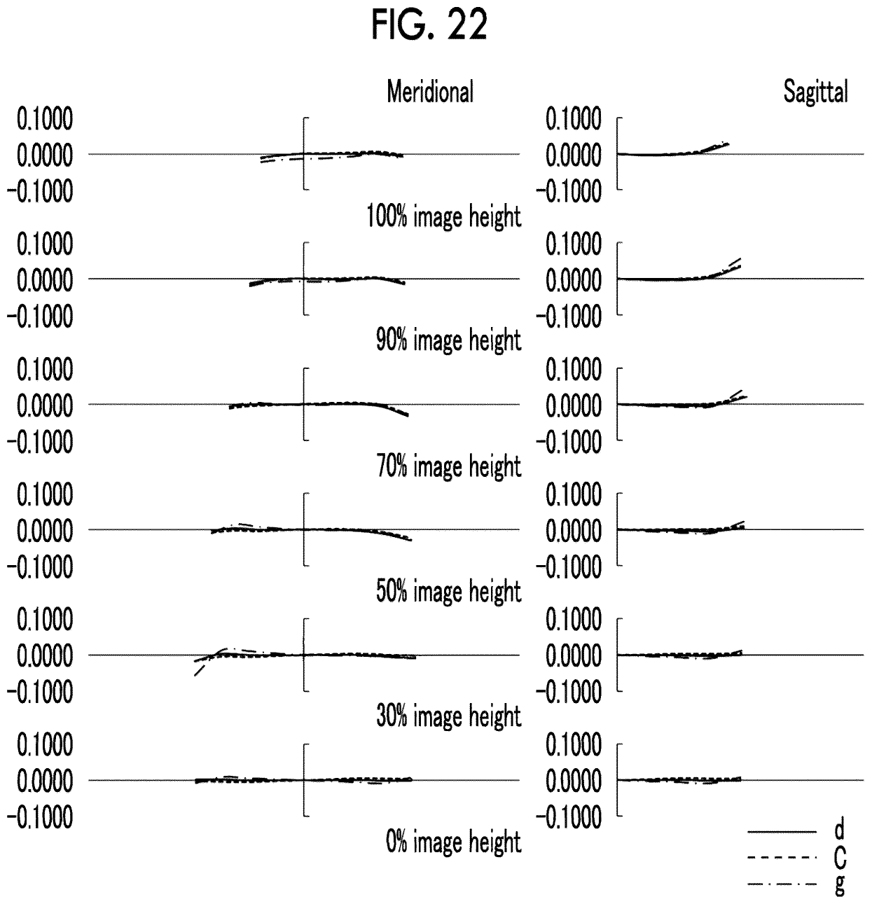

FIG. 23 is a longitudinal aberration diagram at a telephoto end and during focusing on infinity in Example 2.

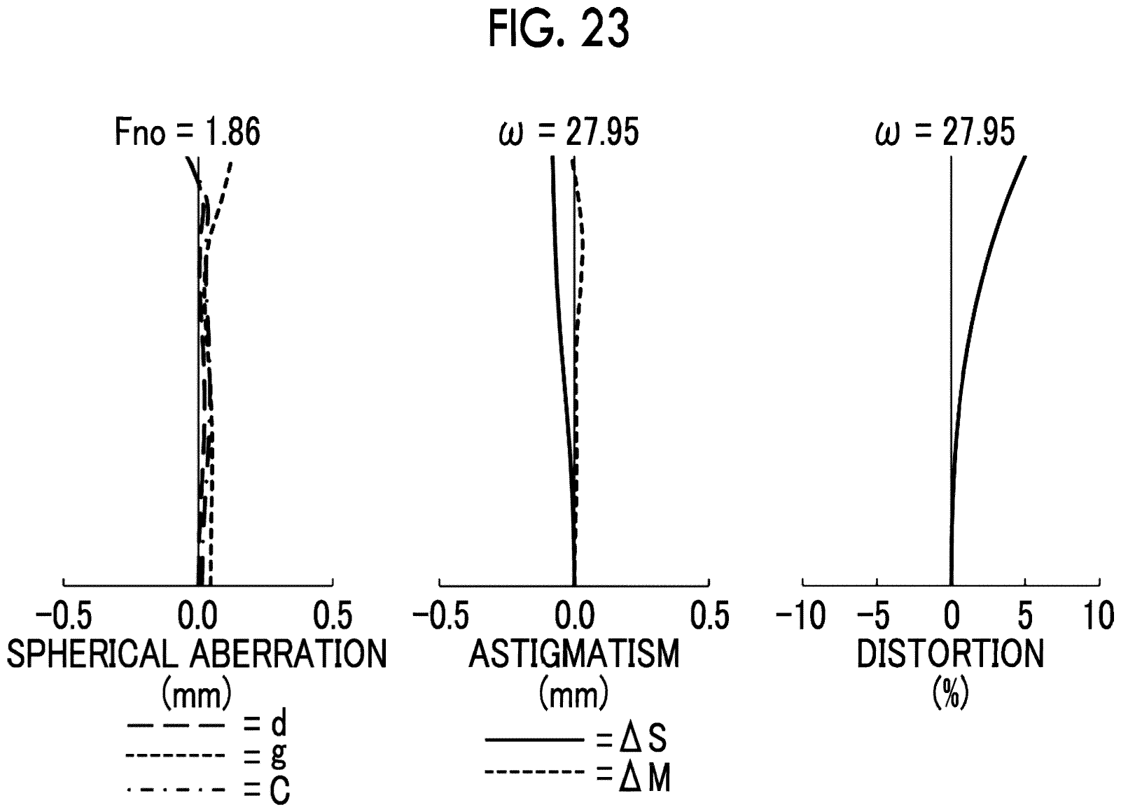

FIG. 24 is a longitudinal aberration diagram at the telephoto end and a focusing distance of 1676 mm in Example 2.

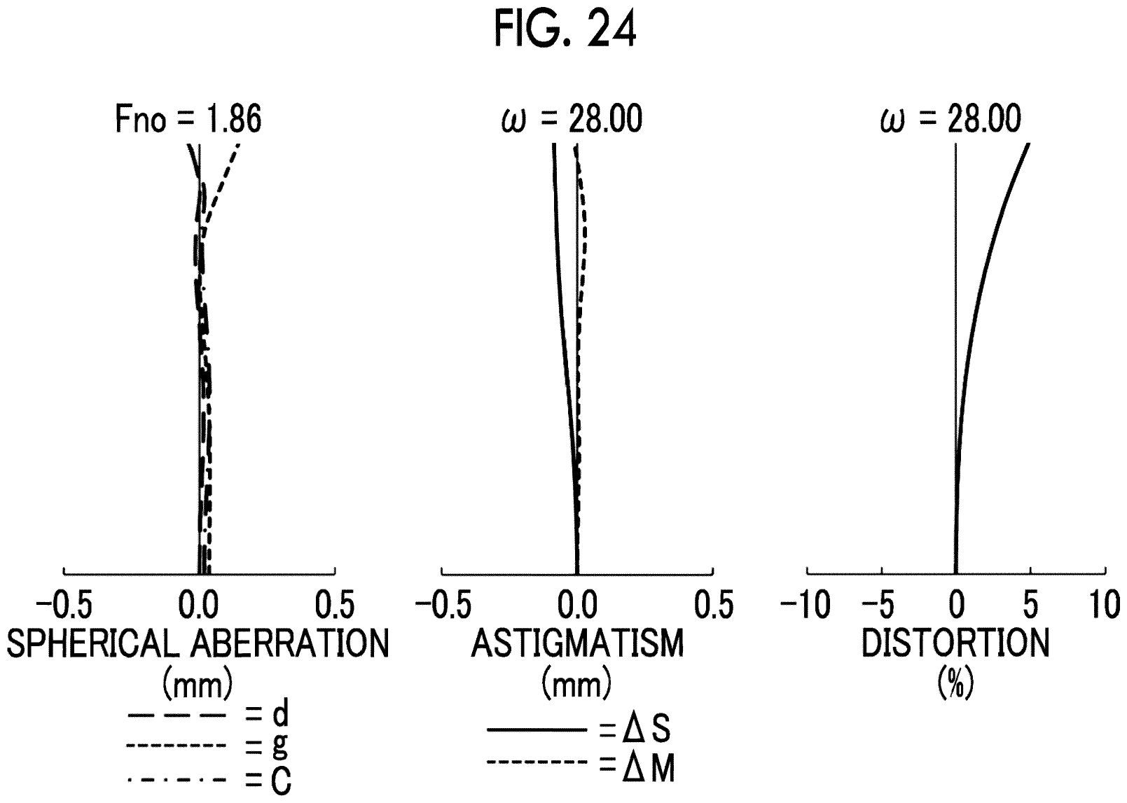

FIG. 25 is a lateral aberration diagram at the telephoto end and during focusing on infinity in Example 2.

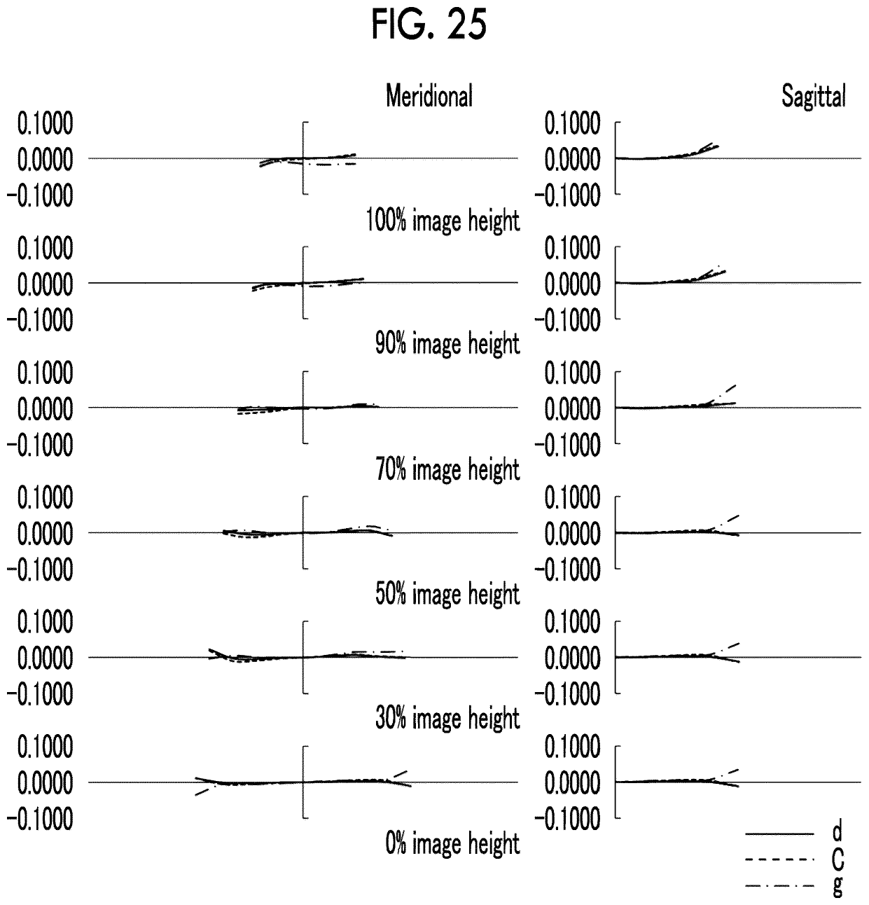

FIG. 26 is a lateral aberration diagram at the telephoto end and a focusing distance of 1676 mm in Example 2.

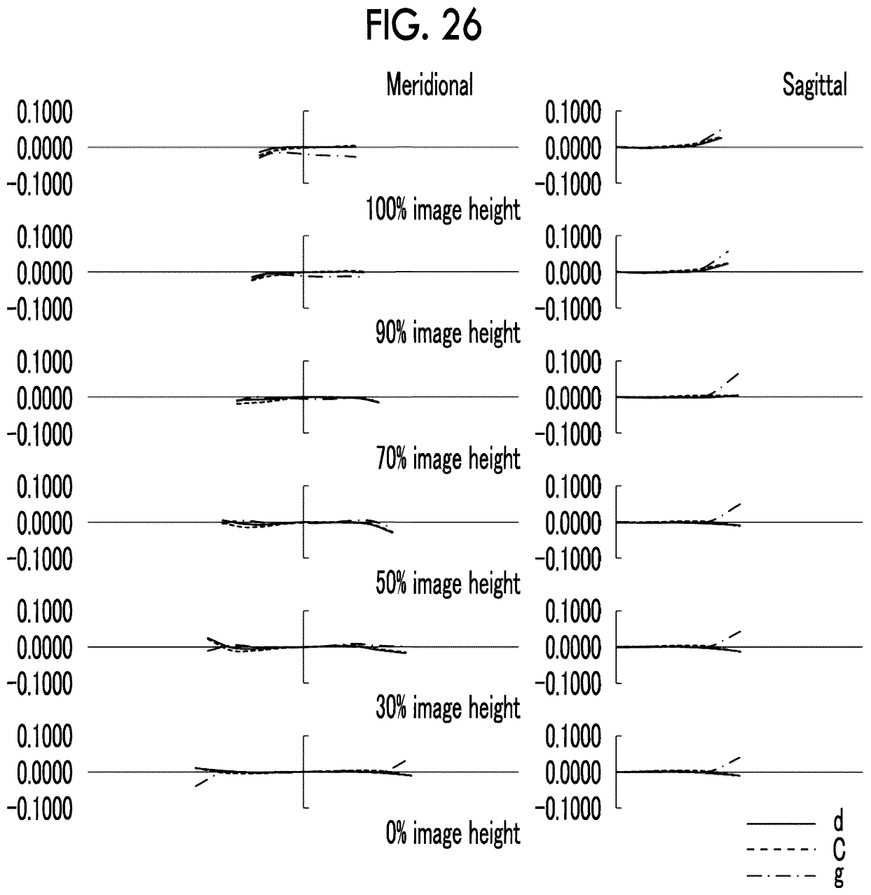

FIG. 27 is a lens configuration diagram at a wide-angle end at focusing on infinity in Example 3.

FIG. 28 is a longitudinal aberration diagram at the wide-angle end and during focusing on infinity in Example 3.

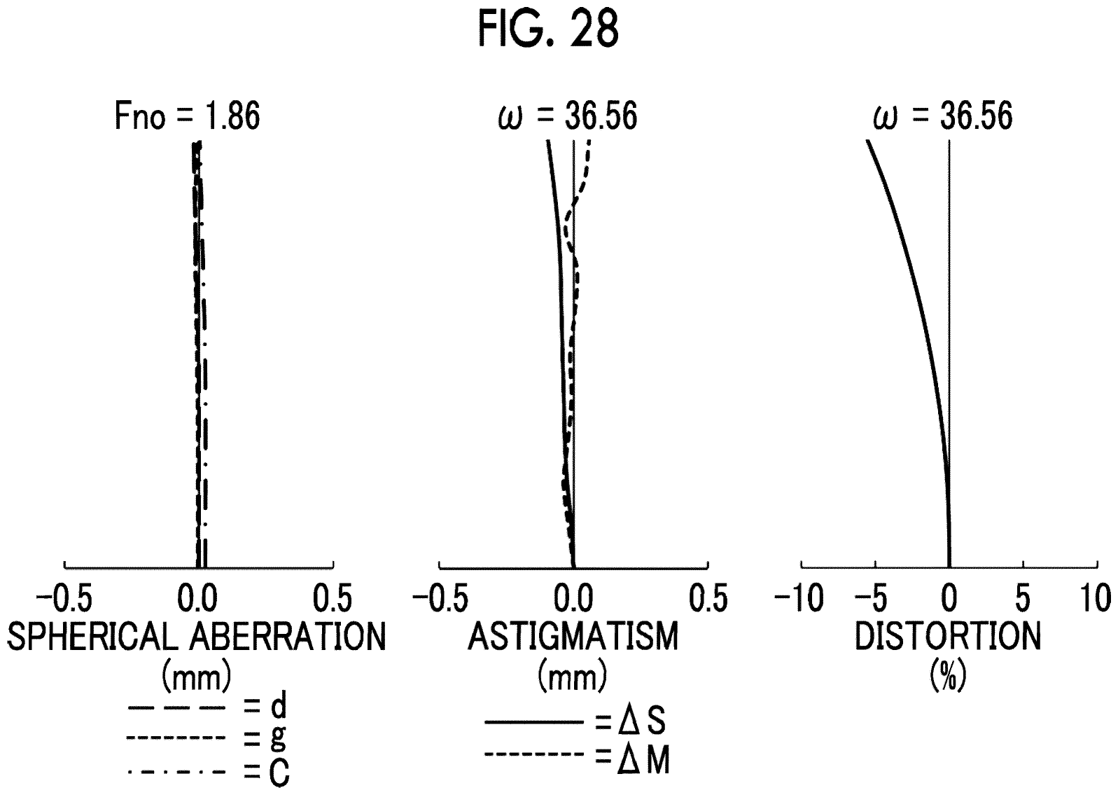

FIG. 29 is a longitudinal aberration diagram at the wide-angle end and a focusing distance of 1362 mm in Example 3.

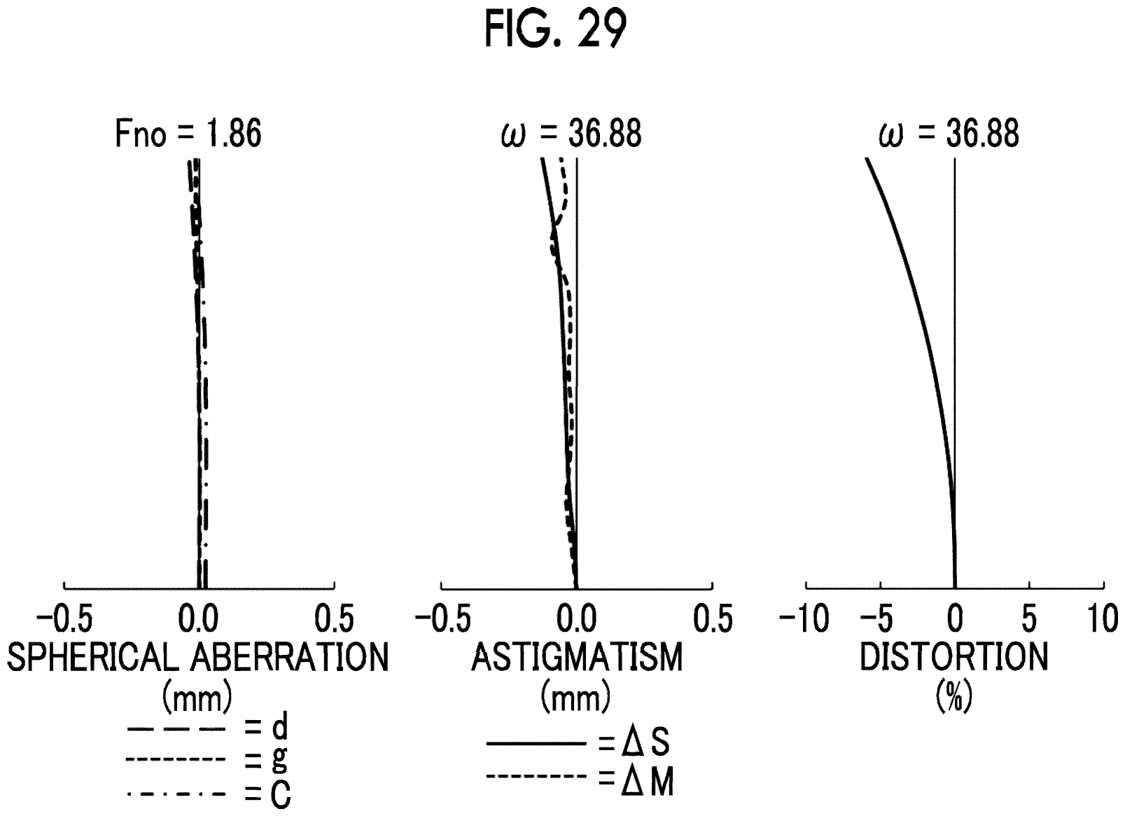

FIG. 30 is a lateral aberration diagram at a wide-angle end and during focusing on infinity in Example 3.

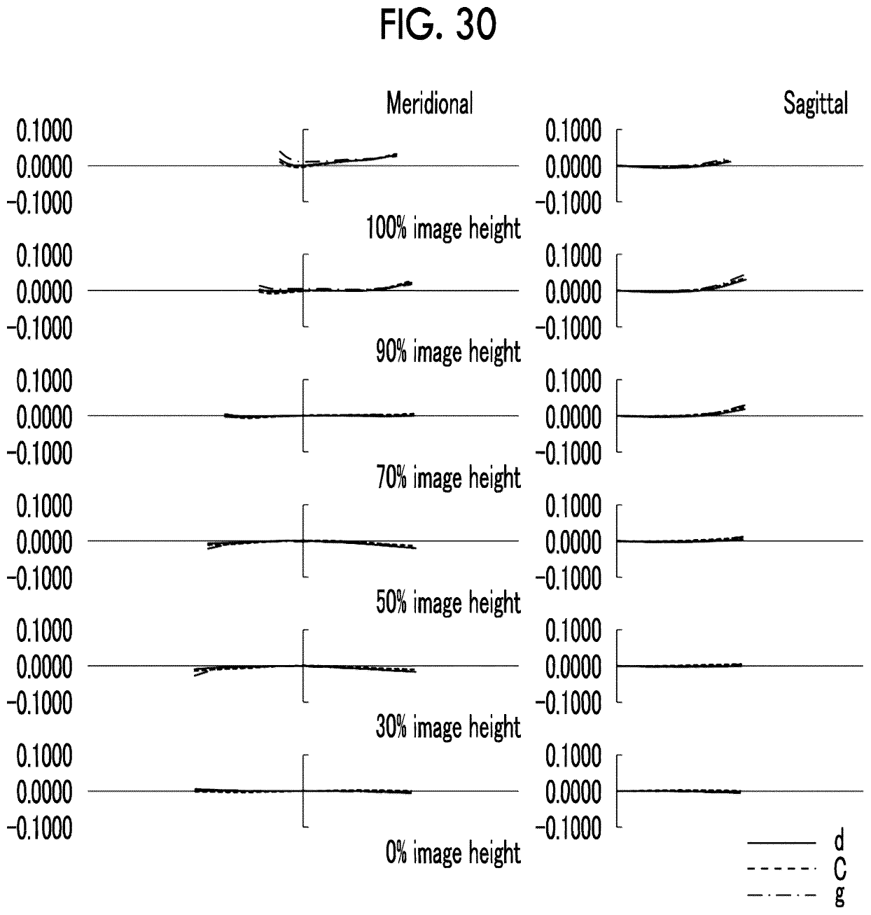

FIG. 31 is a lateral aberration diagram at the wide-angle end and a focusing distance of 1362 mm in Example 3.

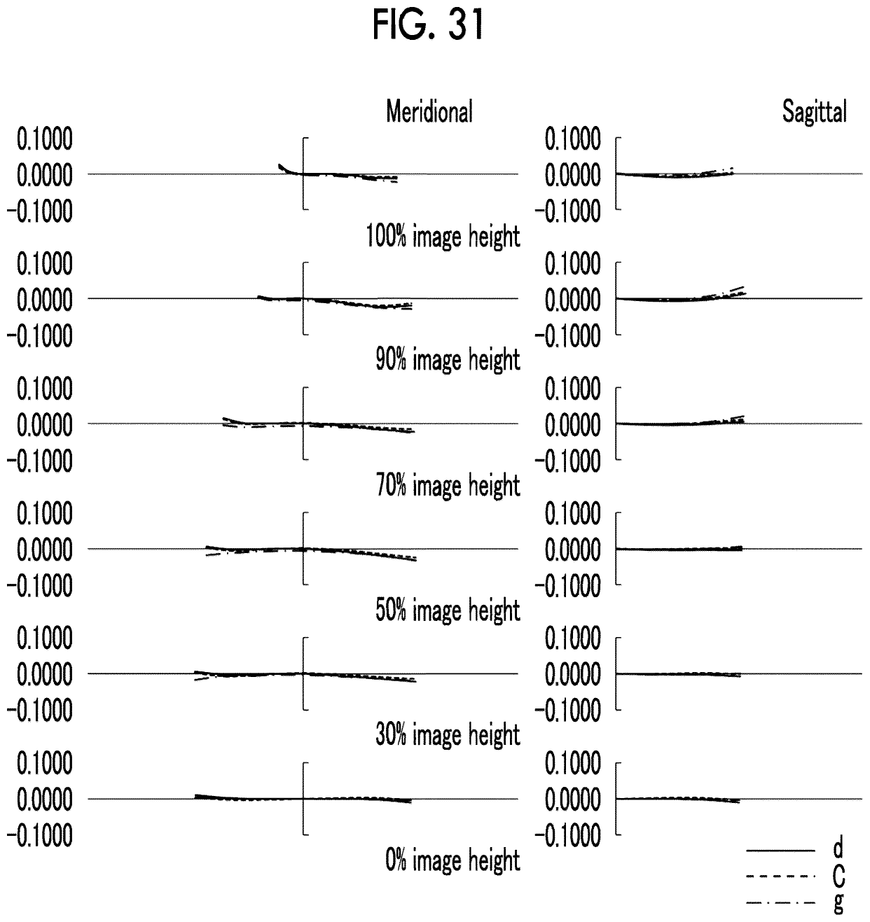

FIG. 32 is a longitudinal aberration diagram at a middle focal length and during focusing on infinity in Example 3.

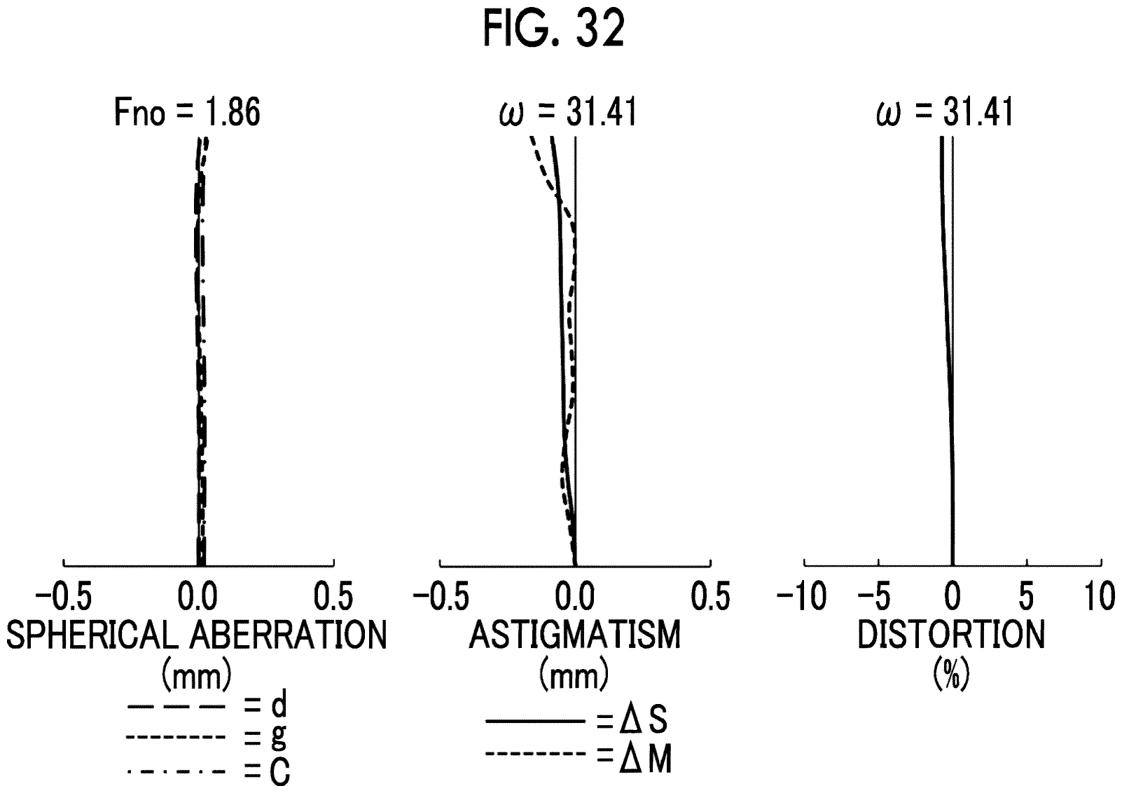

FIG. 33 is a longitudinal aberration diagram at the middle focal length and a focusing distance of 1555 mm in Example 3.

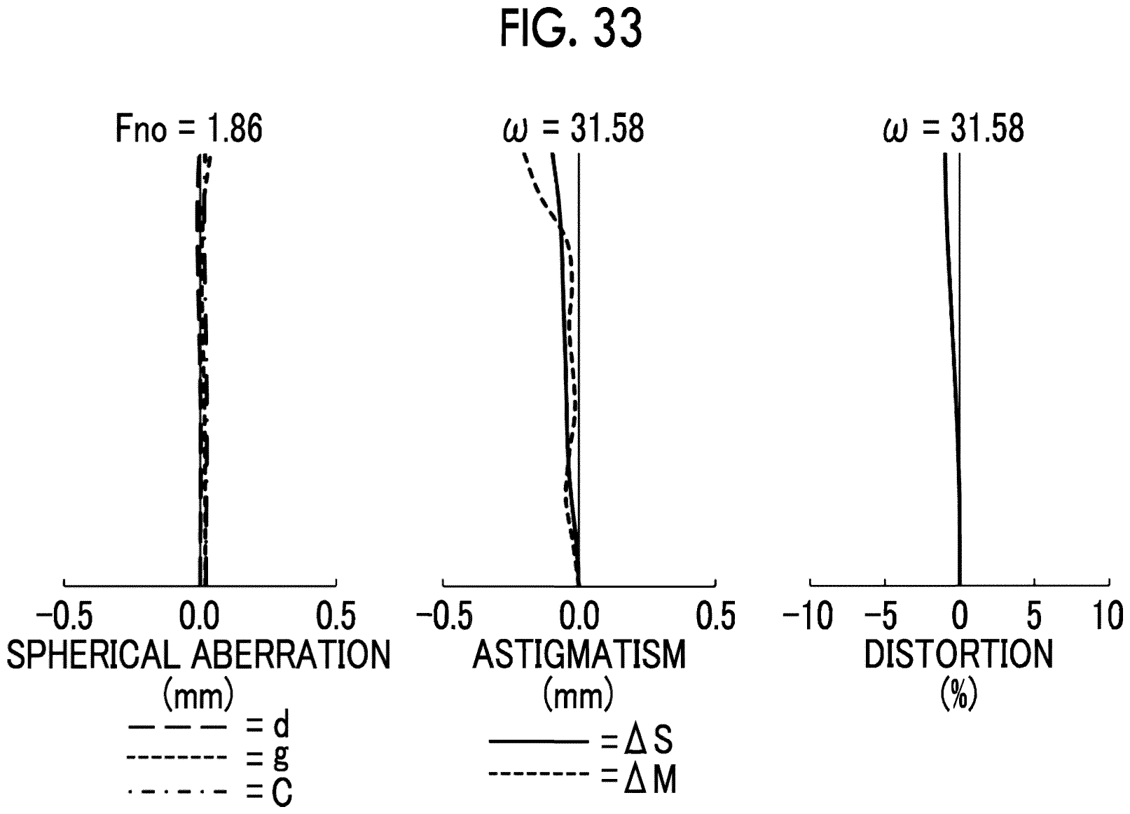

FIG. 34 is a lateral aberration diagram at the middle focal length and during focusing on infinity in Example 3.

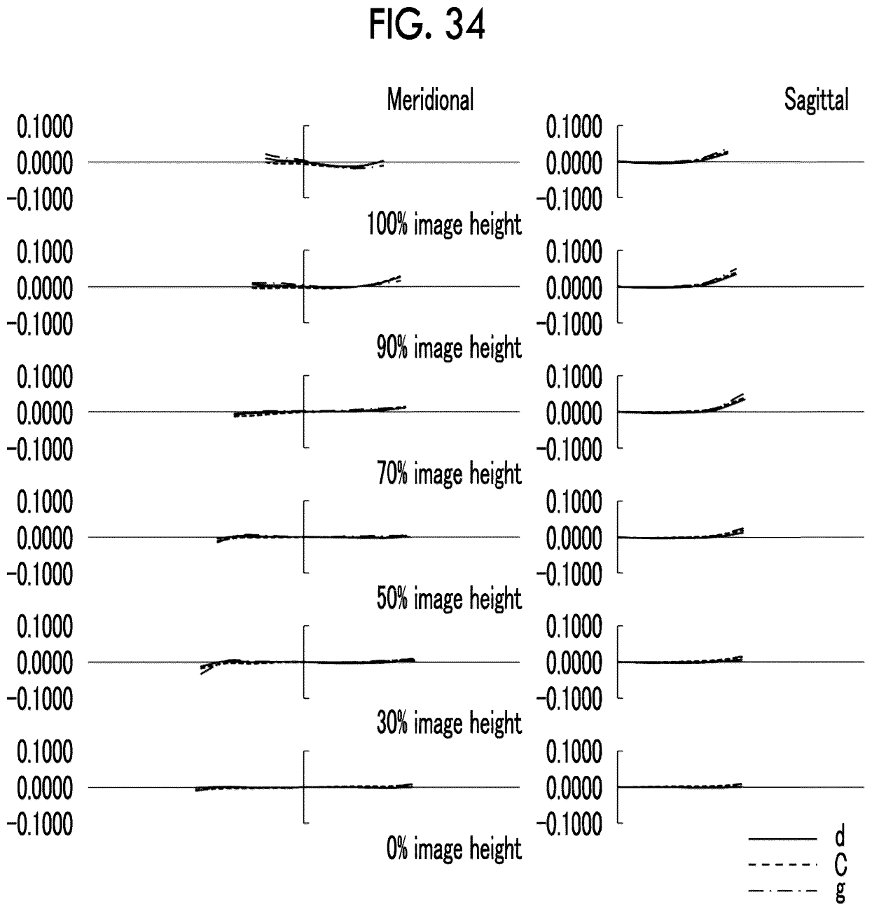

FIG. 35 is a lateral aberration diagram at the middle focal length and a focusing distance of 1555 mm in Example 3.

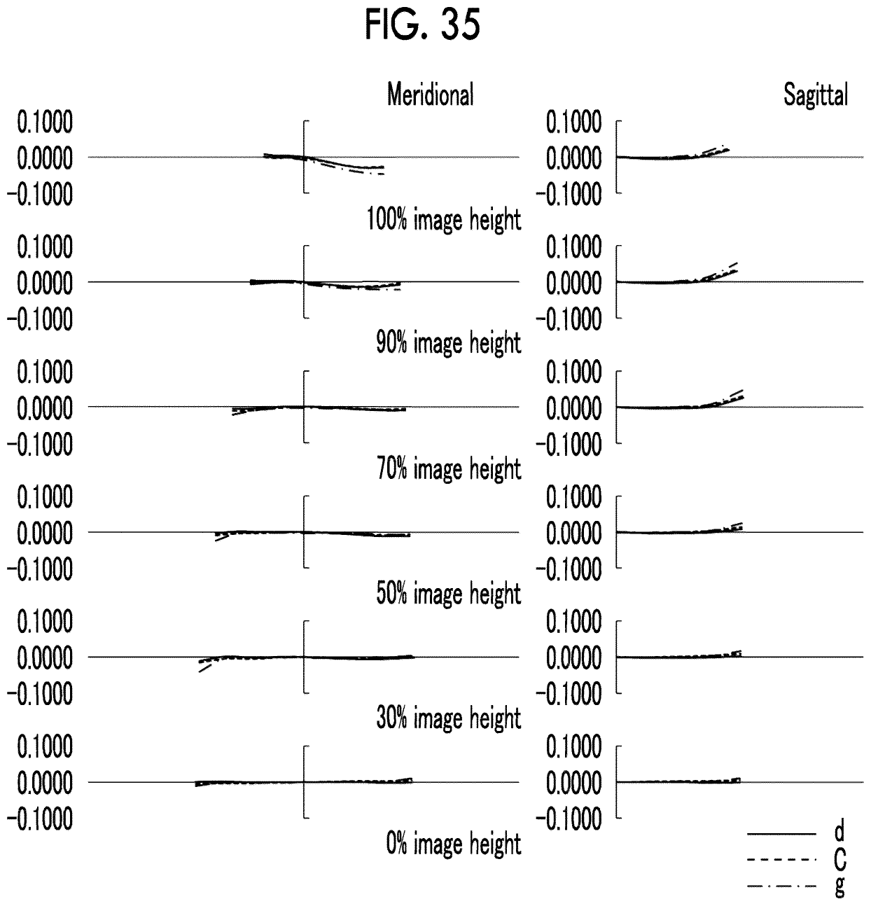

FIG. 36 is a longitudinal aberration diagram at a telephoto end and during focusing on infinity in Example 3.

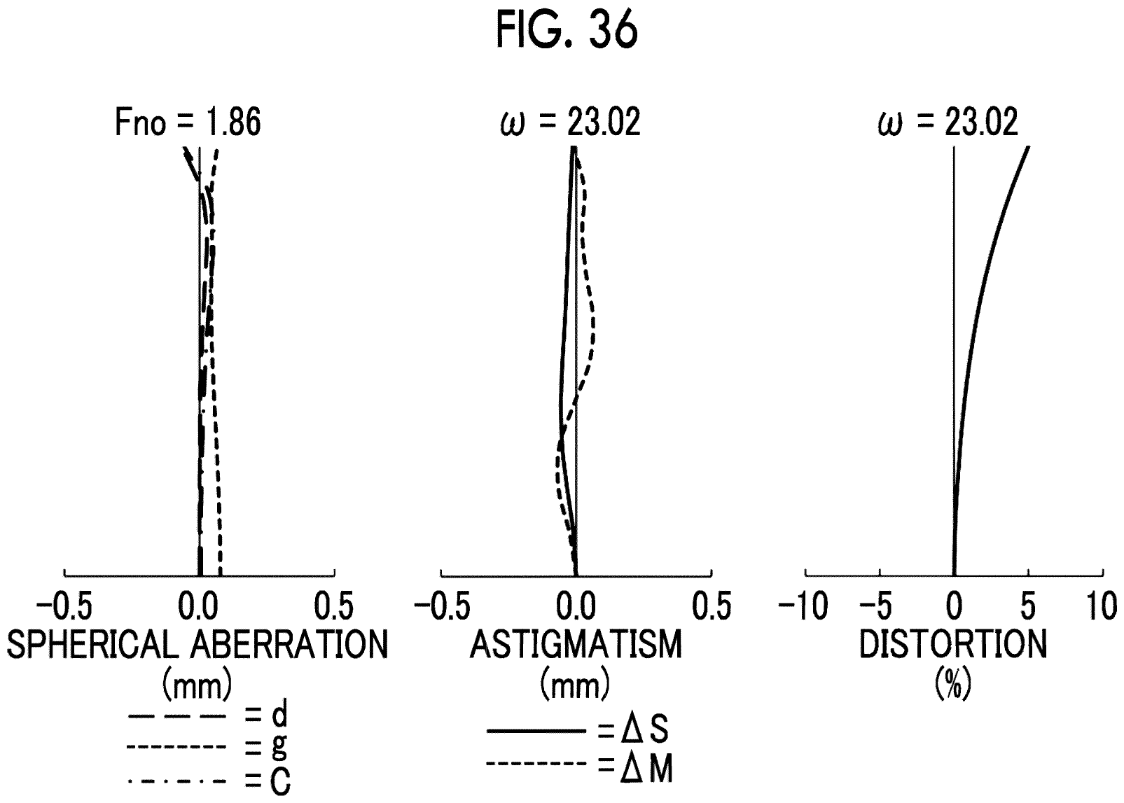

FIG. 37 is a longitudinal aberration diagram at the telephoto end and a focusing distance of 2068 mm in Example 3.

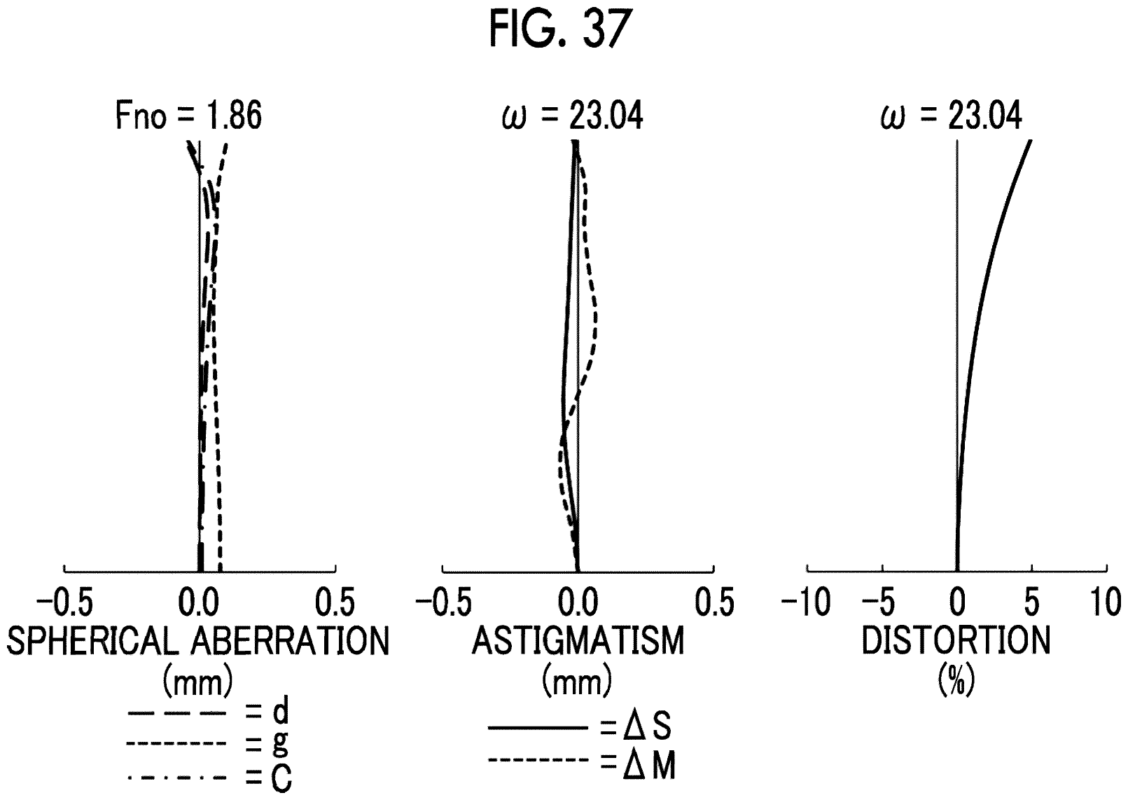

FIG. 38 is a lateral aberration diagram at the telephoto end and during focusing on infinity in Example 3.

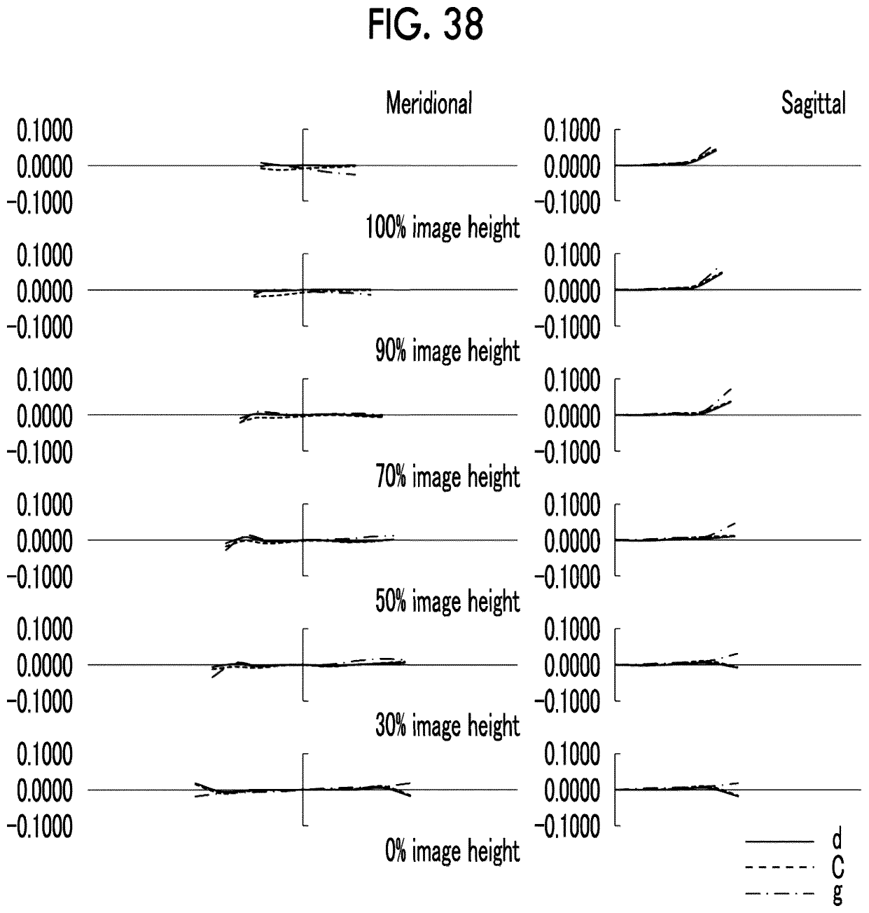

FIG. 39 is a lateral aberration diagram at the telephoto end and a focusing distance of 2068 mm in Example 3.

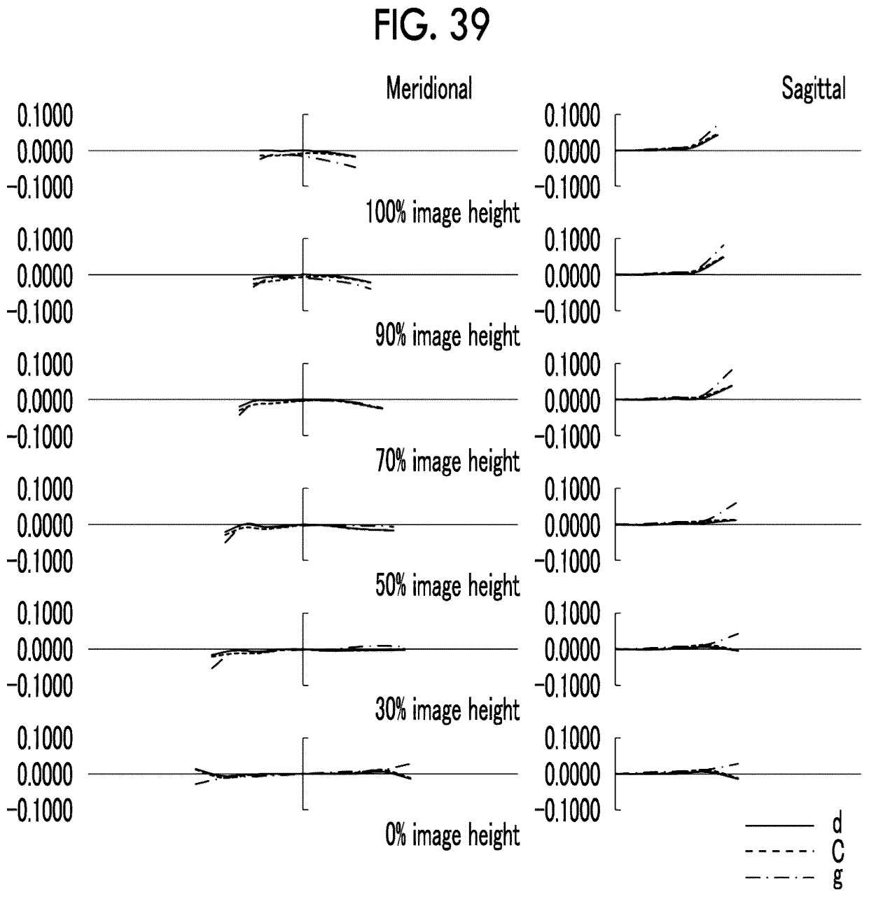

FIG. 40 is a lens configuration diagram at a wide-angle end and a focusing on infinity in Example 4.

FIG. 41 is a longitudinal aberration diagram at the wide-angle end and during focusing on infinity in Example 4.

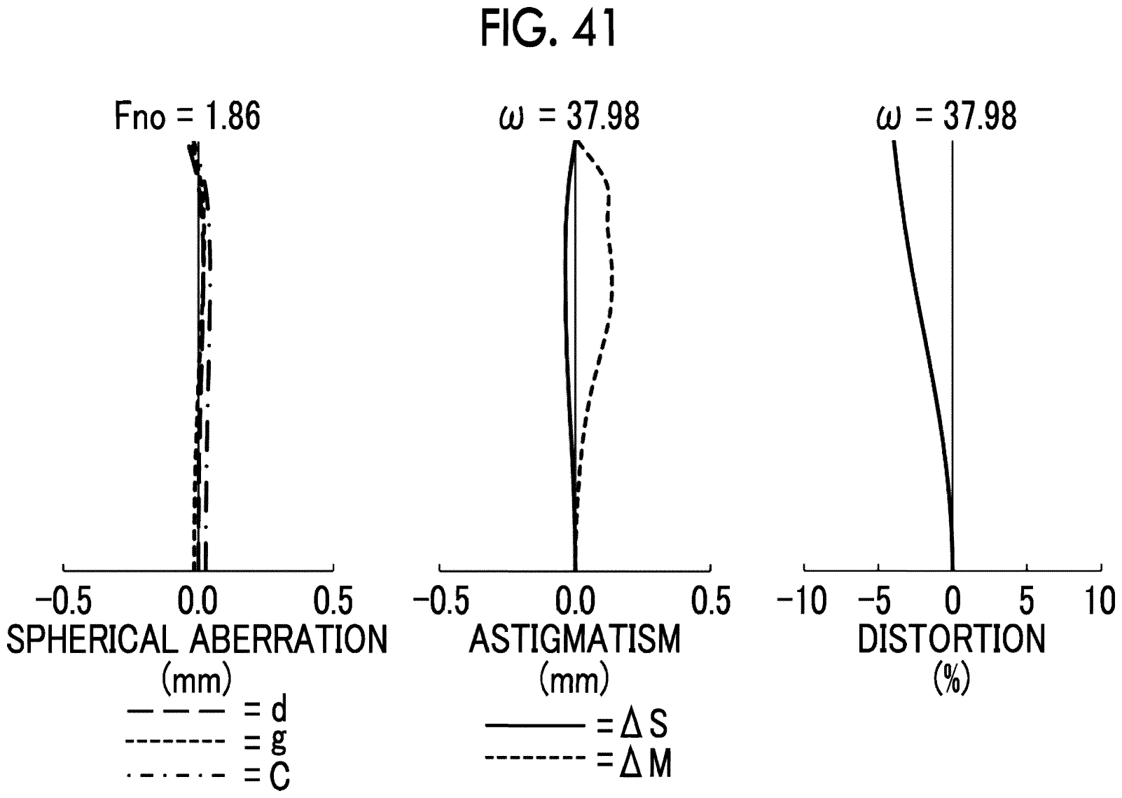

FIG. 42 is a longitudinal aberration diagram at the wide-angle end and a focusing distance of 1274 mm in Example 4.

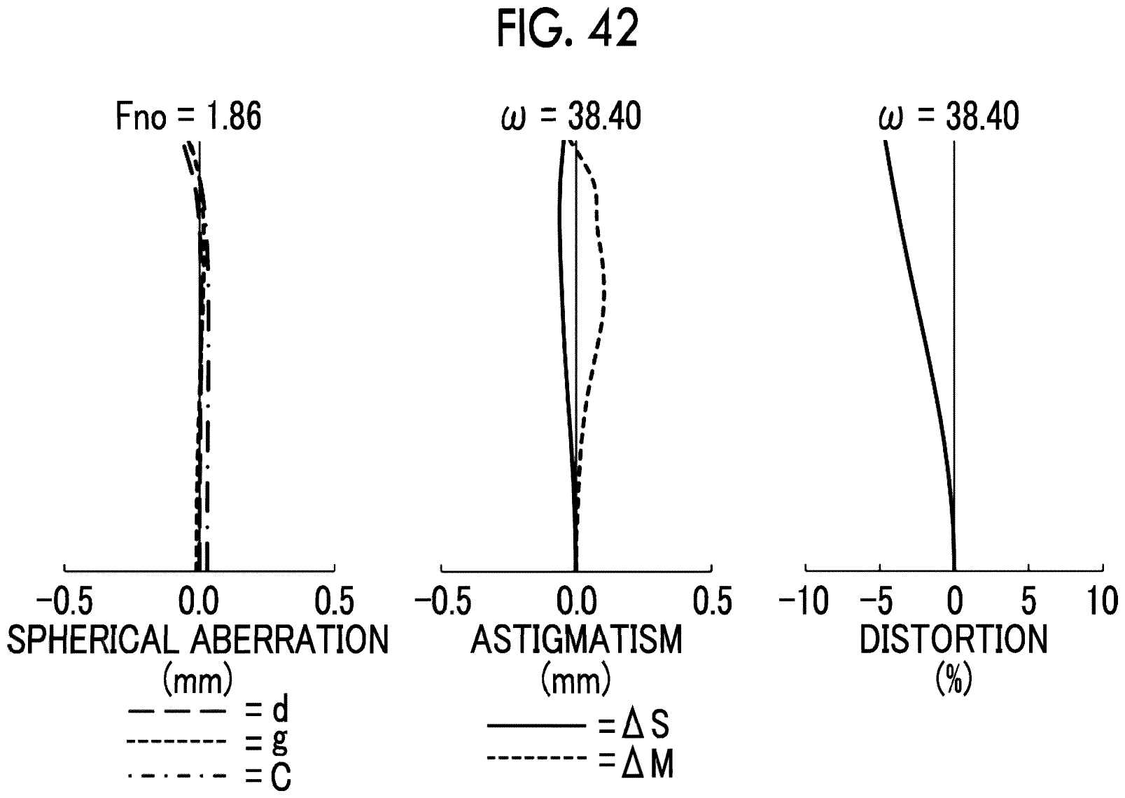

FIG. 43 is a lateral aberration diagram at the wide-angle end and during focusing on infinity in Example 4.

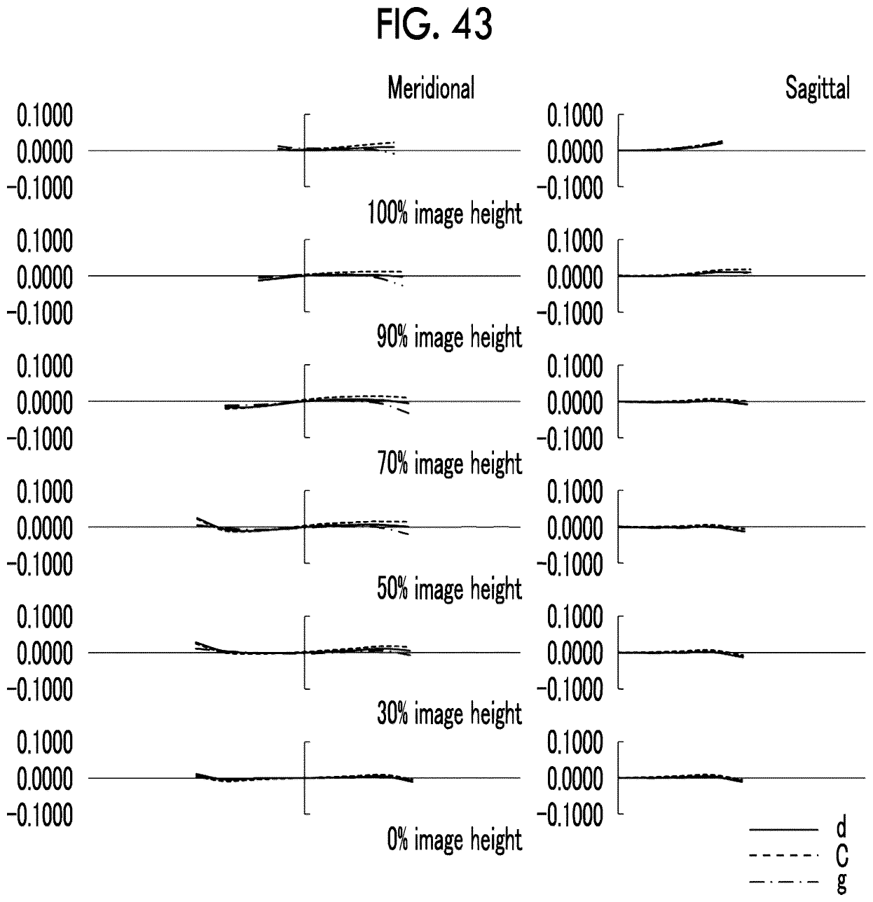

FIG. 44 is a lateral aberration diagram at the wide-angle end and a focusing distance of 1274 mm in Example 4.

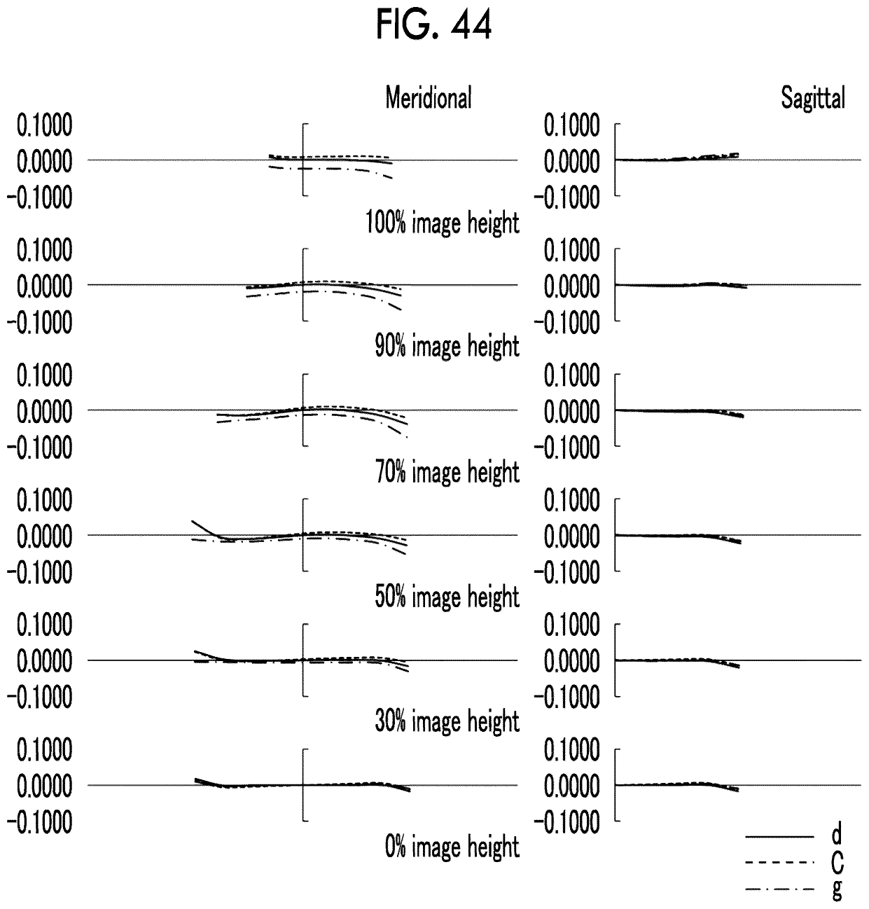

FIG. 45 is a longitudinal aberration diagram at a middle focal length and during focusing on infinity in Example 4.

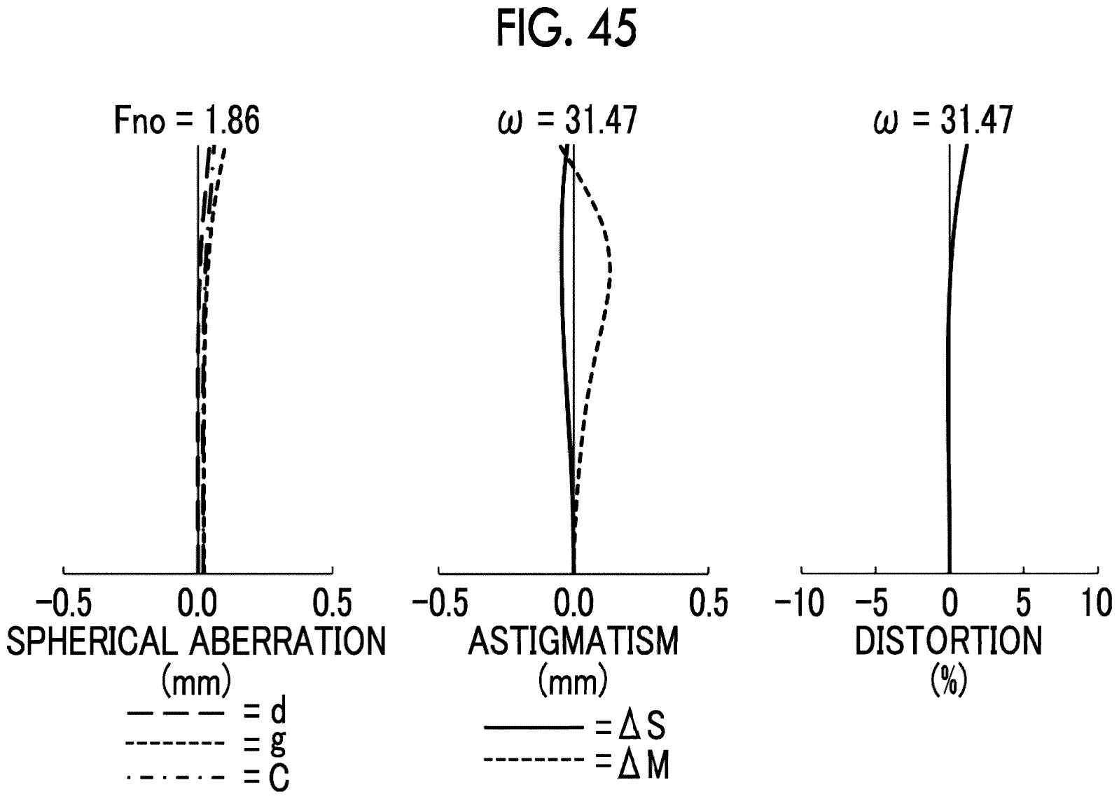

FIG. 46 is a longitudinal aberration diagram at the middle focal length and a focusing distance of 1519 mm in Example 4.

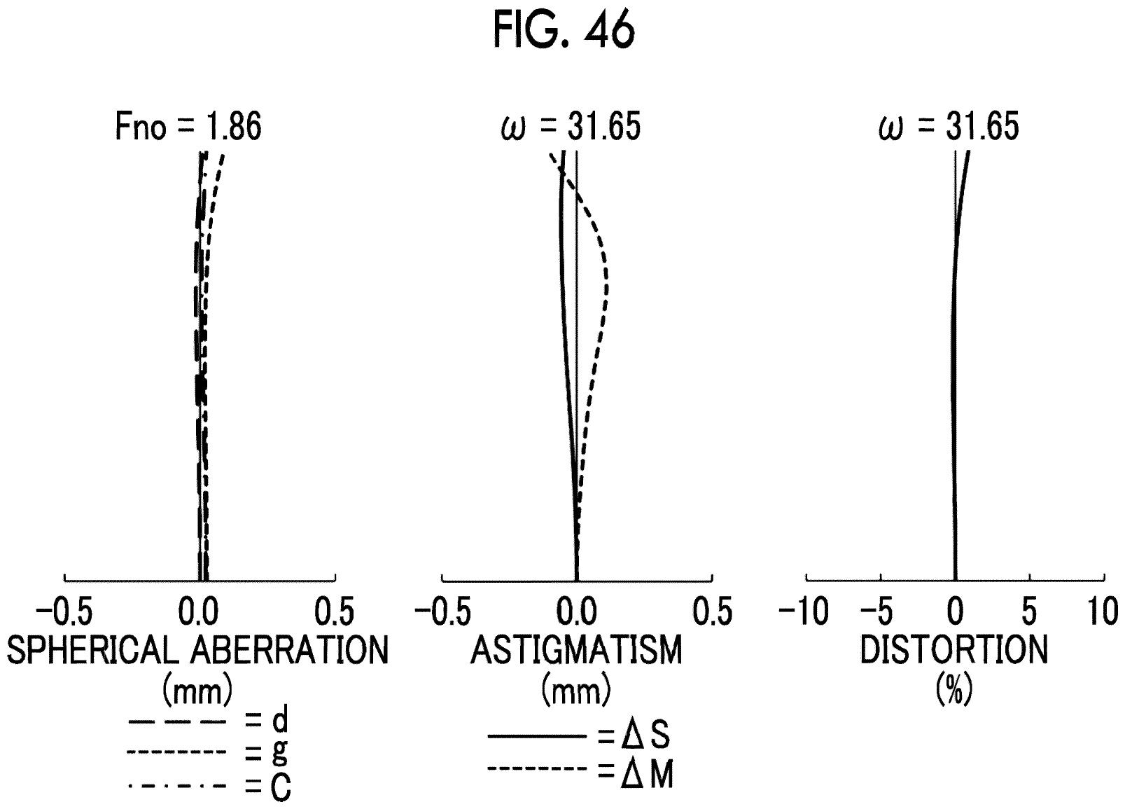

FIG. 47 is a lateral aberration diagram at the middle focal length and during focusing on infinity in Example 4.

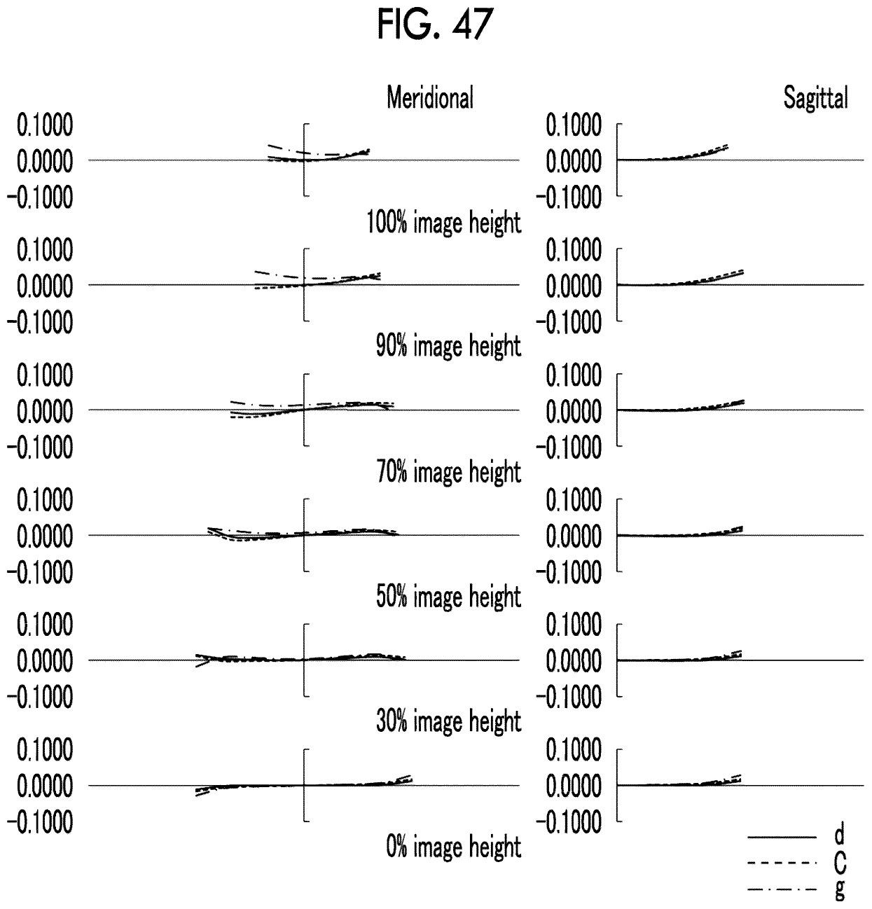

FIG. 48 is a lateral aberration diagram at the middle focal length and a focusing distance of 1519 mm in Example 4.

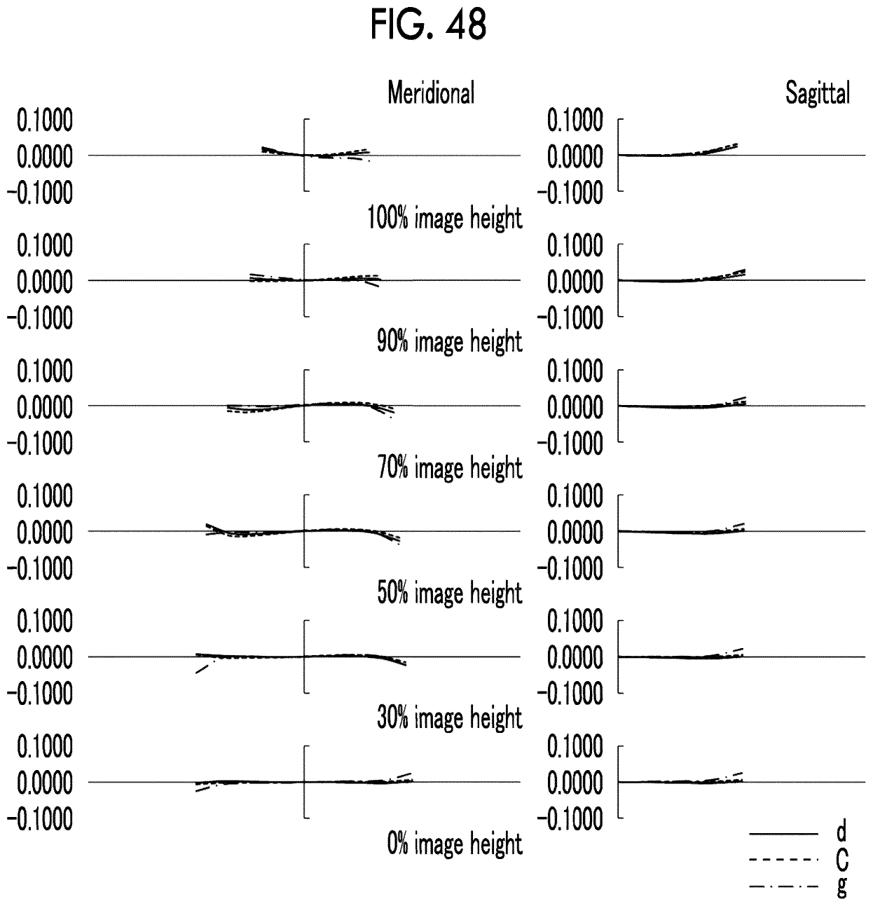

FIG. 49 is a longitudinal aberration diagram at a telephoto end and during focusing on infinity in Example 4.

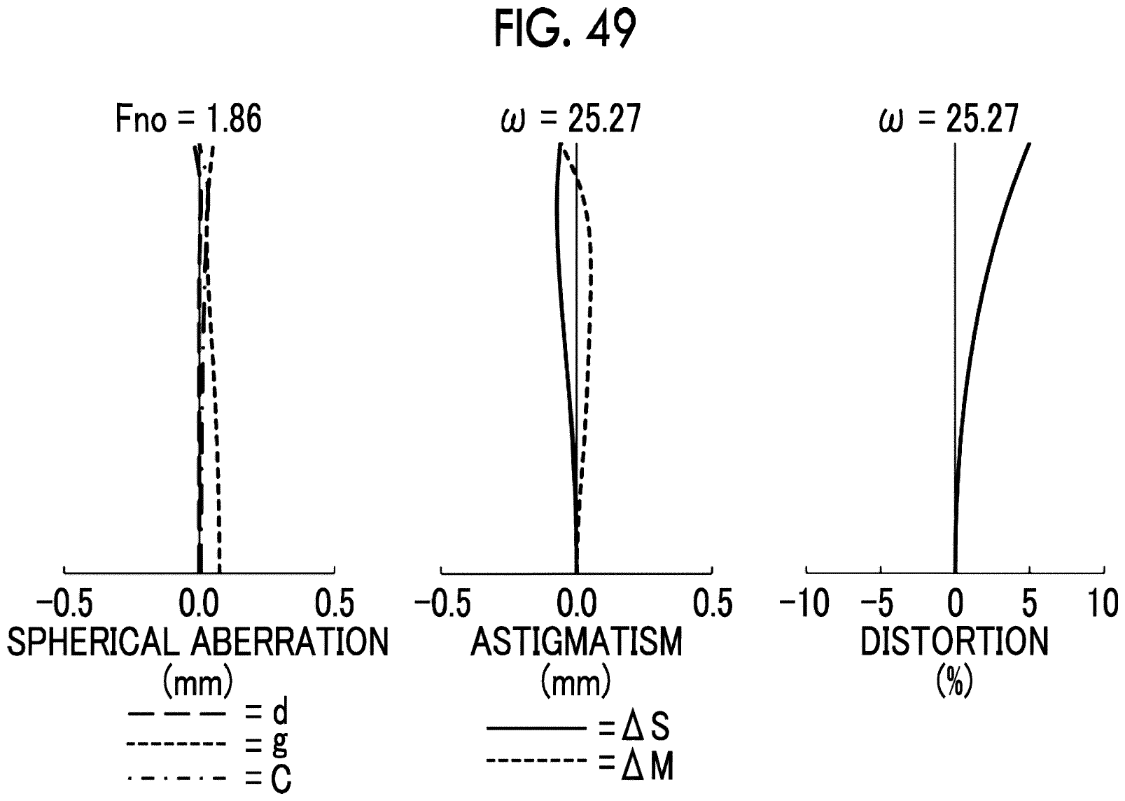

FIG. 50 is a longitudinal aberration diagram at the telephoto end and a focusing distance of 1868 mm in Example 4.

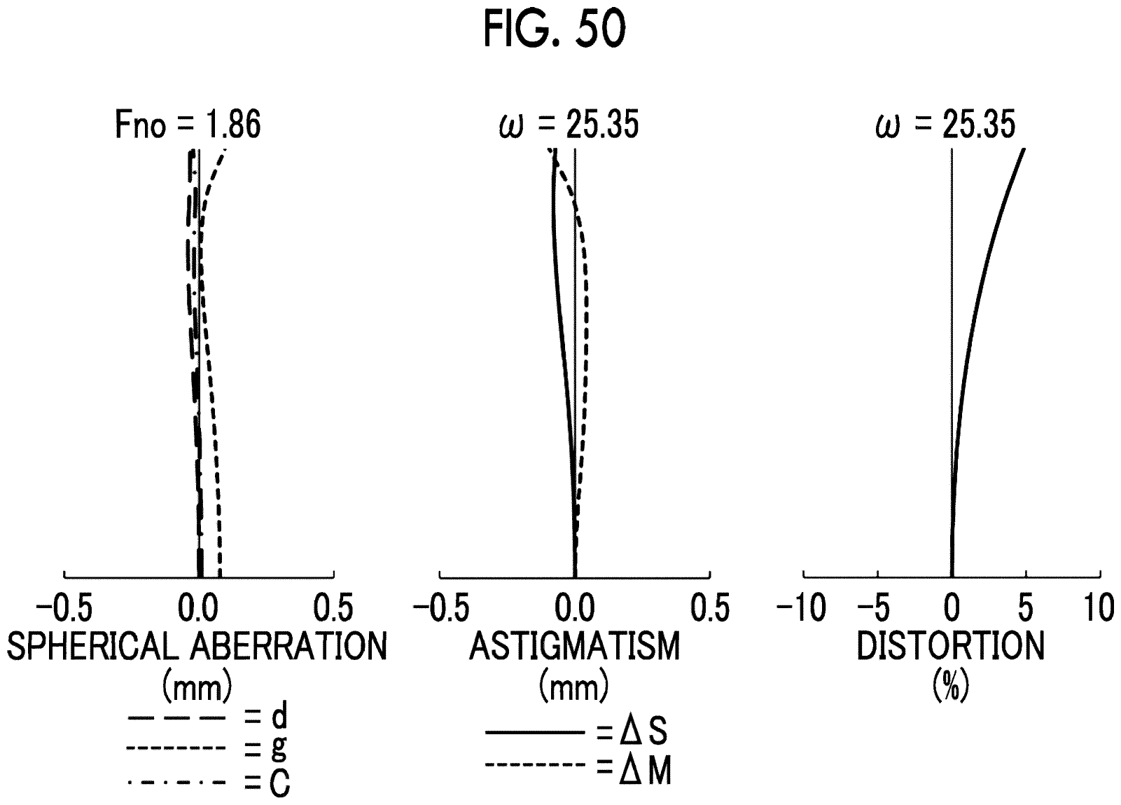

FIG. 51 is a lateral aberration diagram at the telephoto end and during focusing on infinity in Example 4.

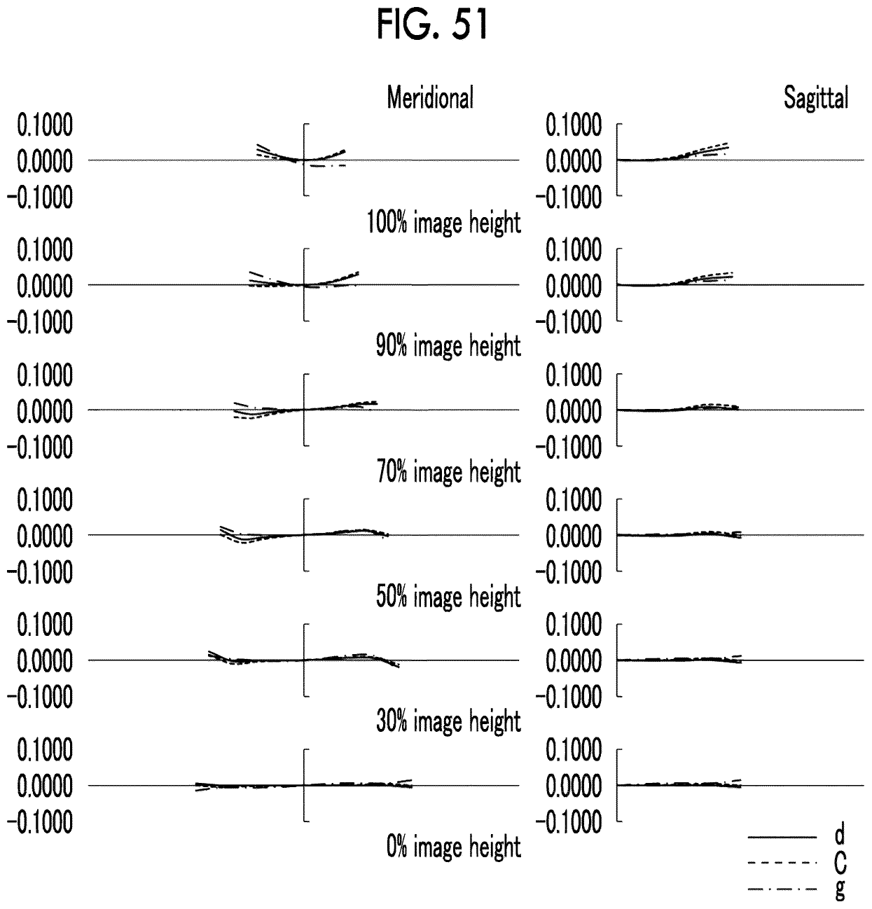

FIG. 52 is a lateral aberration diagram at the telephoto end and a focusing distance of 1868 mm in Example 4.

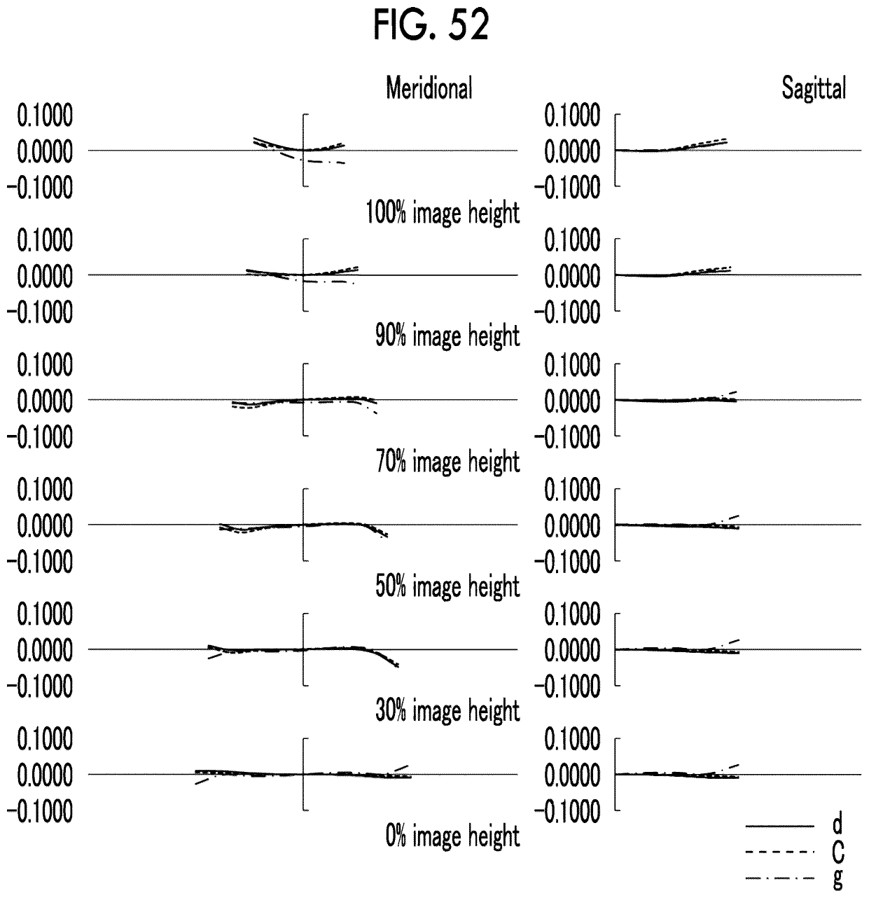

FIG. 53 is a lens configuration diagram at a wide-angle end and during focusing on infinity in Example 5.

FIG. 54 is a longitudinal aberration diagram at the wide-angle end and during focusing on infinity in Example 5.

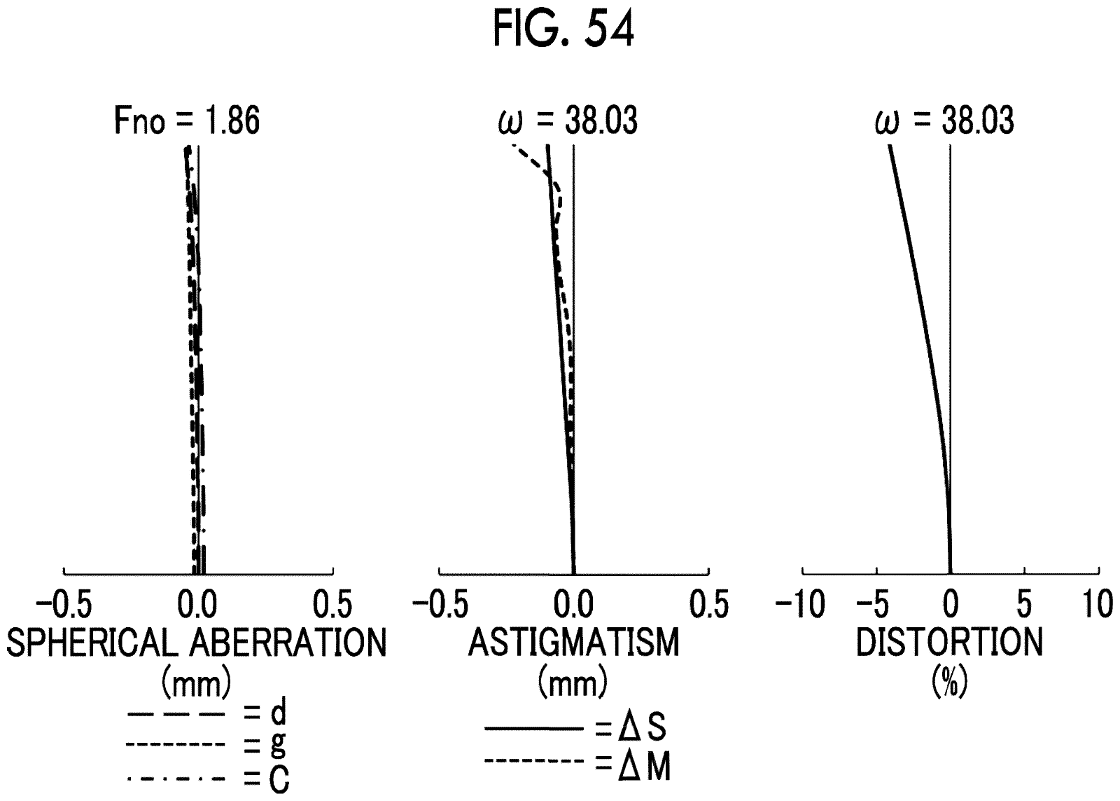

FIG. 55 is a longitudinal aberration diagram at the wide-angle end and a focusing distance of 1273 mm in Example 5.

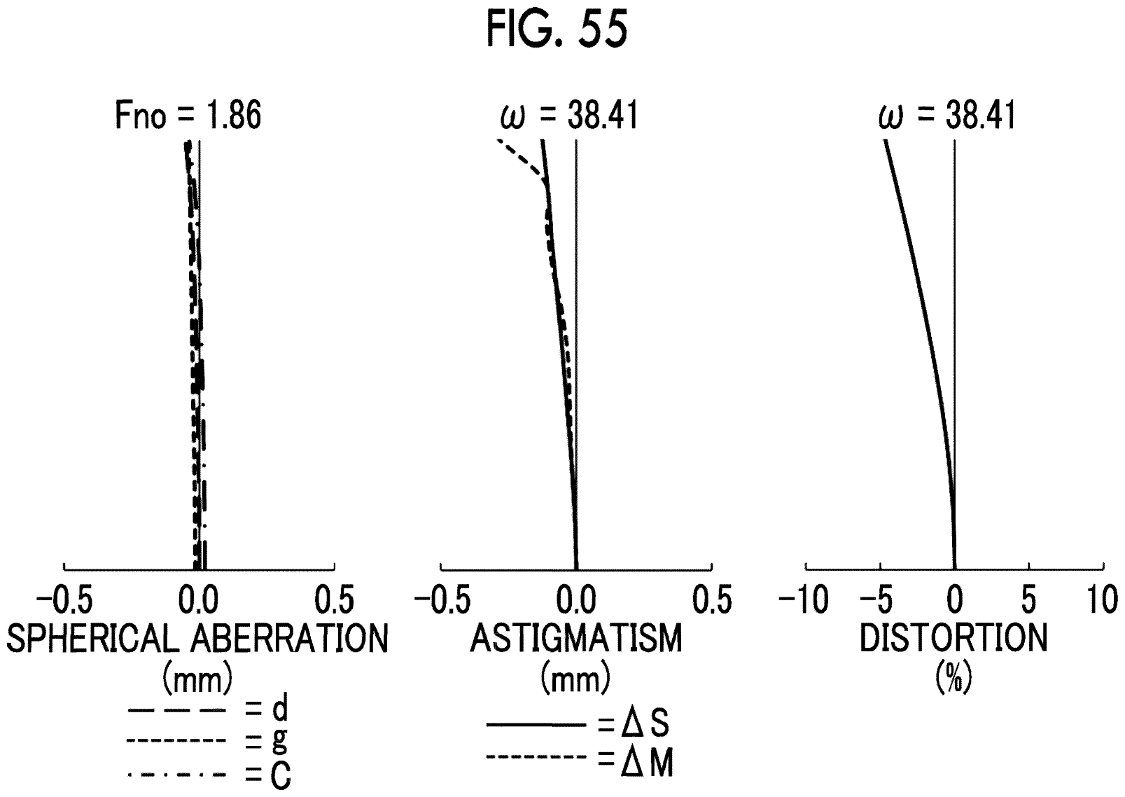

FIG. 56 is a lateral aberration diagram at the wide-angle end and during focusing on infinity in Example 5.

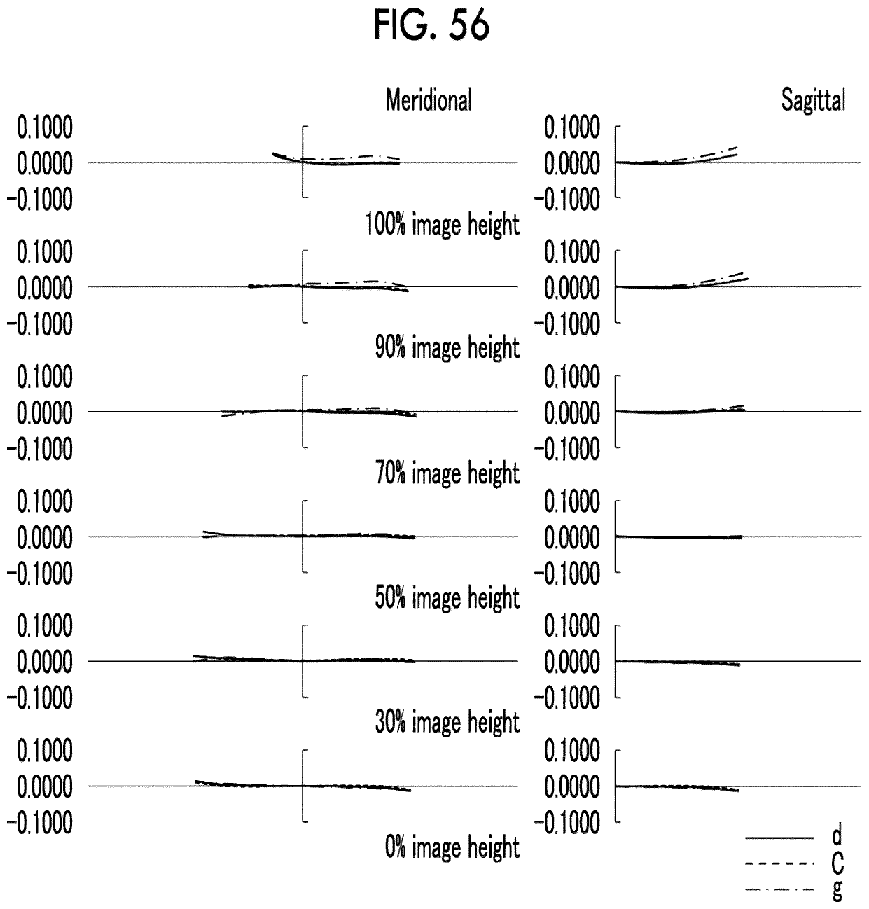

FIG. 57 is a lateral aberration diagram at the wide-angle end and a focusing distance of 1273 mm in Example 5.

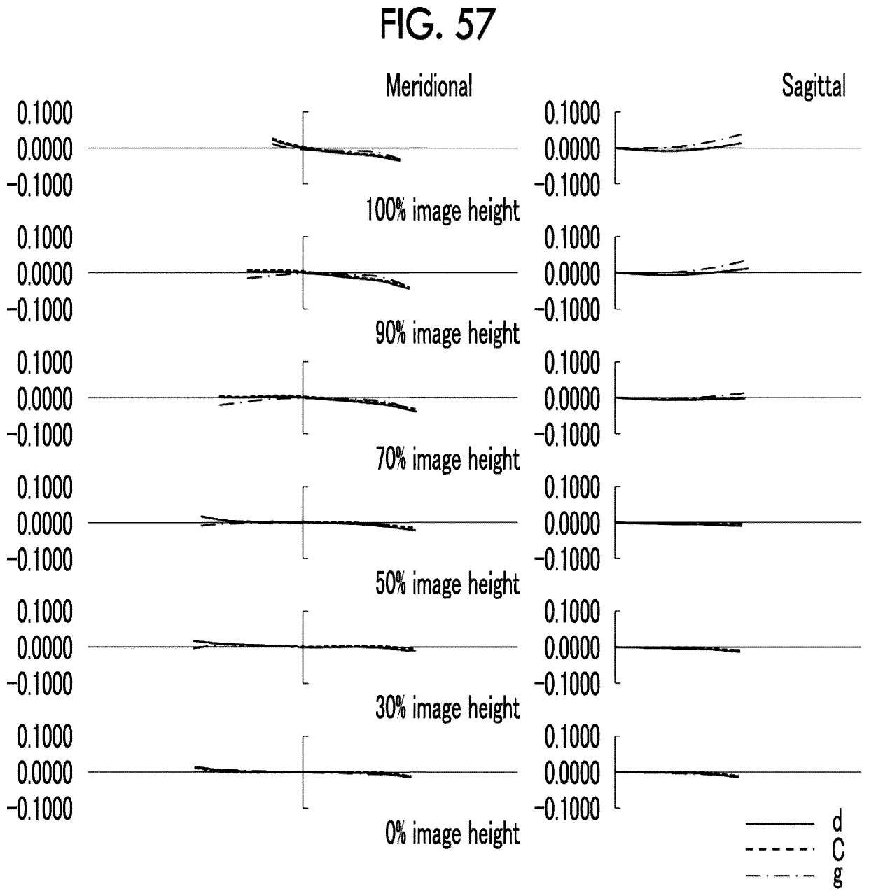

FIG. 58 is a longitudinal aberrations diagram at a middle focal length and during focusing on infinity in Example 5.

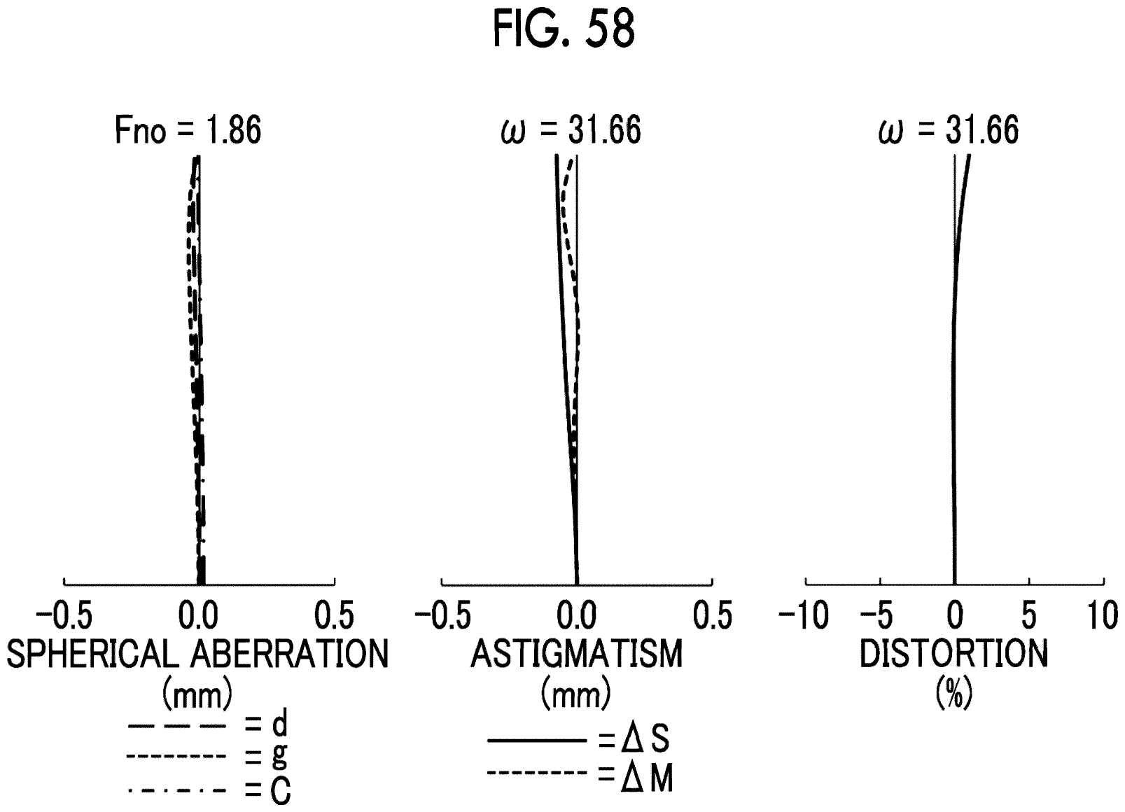

FIG. 59 is a longitudinal aberration diagram at the middle focal length and a focusing distance of 1509 mm in Example 5.

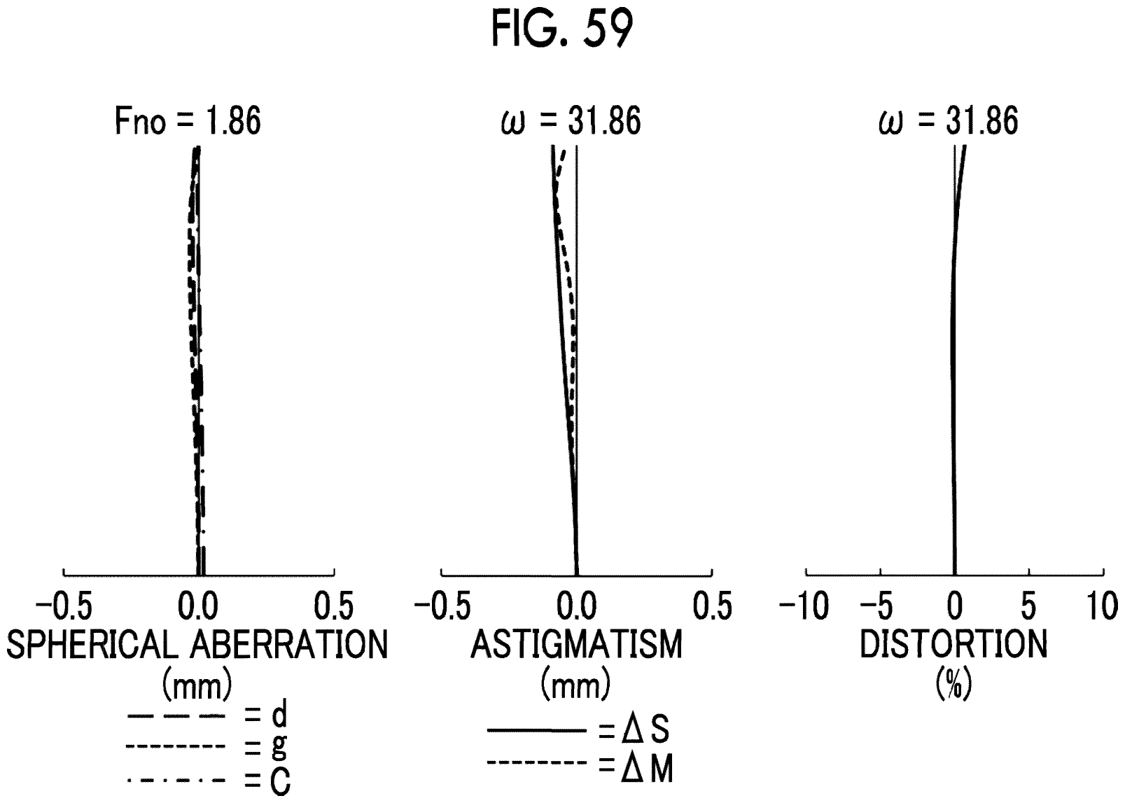

FIG. 60 is a lateral aberration diagram at the middle focal length and during focusing on infinity in Example 5.

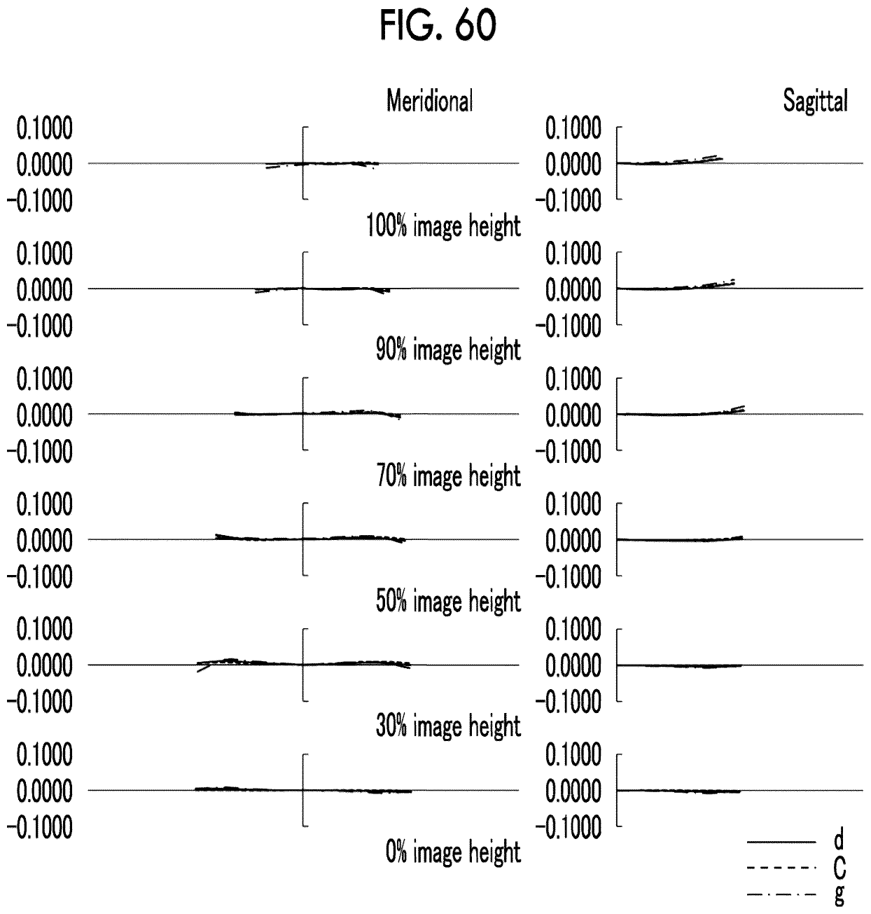

FIG. 61 is a lateral aberration diagram at the middle focal length and a focusing distance of 1509 mm in Example 5.

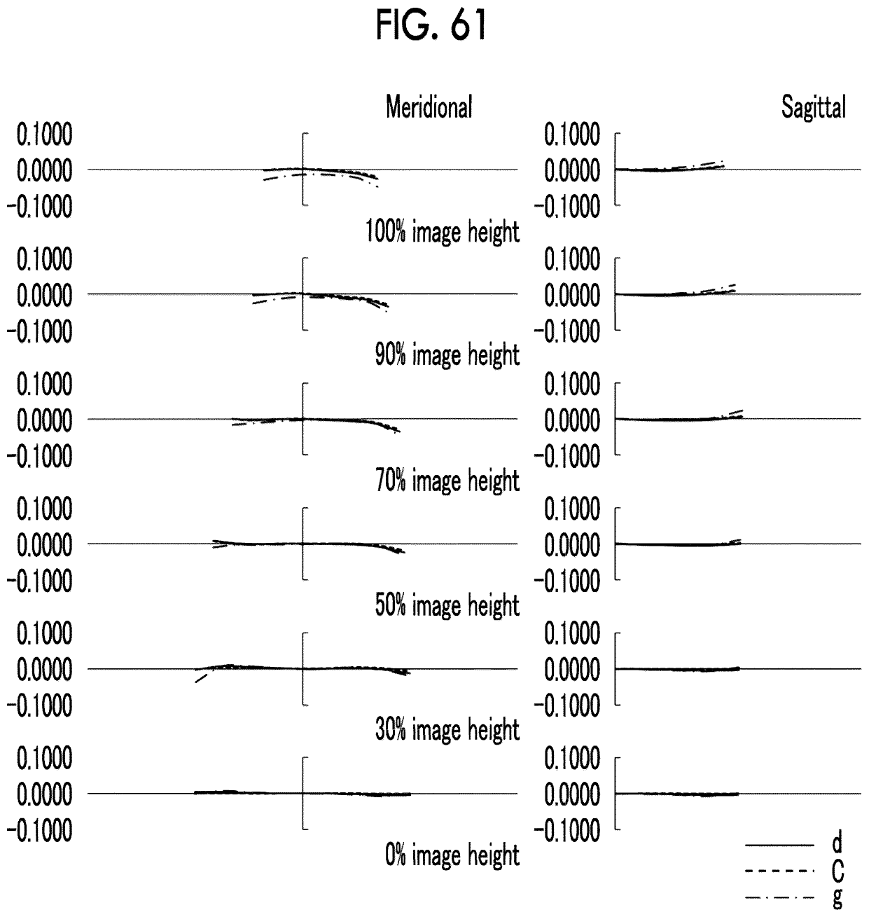

FIG. 62 is a longitudinal aberration diagram at a telephoto end and during focusing on infinity in Example 5.

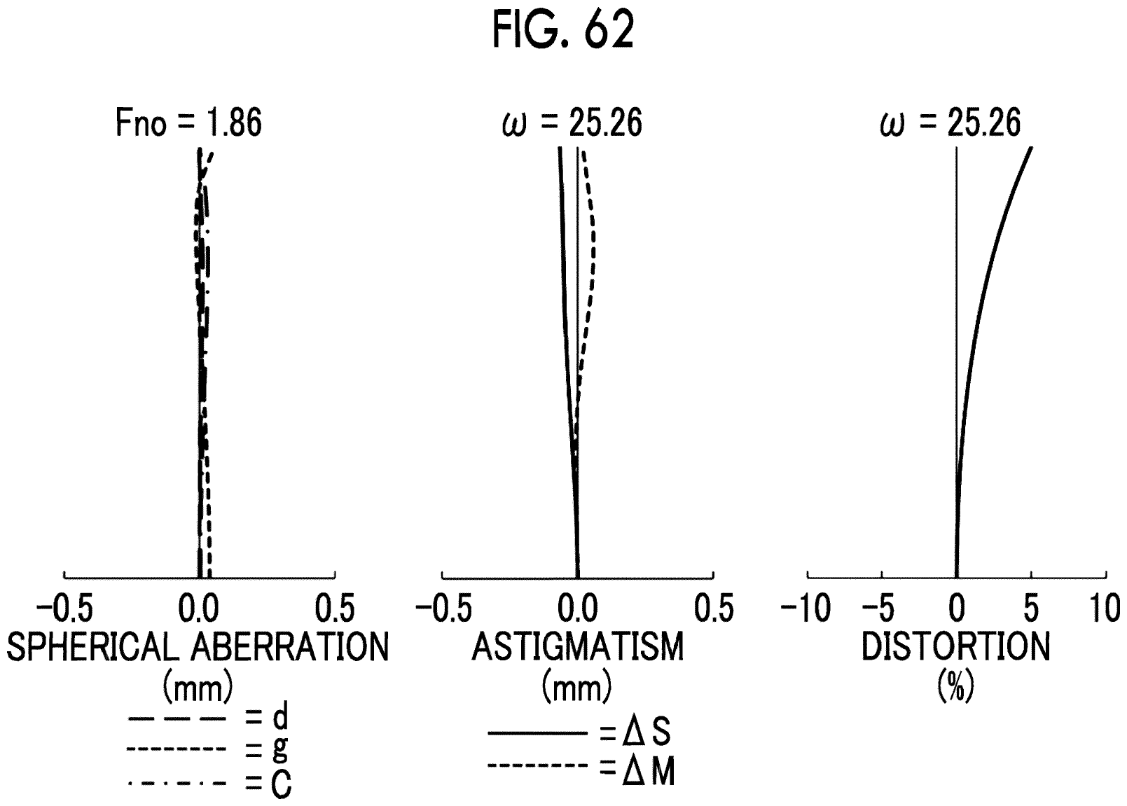

FIG. 63 is a longitudinal aberration diagram at the telephoto end and a focusing distance of 1867 mm in Example 5.

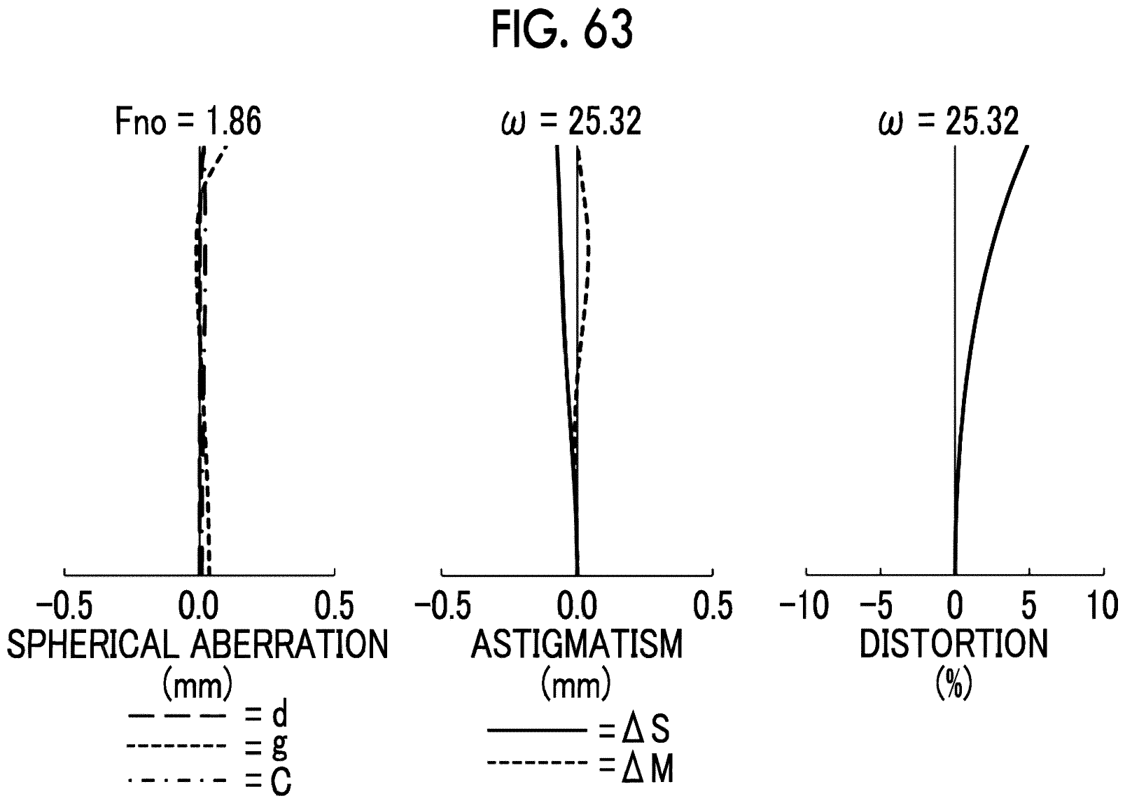

FIG. 64 is a lateral aberration diagram at the telephoto end and during focusing on infinity in Example 5.

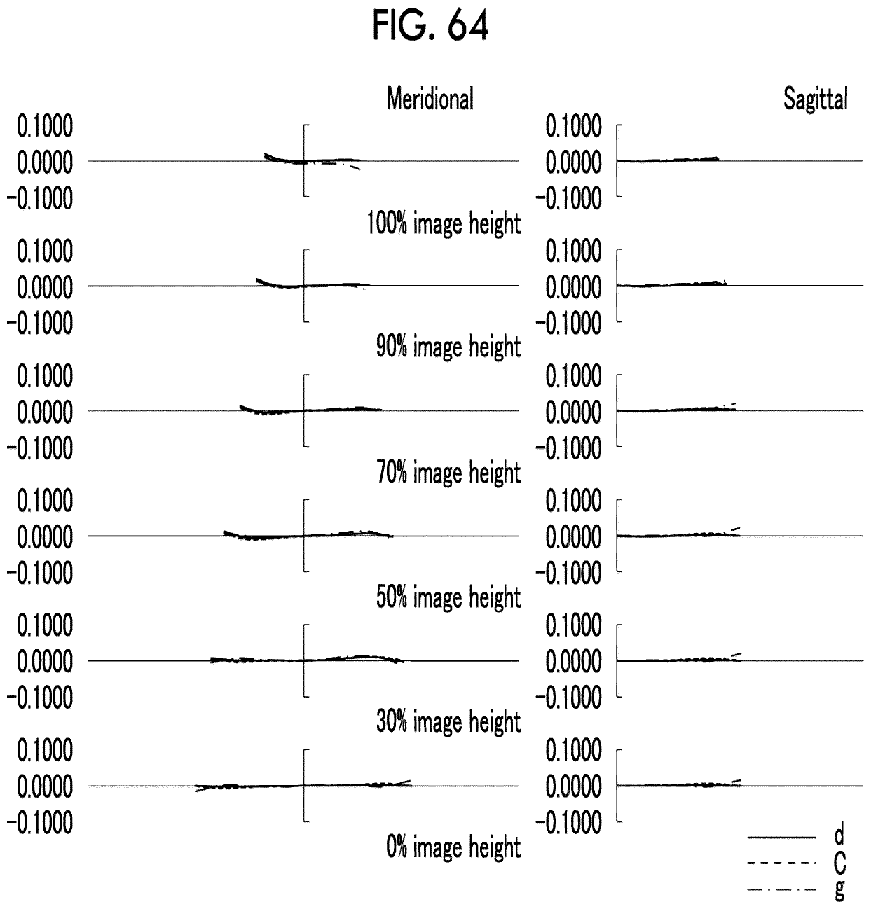

FIG. 65 is a lateral aberration diagram at the telephoto end and a focusing distance of 1867 mm in Example 5.

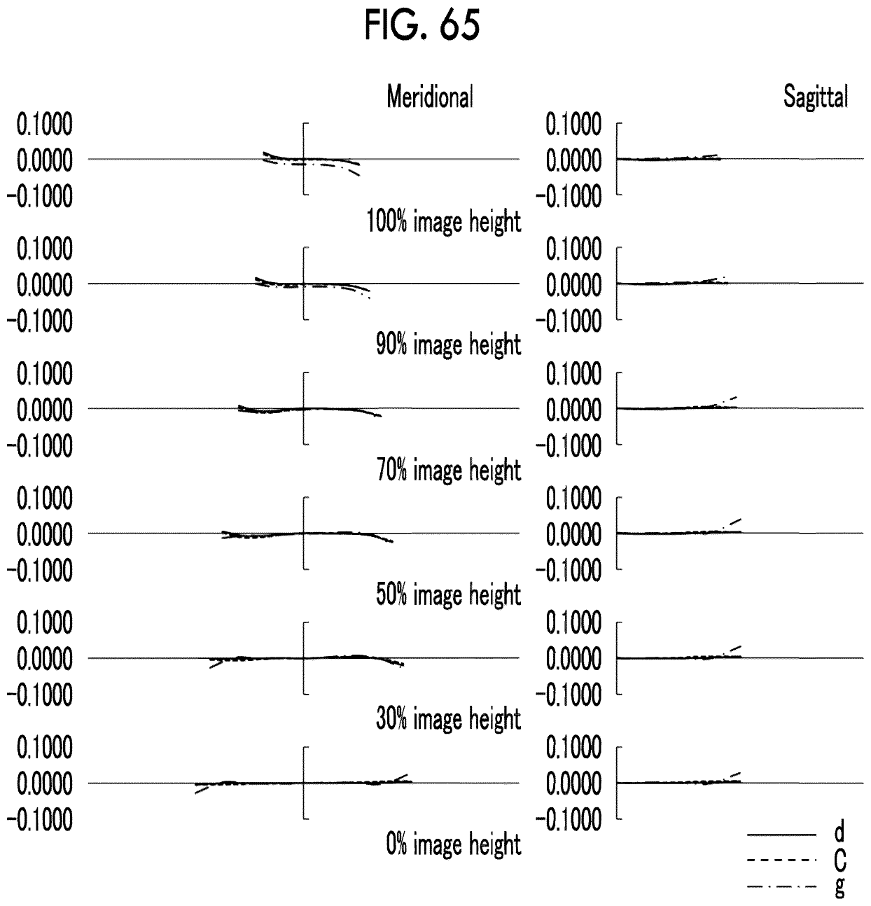

FIG. 66 is a lens configuration diagram at a wide-angle end and during focusing on infinity in Example 6.

FIG. 67 is a longitudinal aberration diagram at the wide-angle end and during focusing on infinity in Example 6.

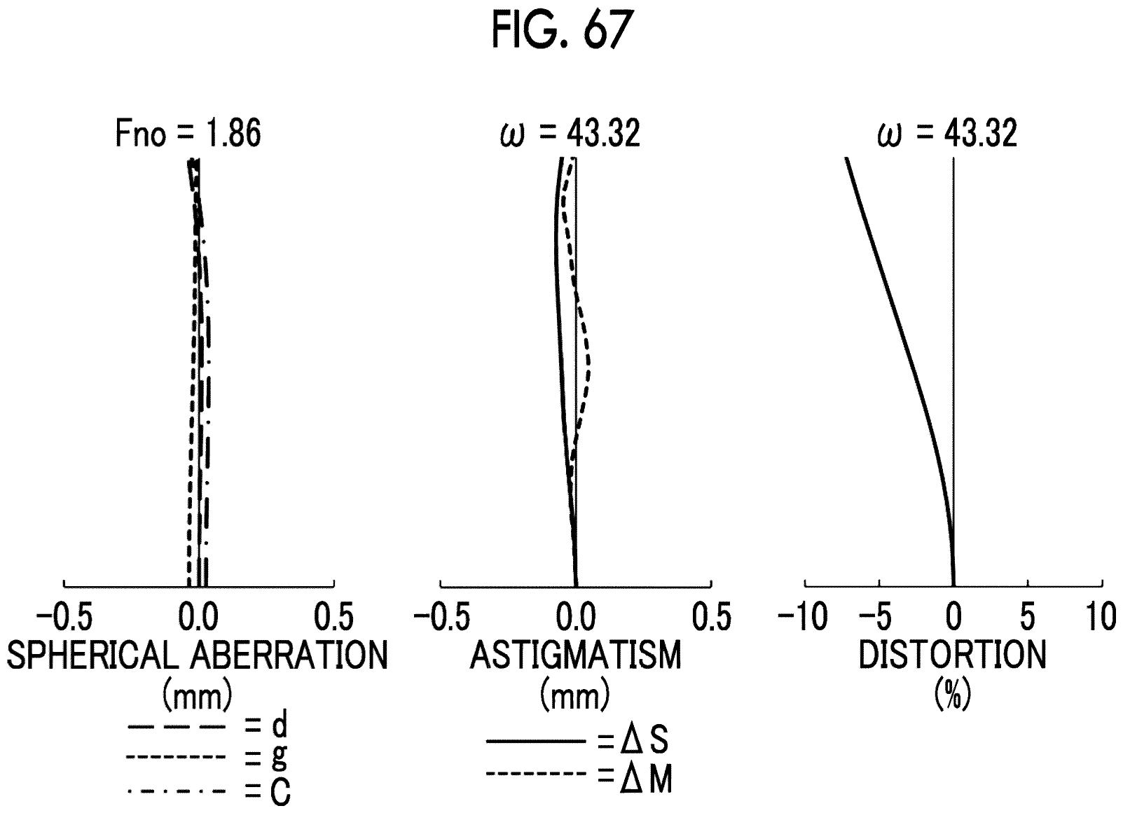

FIG. 68 is a longitudinal aberration diagram at the wide-angle end and a focusing distance of 1115 mm in Example 6.

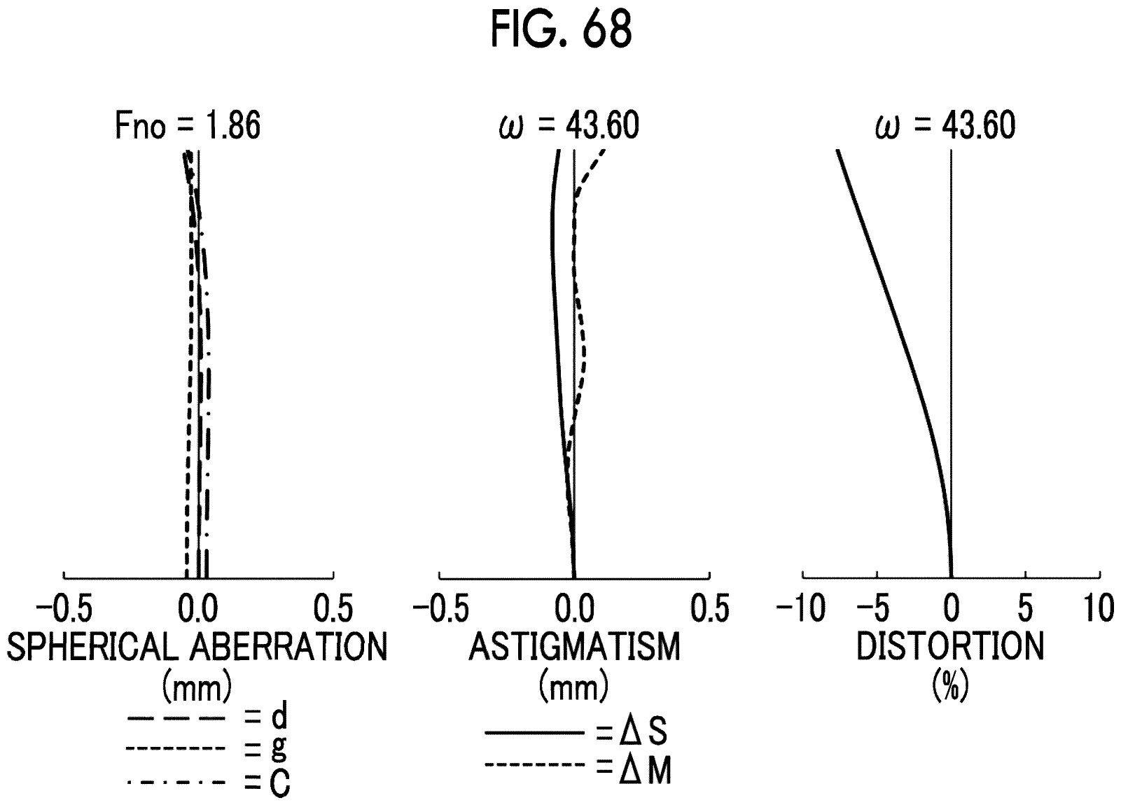

FIG. 69 is a lateral aberration diagram at the wide-angle end and during focusing on infinity in Example 6.

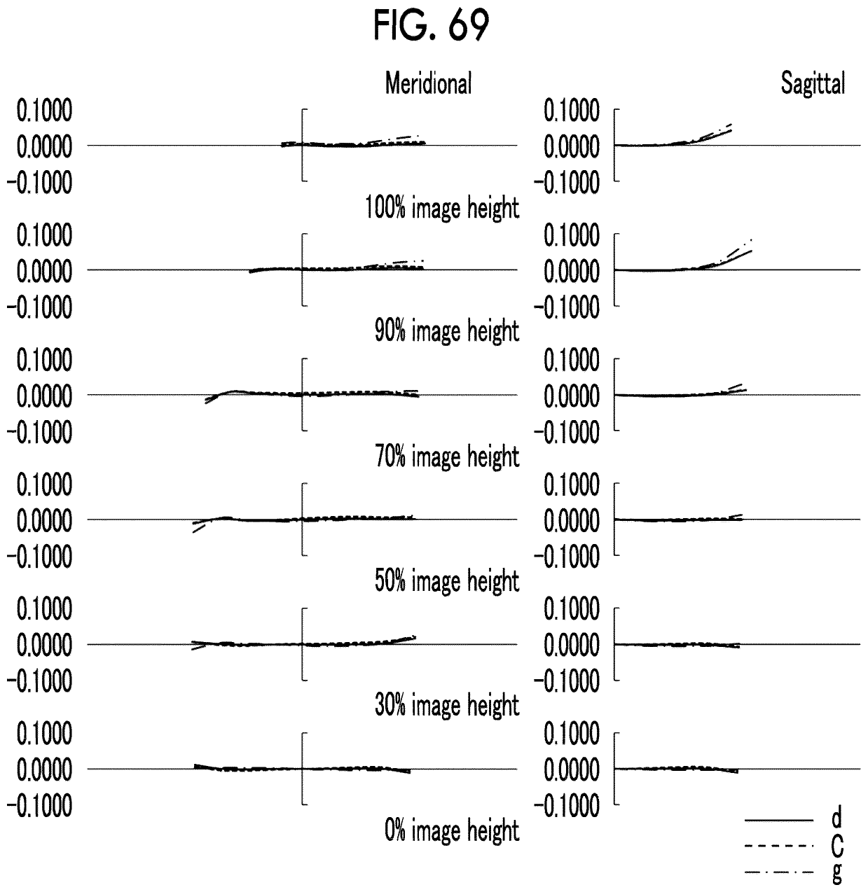

FIG. 70 is a lateral aberration diagram at the wide-angle end and a focusing distance of 1115 mm in Example 6.

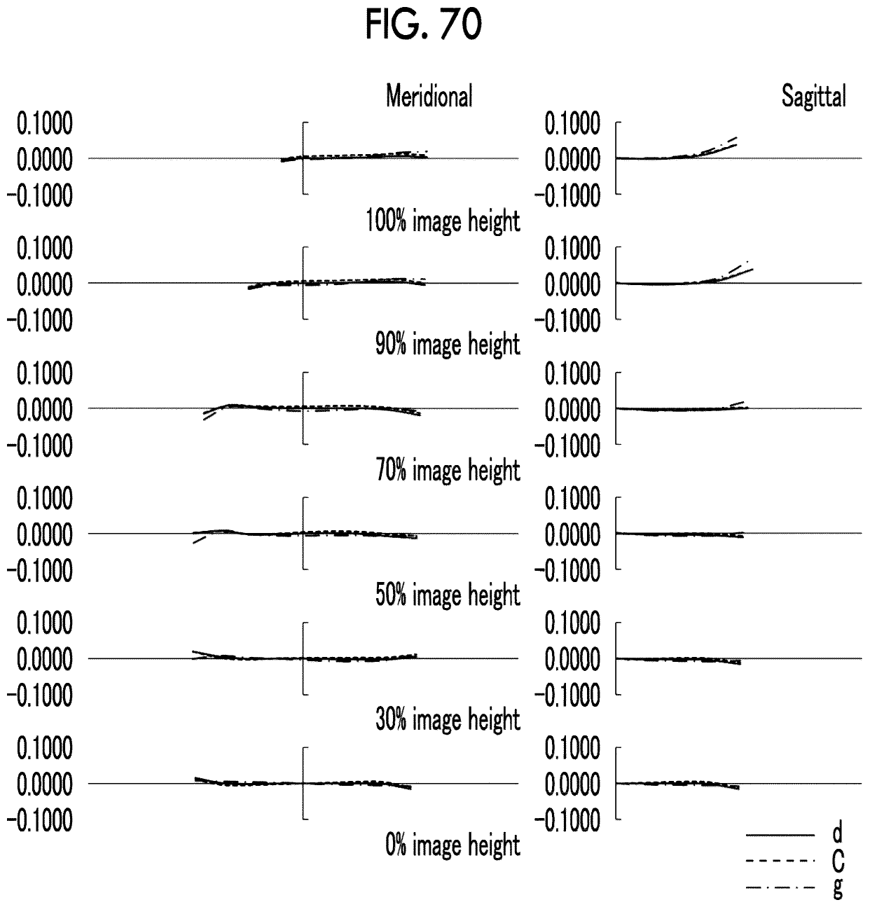

FIG. 71 is a longitudinal aberration diagram at a middle focal length and during focusing on infinity in Example 6.

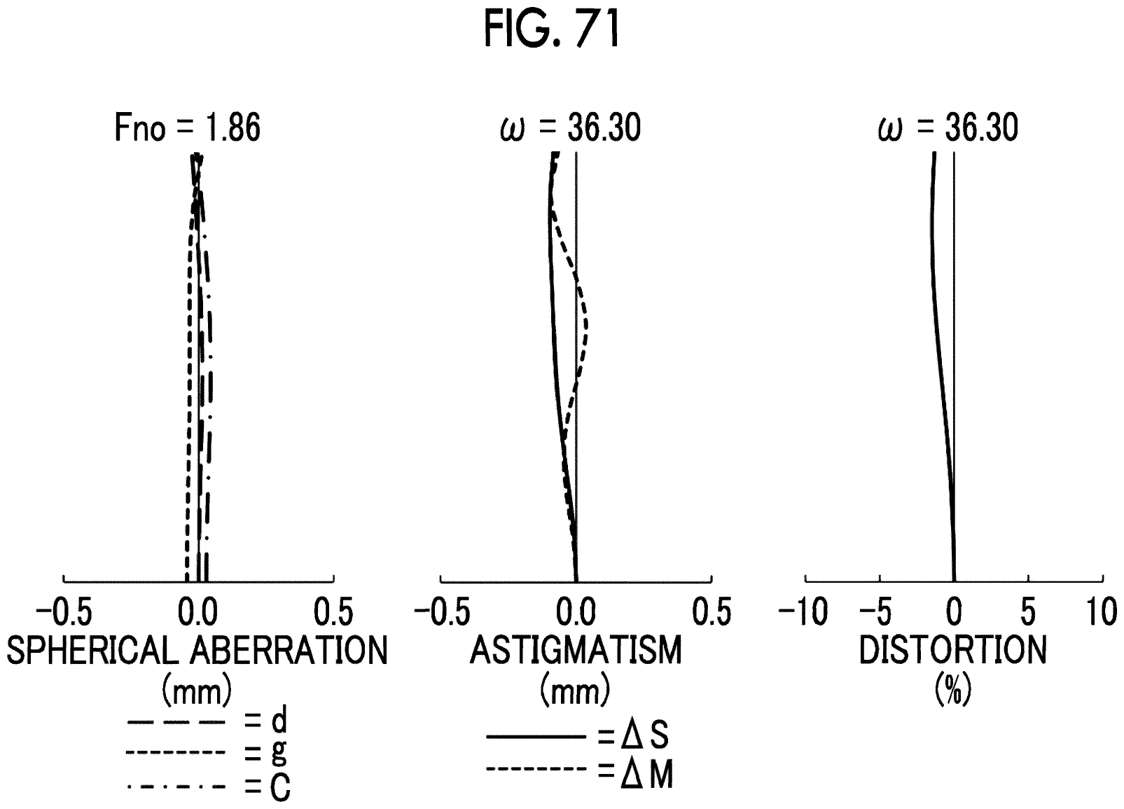

FIG. 72 is a longitudinal aberration diagram at the middle focal length and a focusing distance of 1320 mm in Example 6.

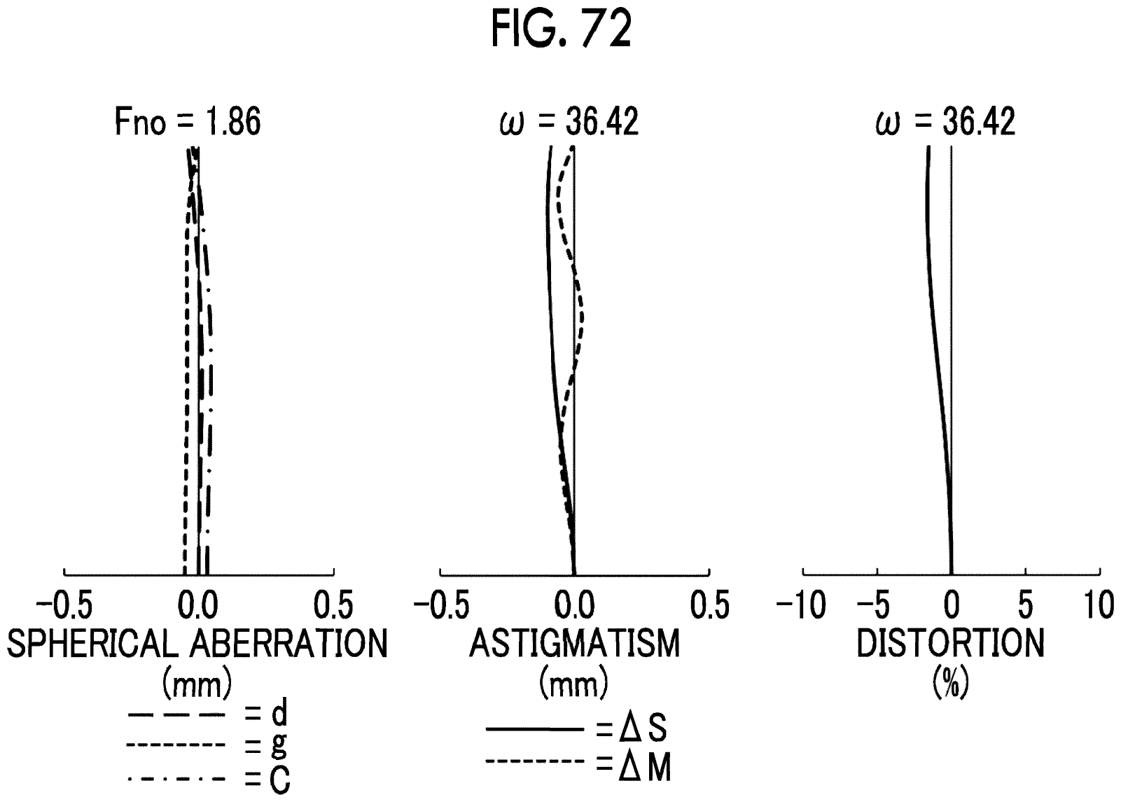

FIG. 73 is a lateral aberration diagram at the middle focal length and during focusing on infinity in Example 6.

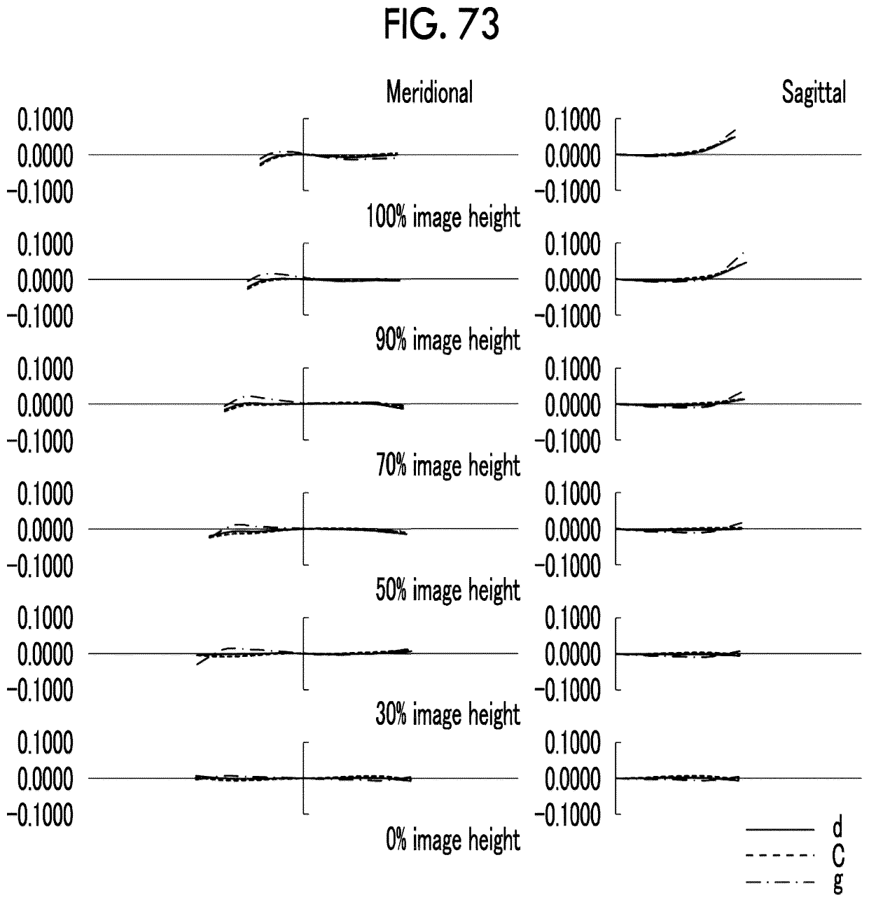

FIG. 74 is a lateral aberration diagram at the middle focal length and a focusing distance of 1320 mm in Example 6.

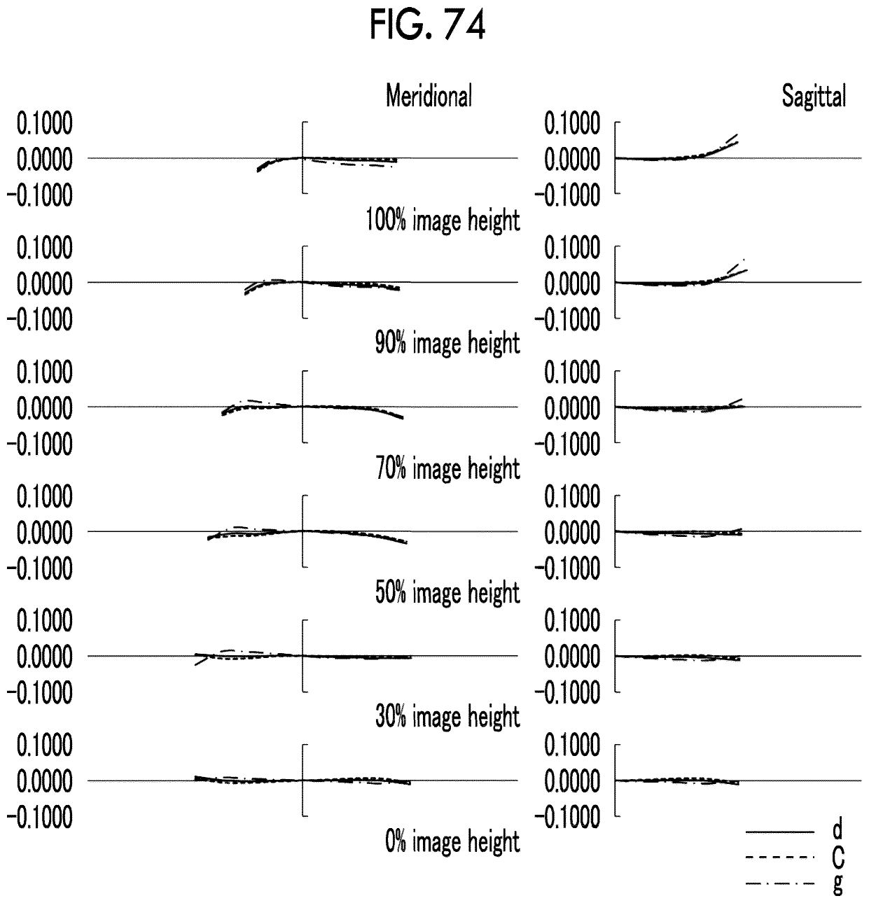

FIG. 75 is a longitudinal aberration diagram at the telephoto end and during focusing on infinity in Example 6.

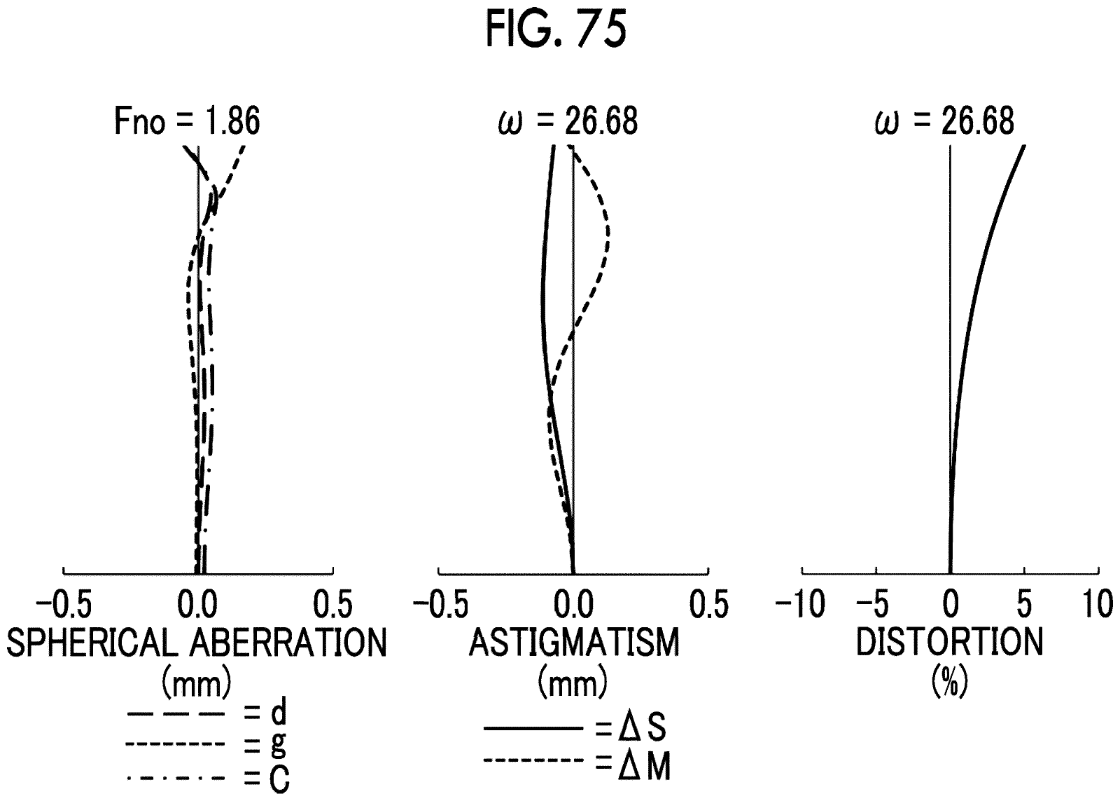

FIG. 76 is a longitudinal aberration diagram at the telephoto end and a focusing distance of 1768 mm in Example 6.

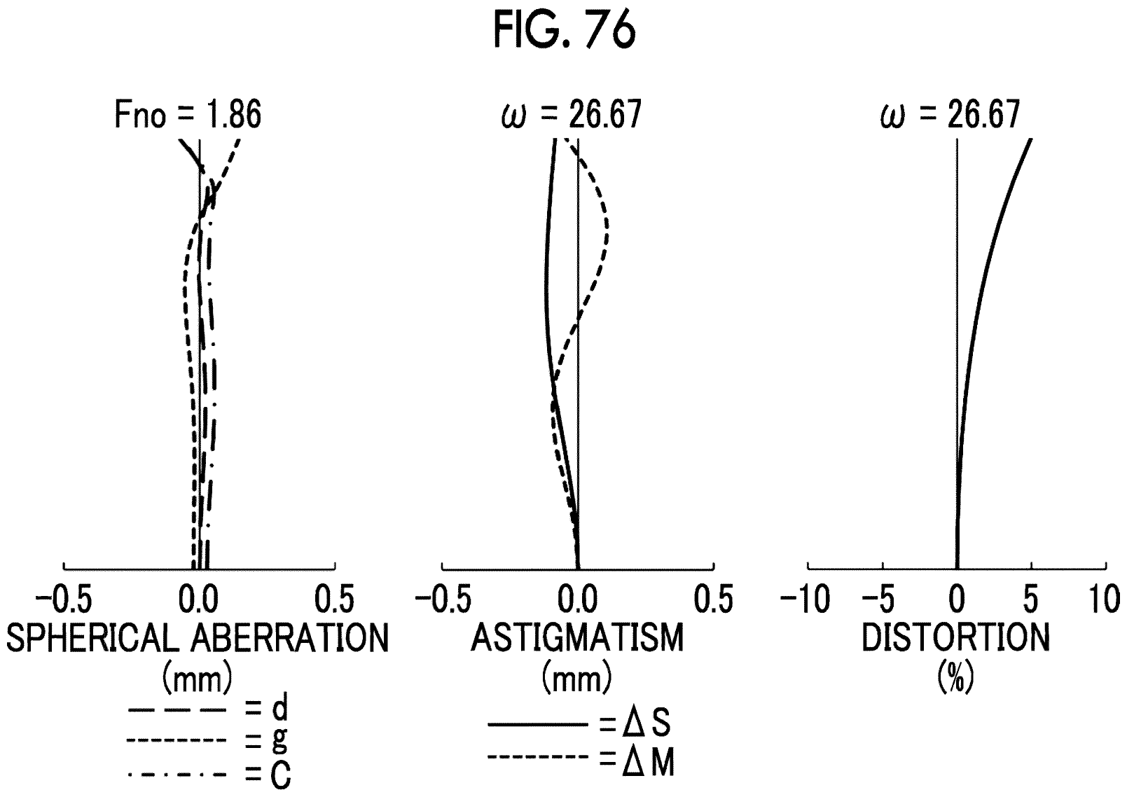

FIG. 77 is a lateral aberration diagram at the telephoto end and during focusing on infinity in Example 6.

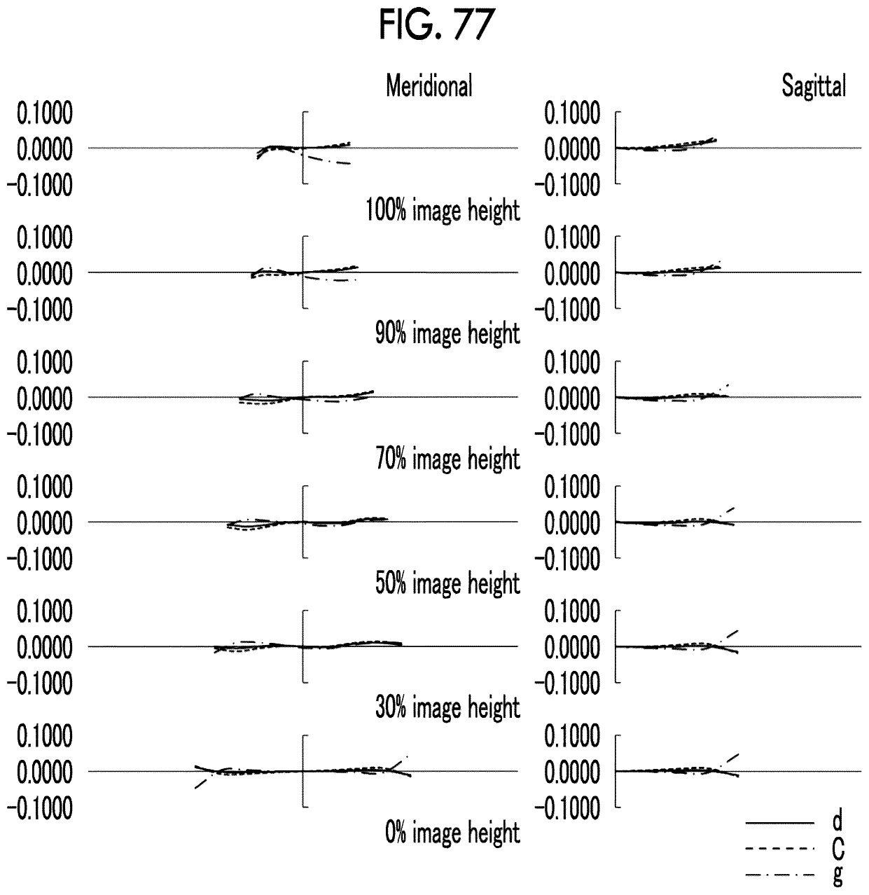

FIG. 78 is a lateral aberration diagram at the telephoto end and a focusing distance of 1768 mm in Example 6.

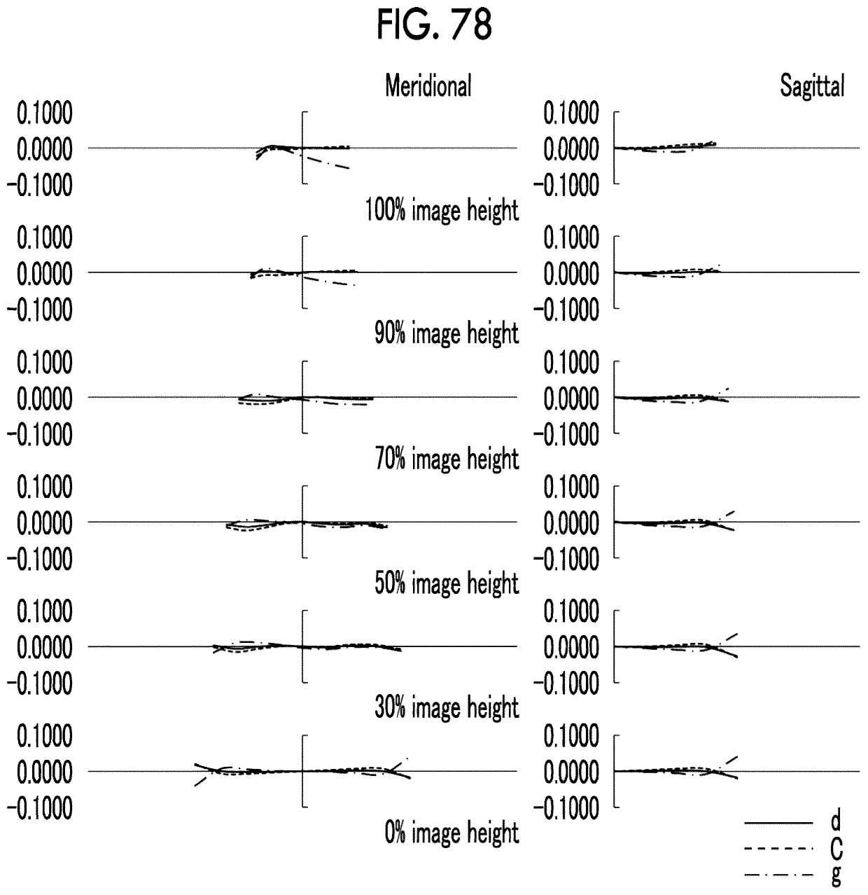

FIG. 79 is a lens configuration diagram at a wide-angle end and during focusing on infinity in Example 7.

FIG. 80 is a longitudinal aberration diagram at the wide-angle end and during focusing on infinity in Example 7.

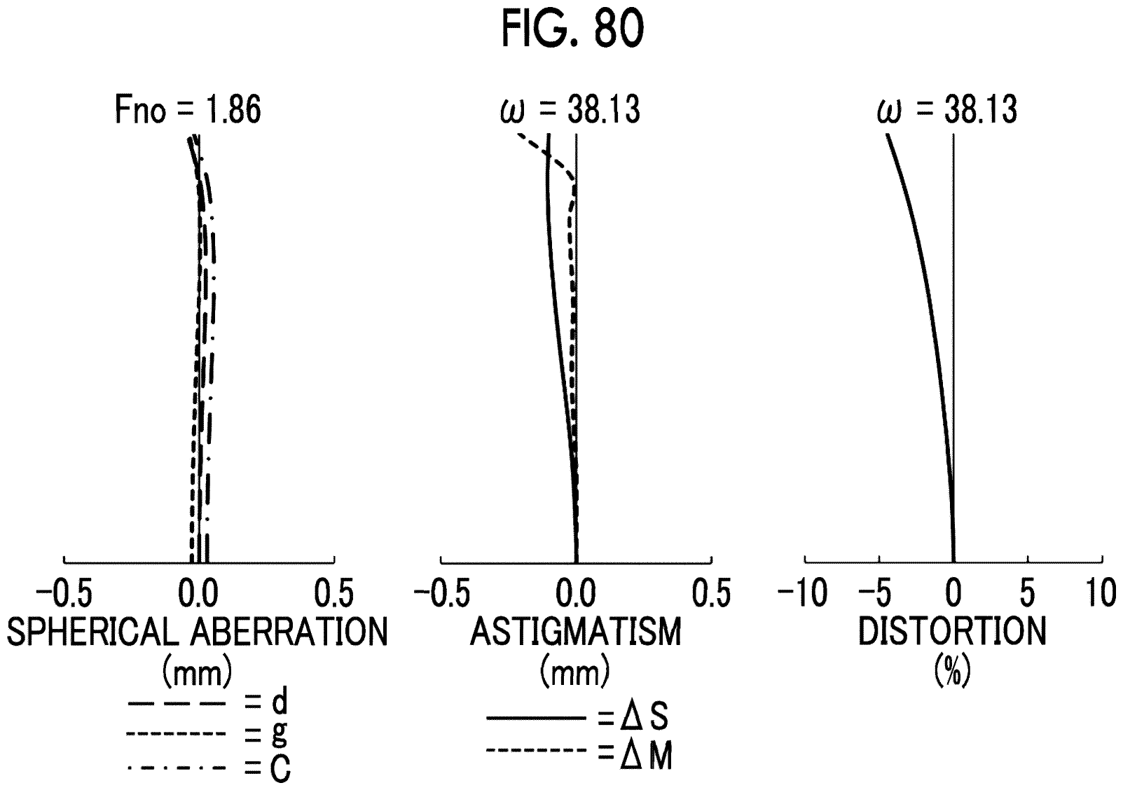

FIG. 81 is a longitudinal aberration diagram at the wide-angle end and a focusing distance of 1265 mm in Example 7.

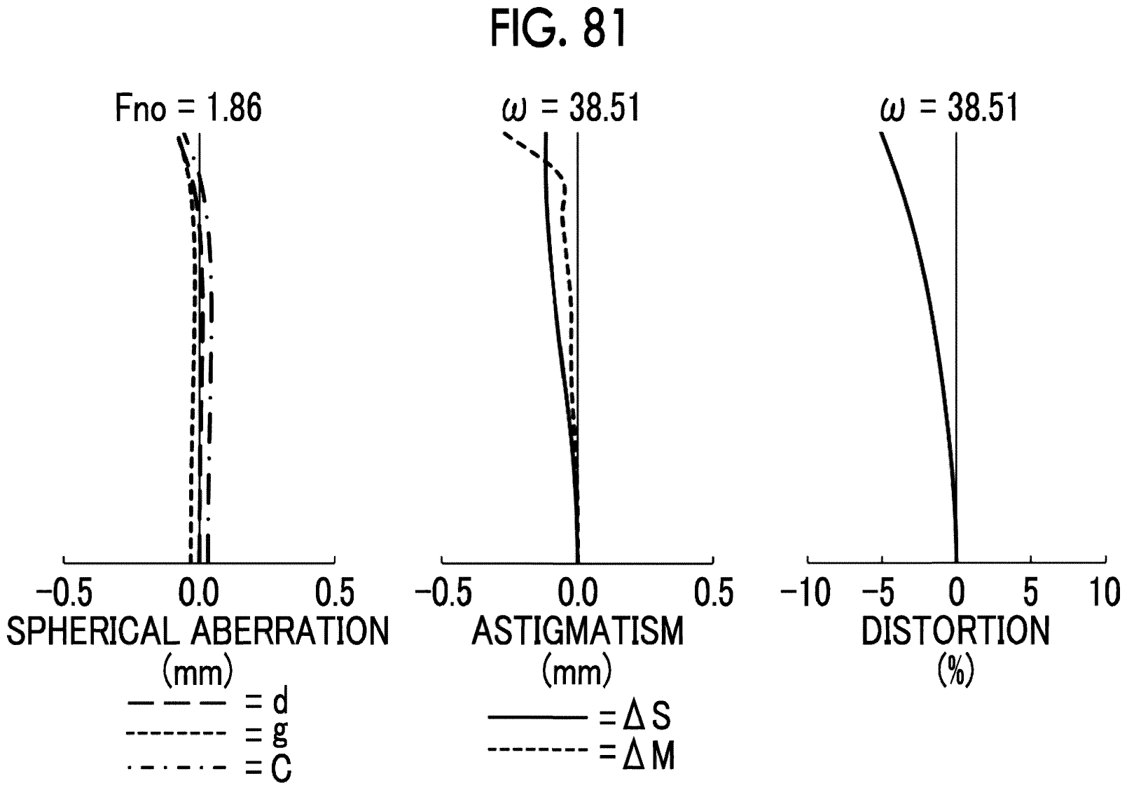

FIG. 82 is a lateral aberration diagram at the wide-angle end and during focusing on infinity in Example 7.

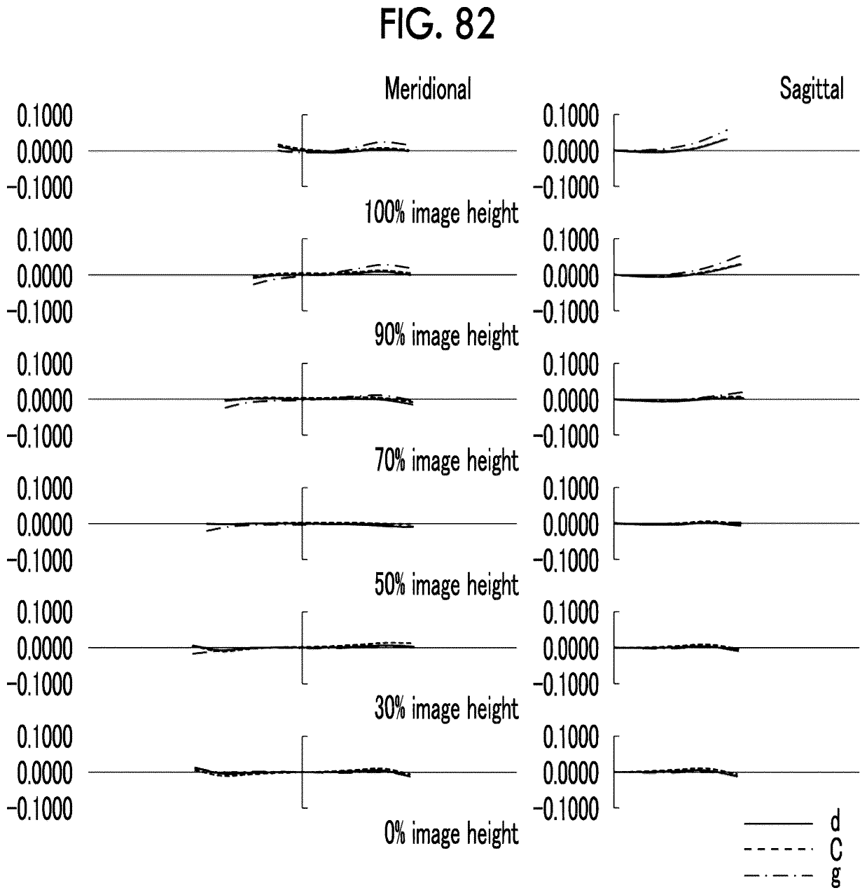

FIG. 83 is a lateral aberration diagram at the wide-angle end and a focusing distance of 1265 mm in Example 7.

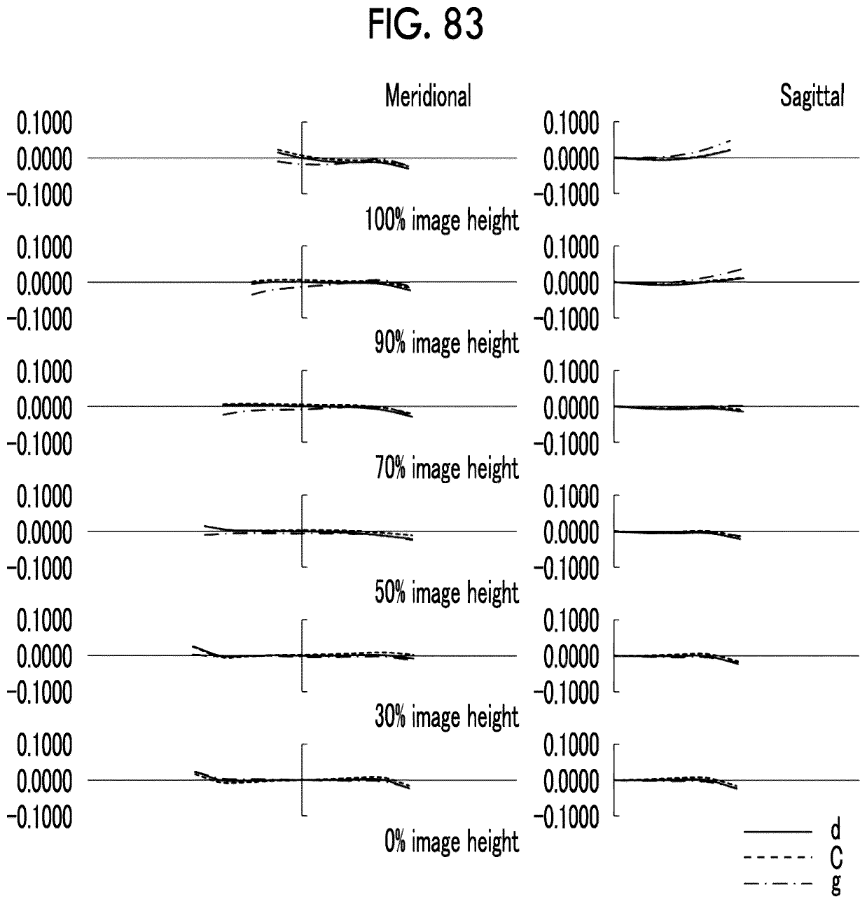

FIG. 84 is a longitudinal aberrations diagram at a middle focal length and during focusing on infinity in Example 7.

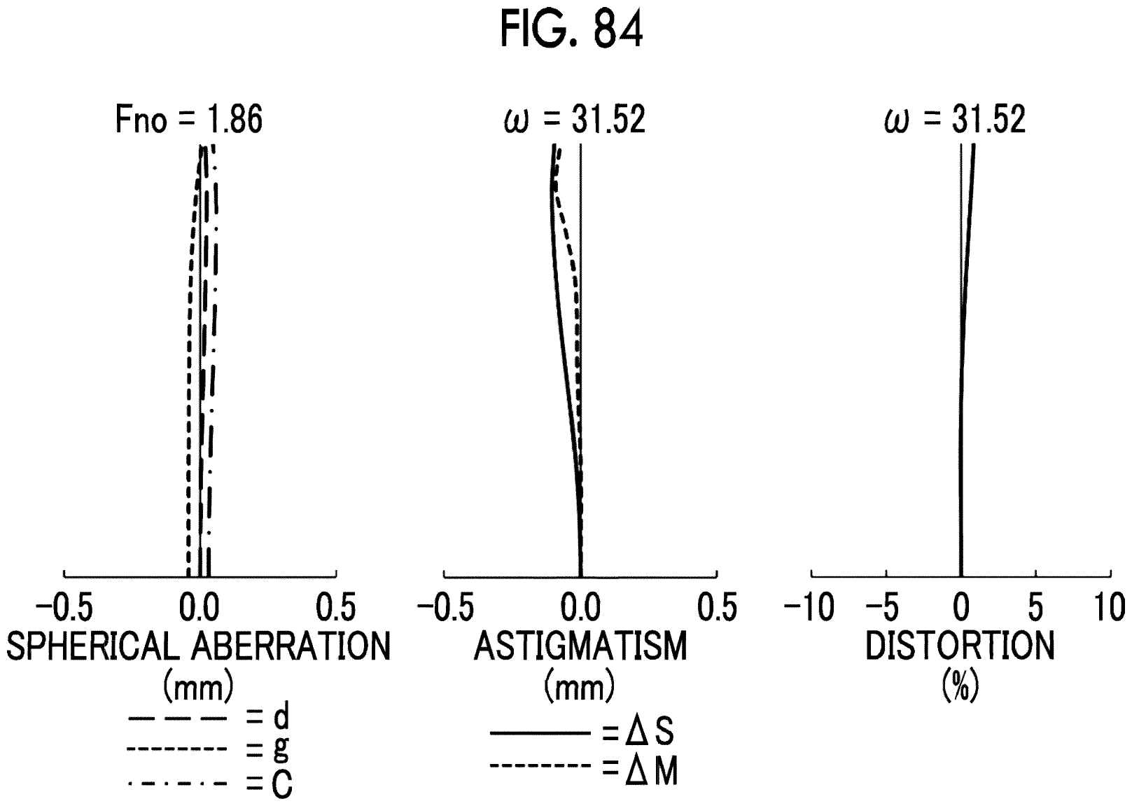

FIG. 85 is a longitudinal aberration diagram at the middle focal length and a focusing distance of 1510 mm in Example 7.

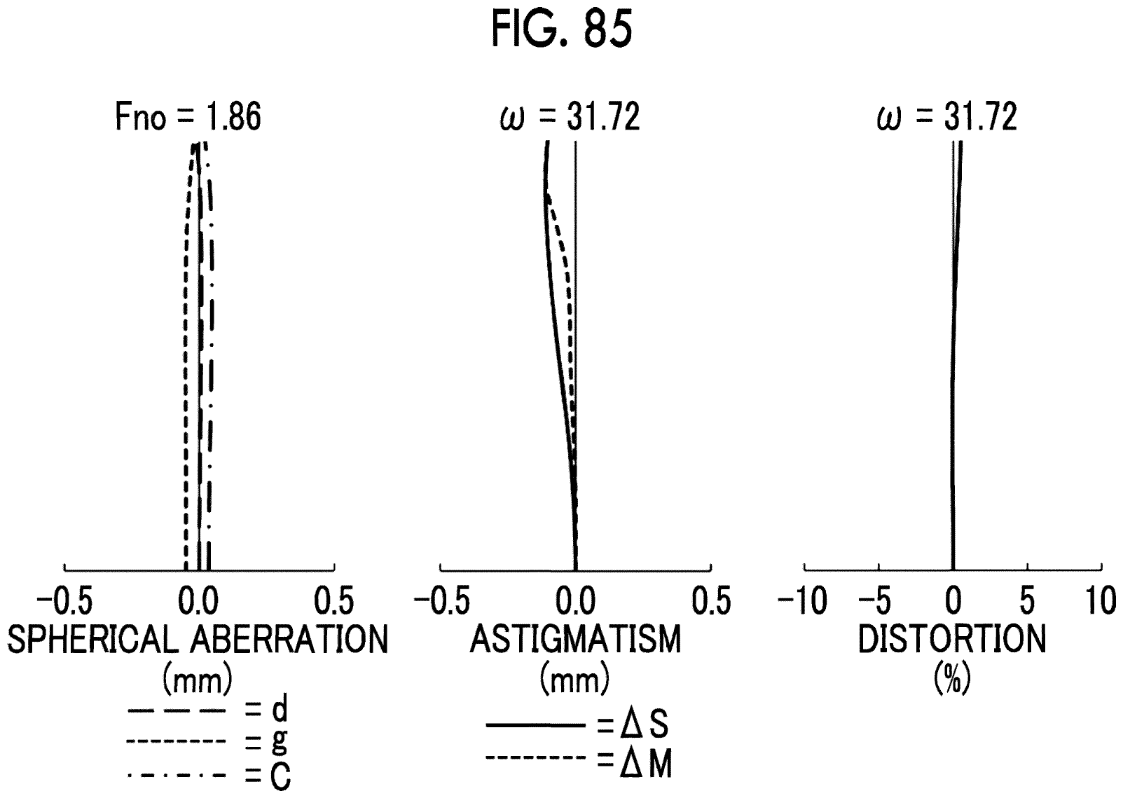

FIG. 86 is a lateral aberration diagram at the middle focal length and during focusing on infinity in Example 7.

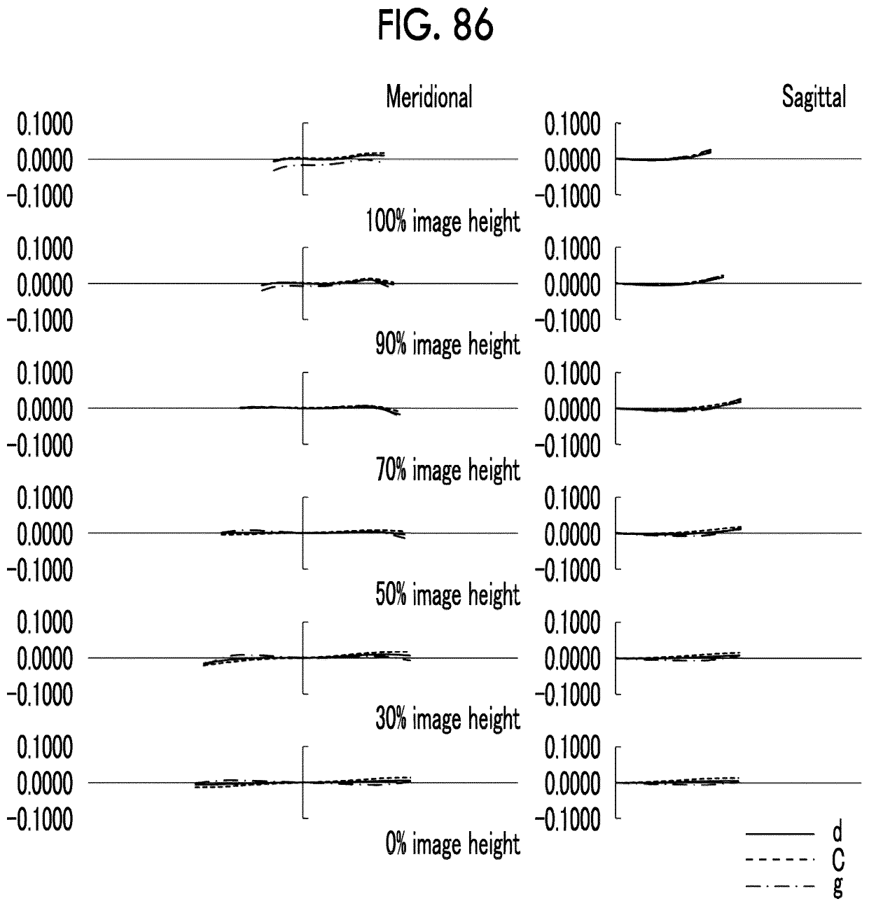

FIG. 87 is a lateral aberration diagram at the middle focal length and a focusing distance of 1510 mm in Example 7.

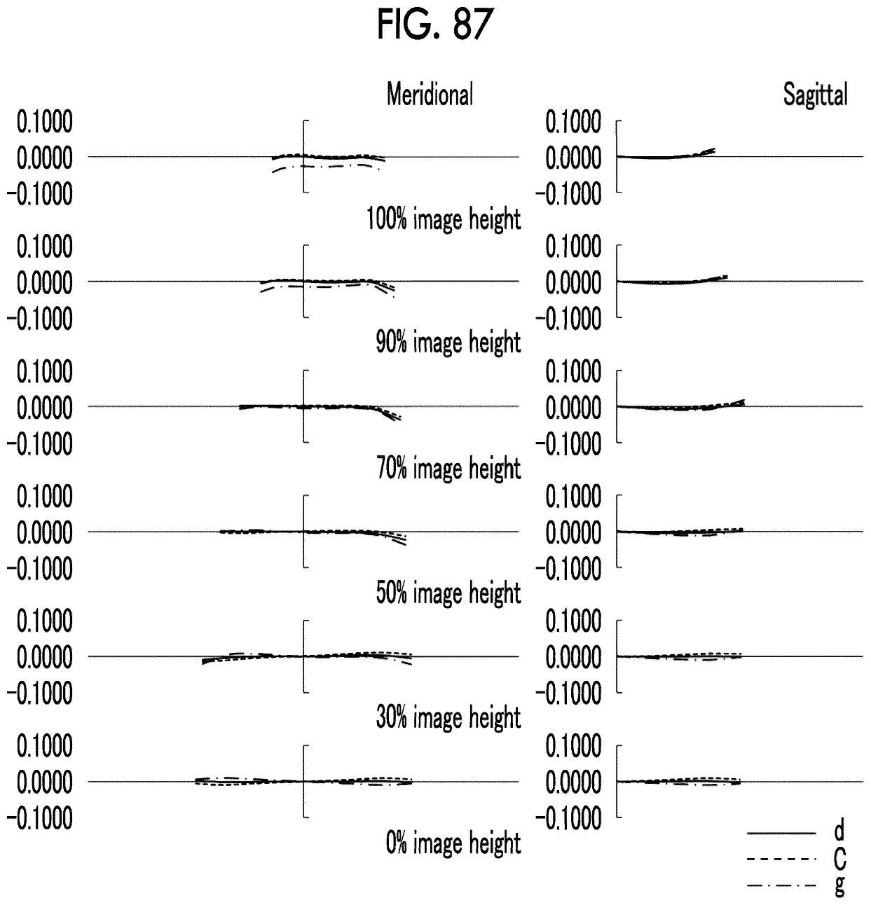

FIG. 88 is a longitudinal aberration diagram at a telephoto end and during focusing on infinity in Example 7.

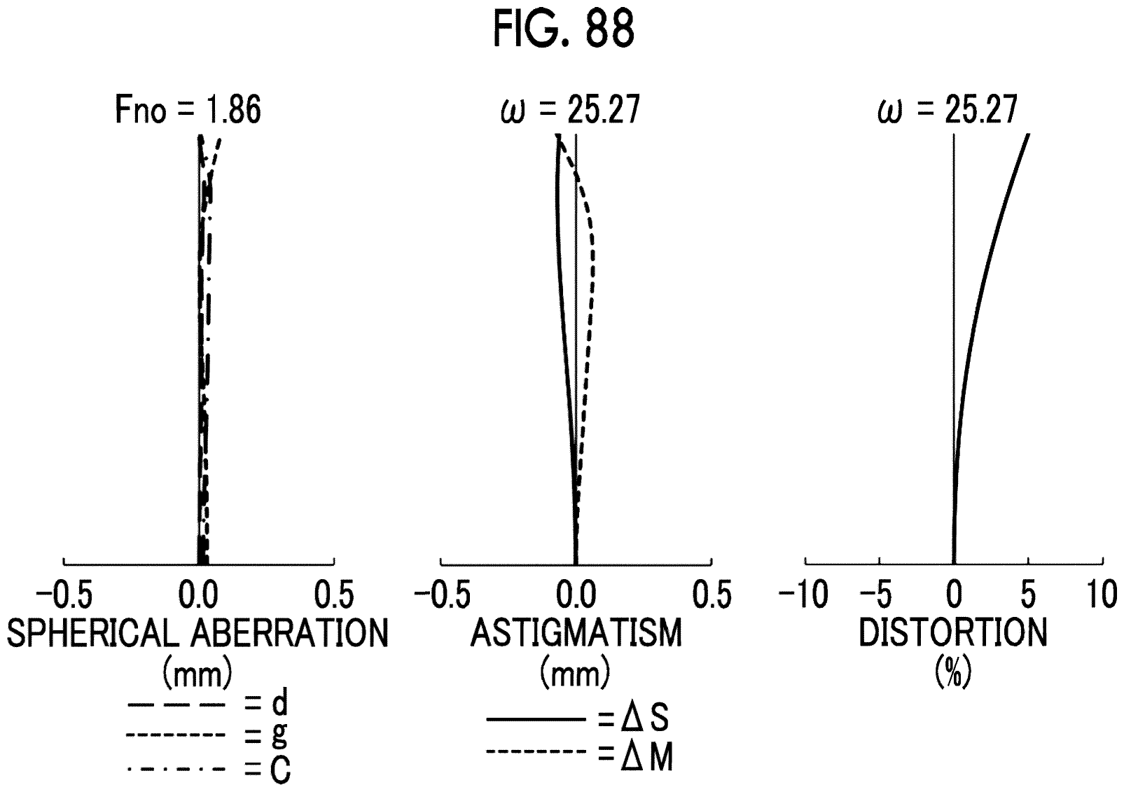

FIG. 89 is a longitudinal aberration diagram at the telephoto end and a focusing distance of 1858 mm in Example 7.

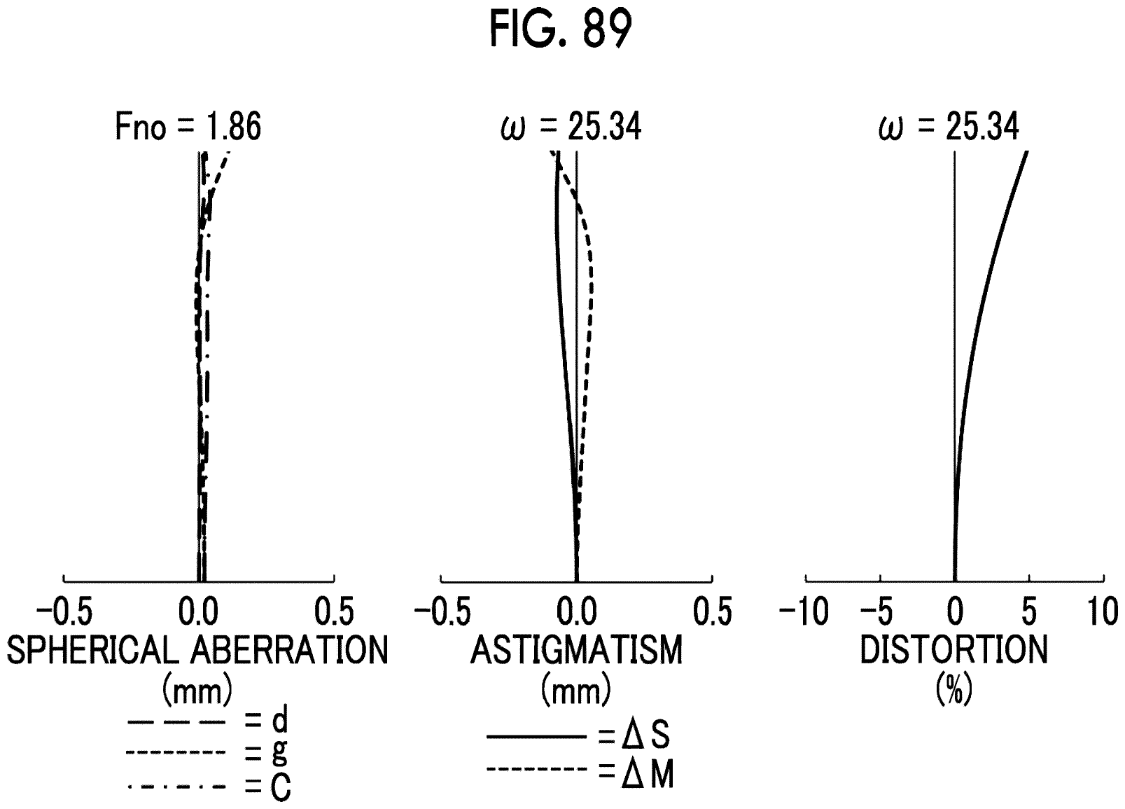

FIG. 90 is a lateral aberration diagram at the telephoto end and during focusing on infinity in Example 7.

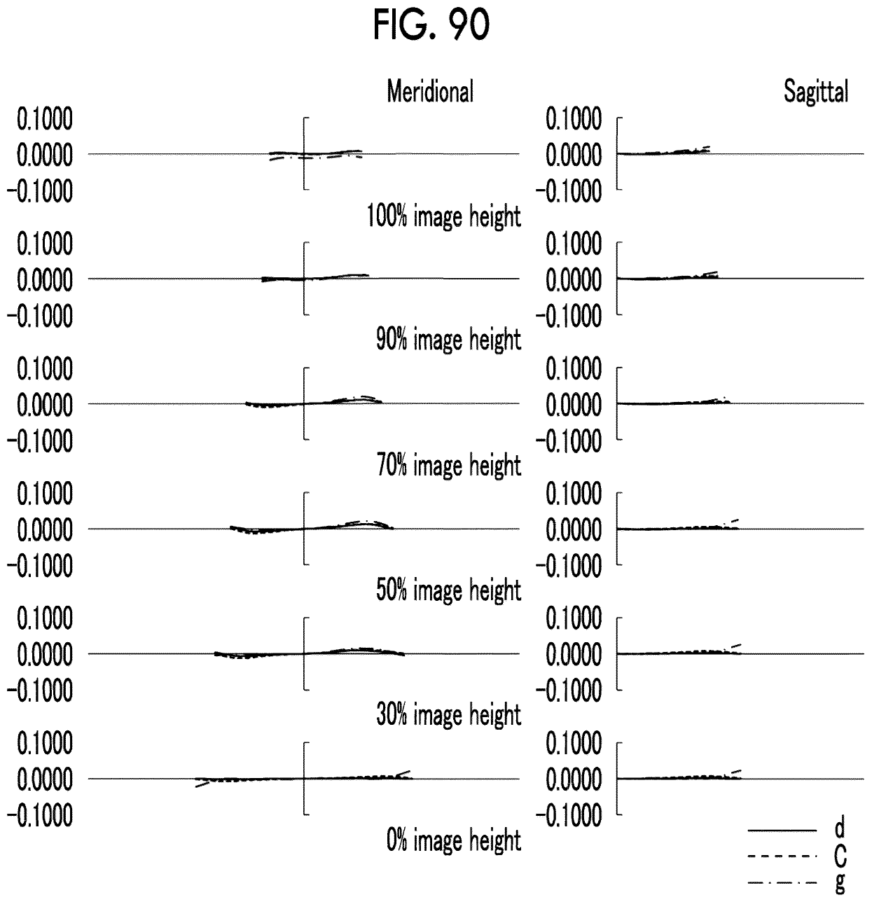

FIG. 91 is a lateral aberration diagram at the telephoto end and a focusing distance of 1858 mm in Example 7.

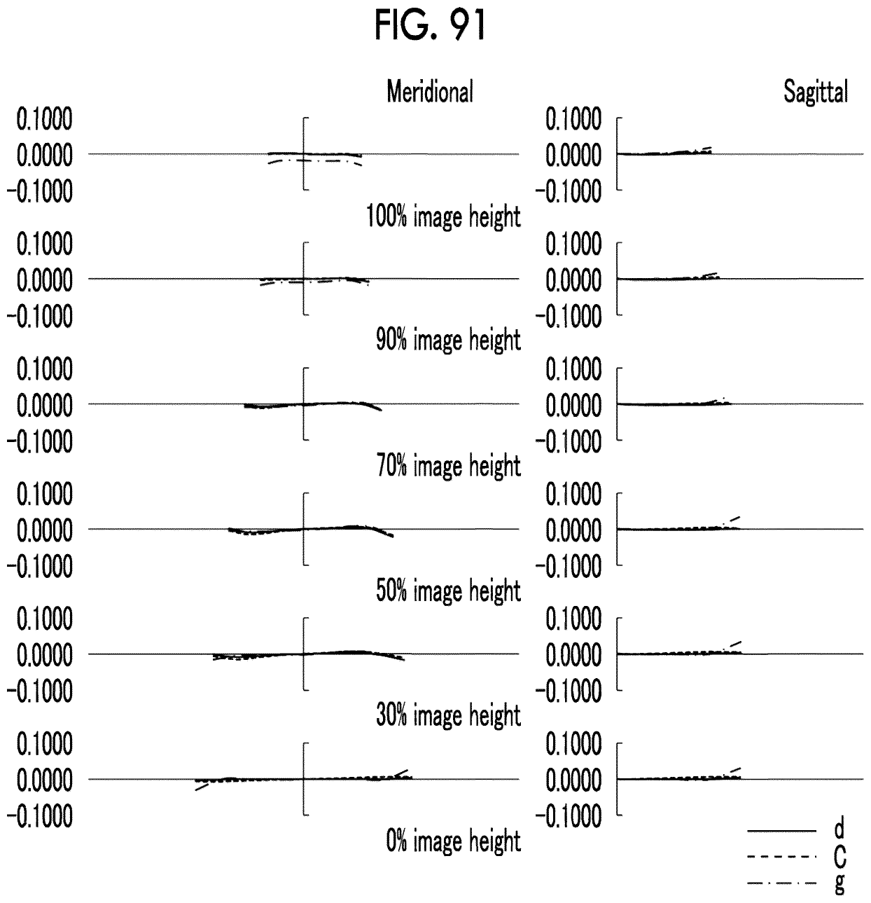

FIG. 92 is a lens configuration diagram at a wide-angle end and during focusing on infinity in Example 8.

FIG. 93 is a longitudinal aberration diagram at the wide-angle end and during focusing on infinity in Example 8.

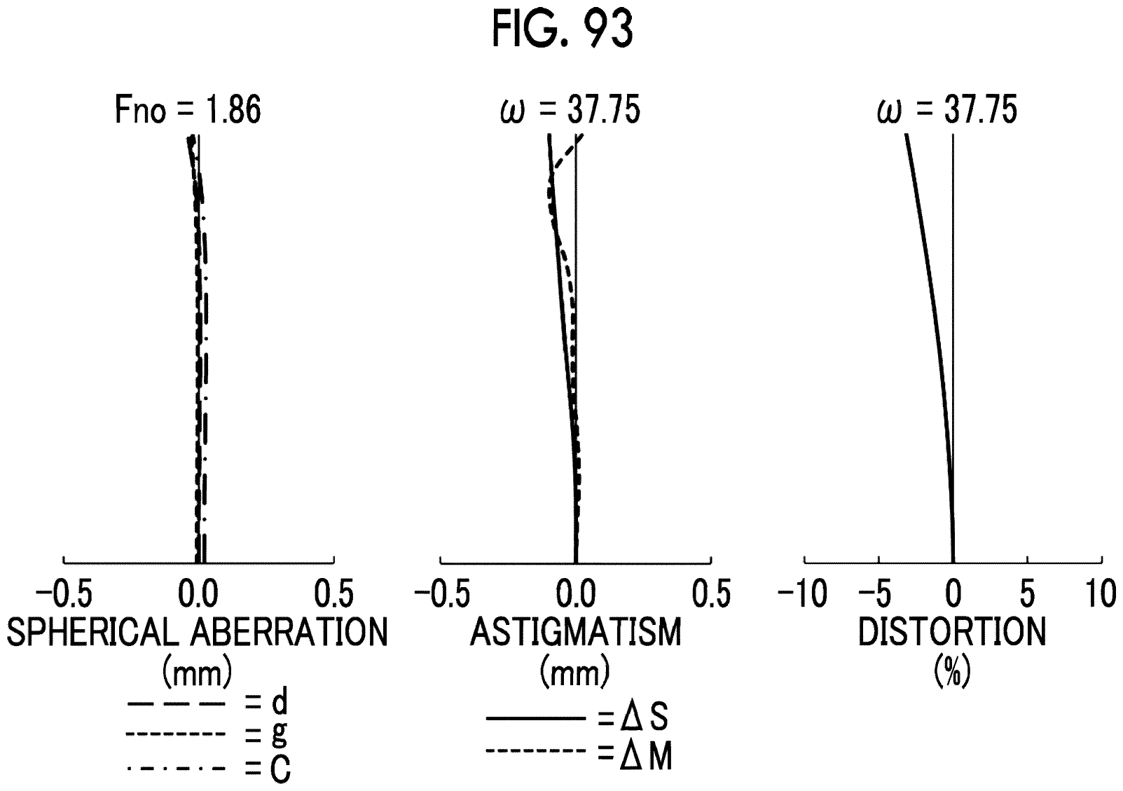

FIG. 94 is a longitudinal aberration diagram at the wide-angle end and a focusing distance of 1274 mm in Example 8.

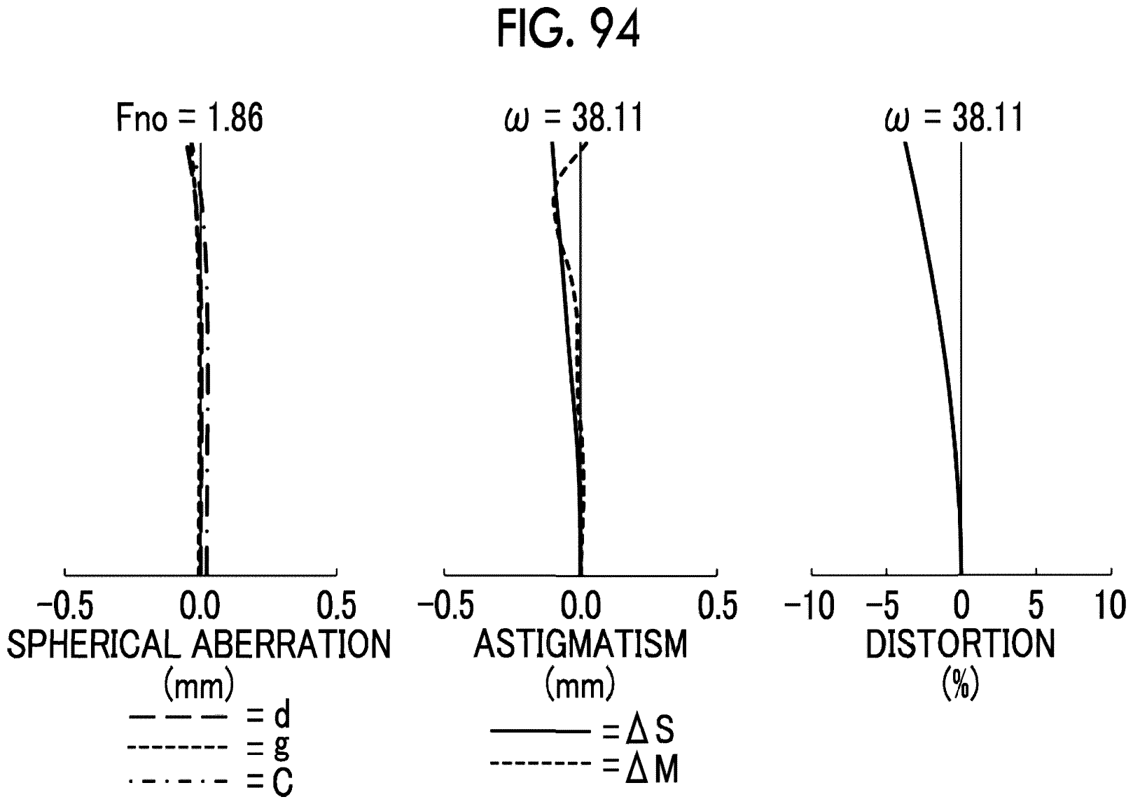

FIG. 95 is a lateral aberration diagram at the wide-angle end and during focusing on infinity in Example 8.

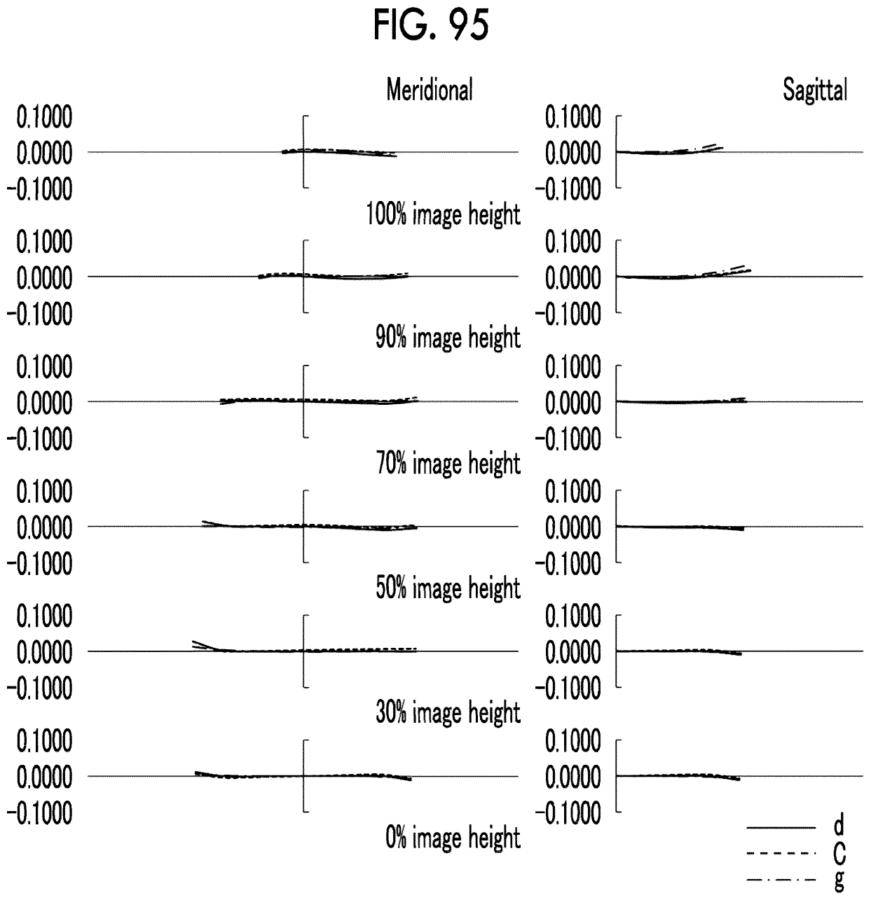

FIG. 96 is a lateral aberration diagram at the wide-angle end and a focusing distance of 1274 mm in Example 8.

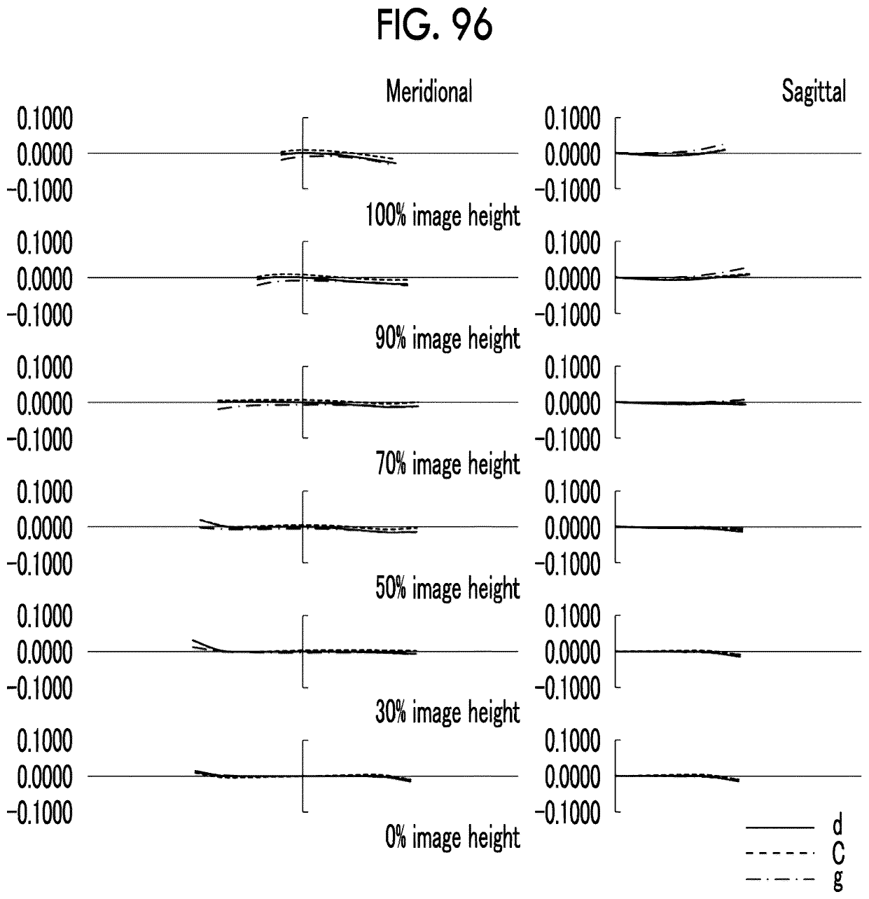

FIG. 97 is a longitudinal aberrations diagram at a middle focal length and during focusing on infinity in Example 8.

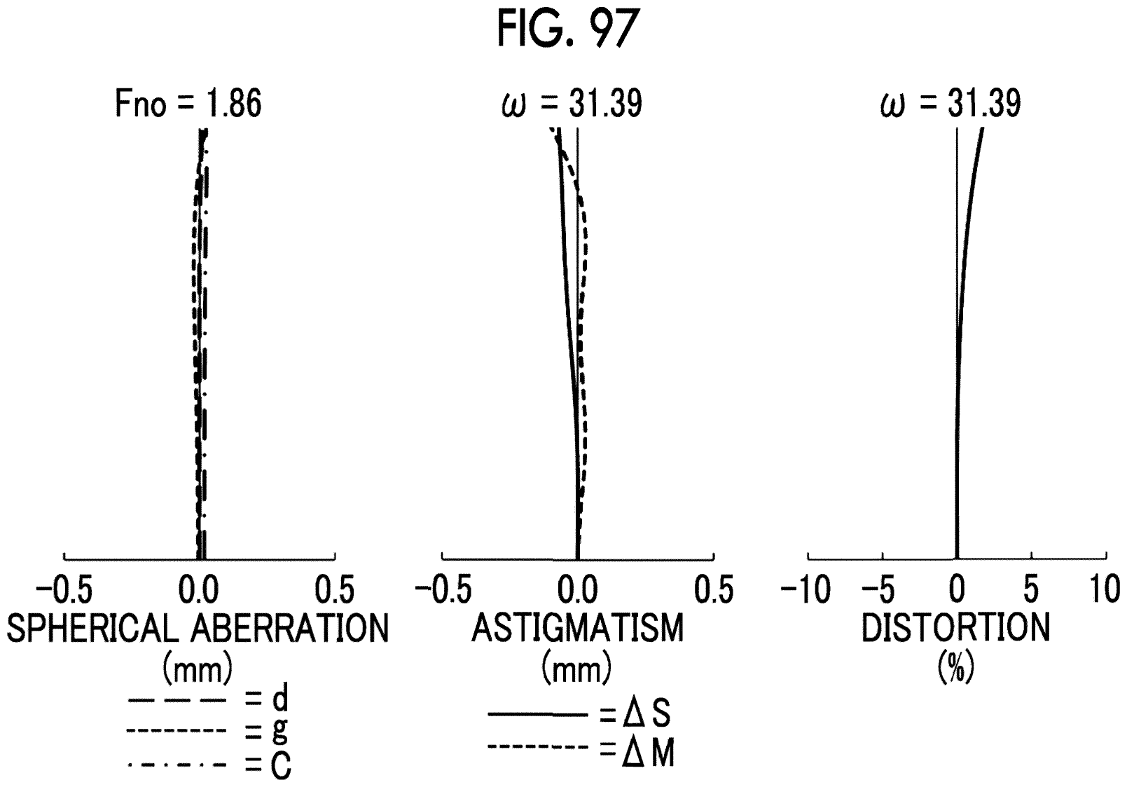

FIG. 98 is a longitudinal aberrations diagram at the middle focal length and a focusing distance of 1515 mm in Example 8.

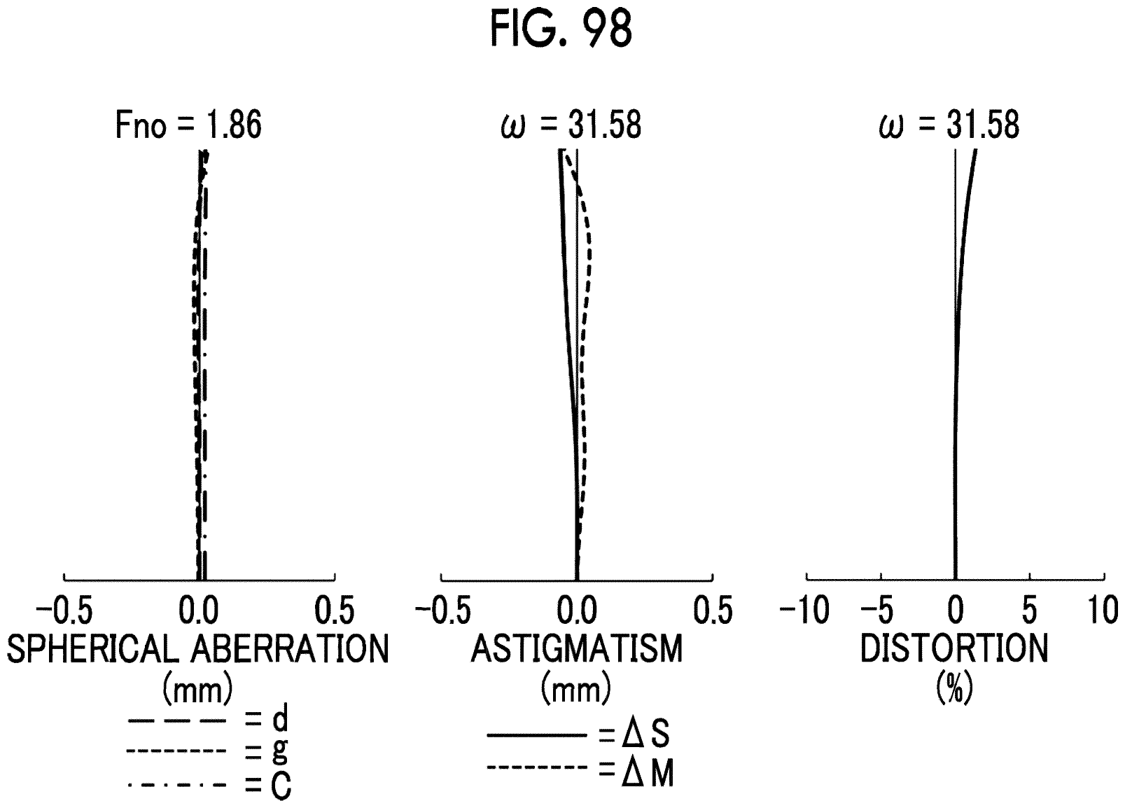

FIG. 99 is a lateral aberration diagram at the middle focal length and during focusing on infinity in Example 8.

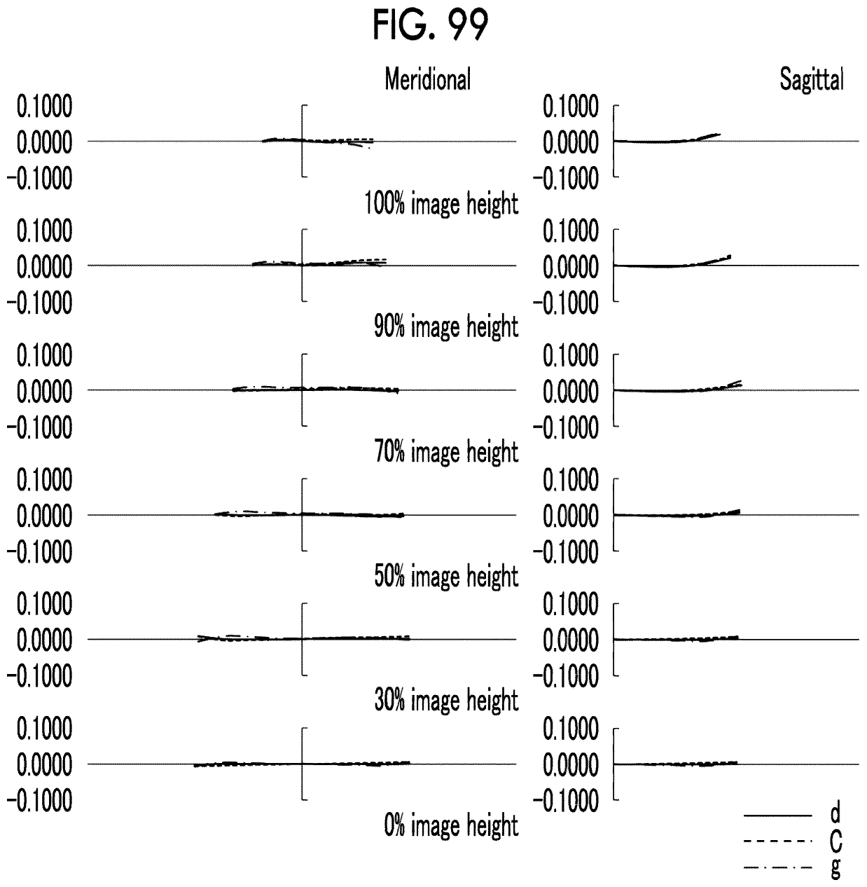

FIG. 100 is a lateral aberration diagram at the middle focal length and a focusing distance of 1515 mm in Example 8.

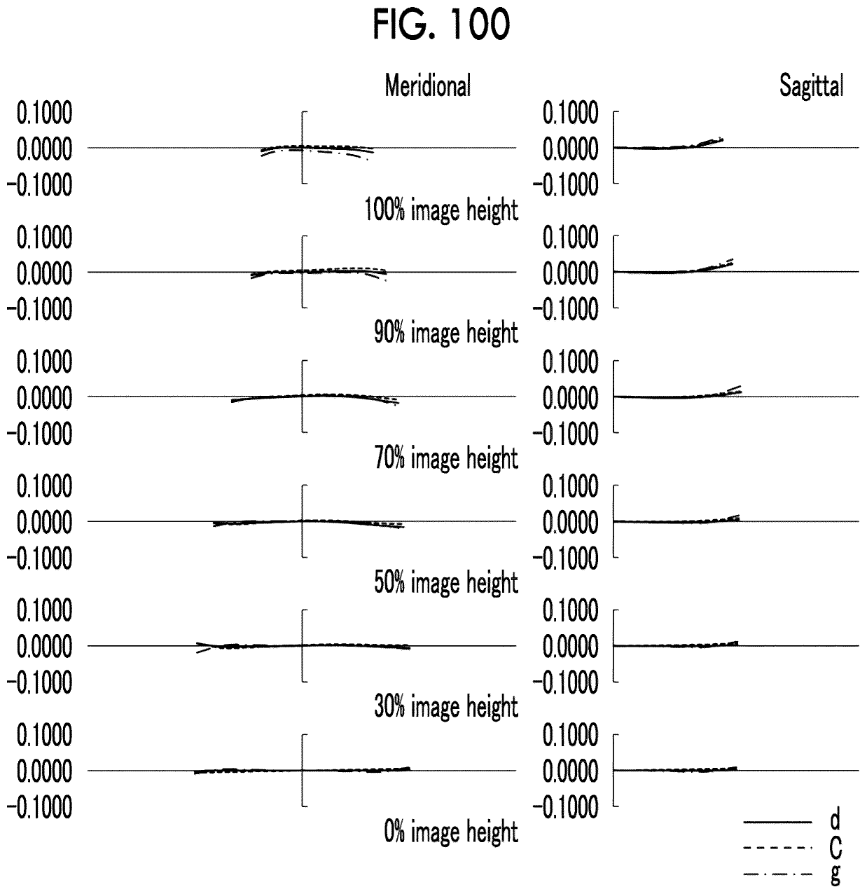

FIG. 101 is a longitudinal aberration diagram at a telephoto end and during focusing on infinity in Example 8.

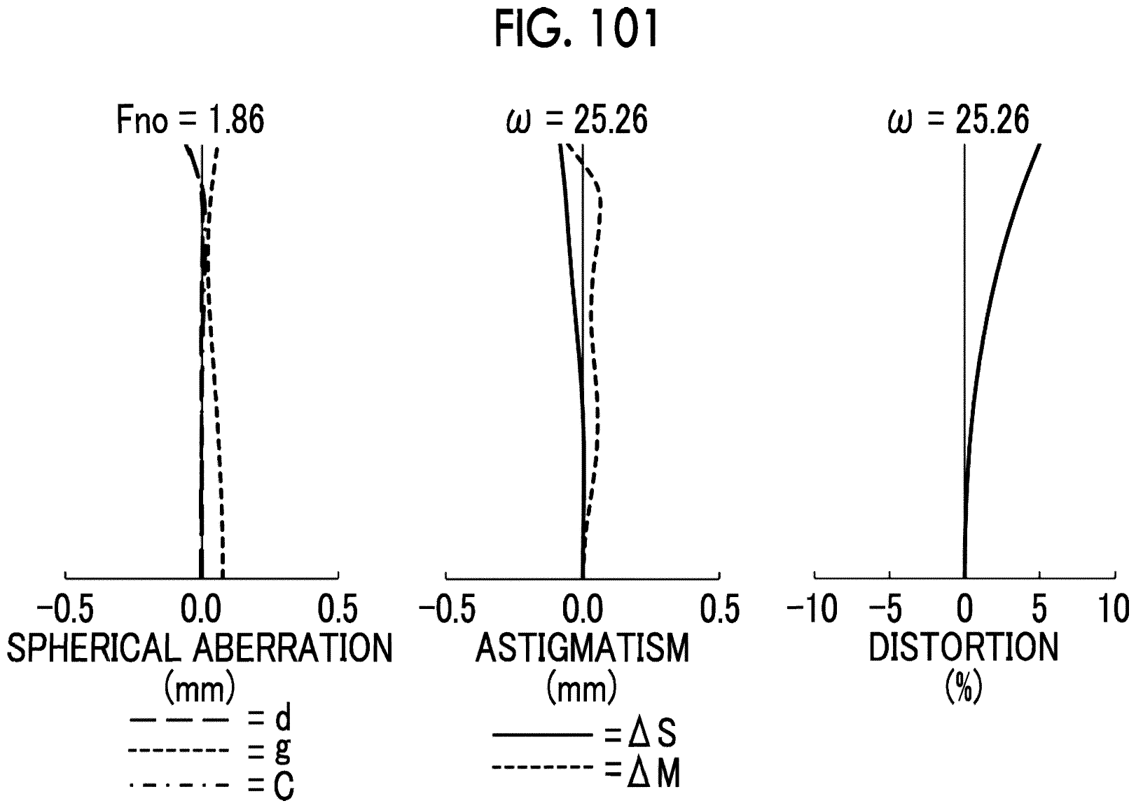

FIG. 102 is a longitudinal aberration diagram at the telephoto end and a focusing distance of 1868 mm in Example 8.

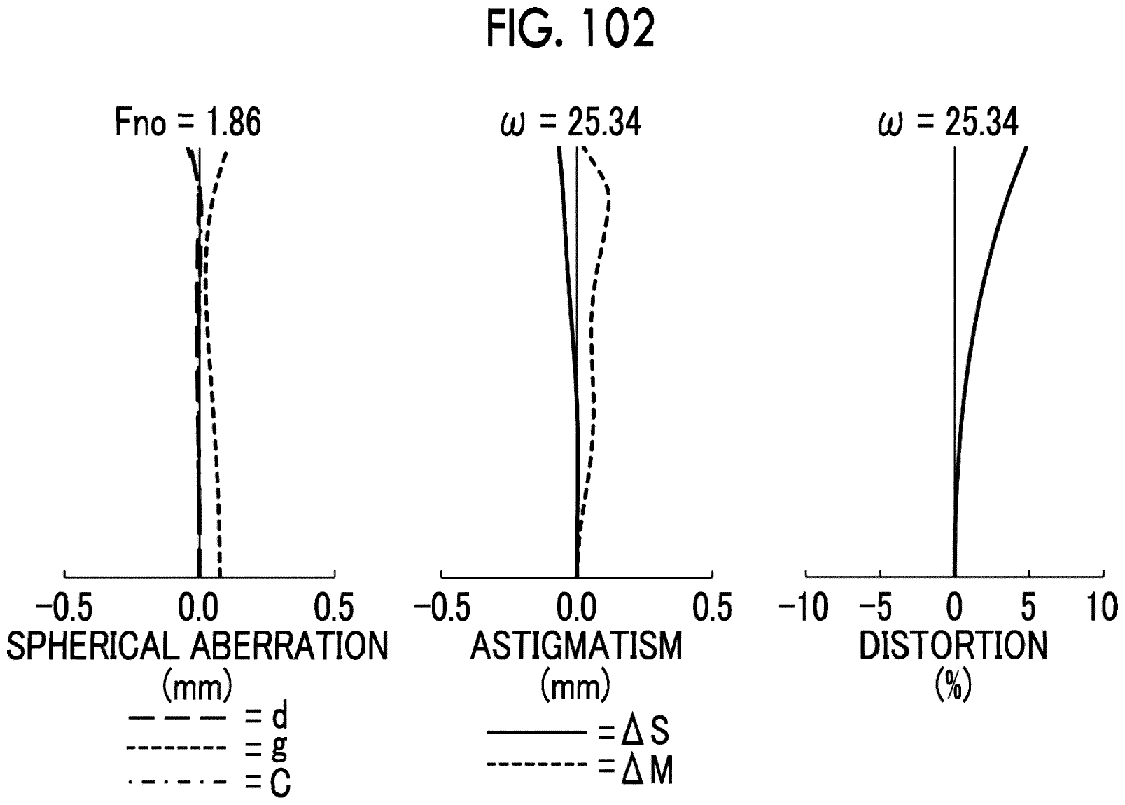

FIG. 103 is a lateral aberration diagram at the telephoto end and during focusing on infinity in Example 8.

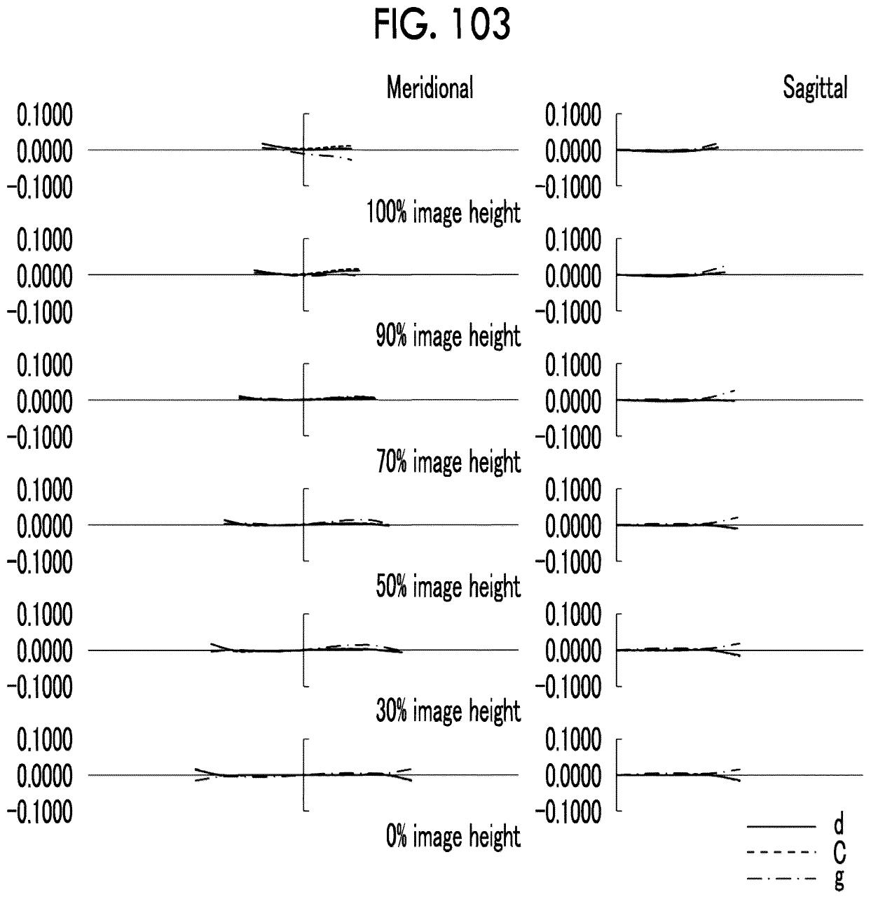

FIG. 104 is a lateral aberration diagram at the telephoto end and a focusing distance of 1868 mm in Example 8.

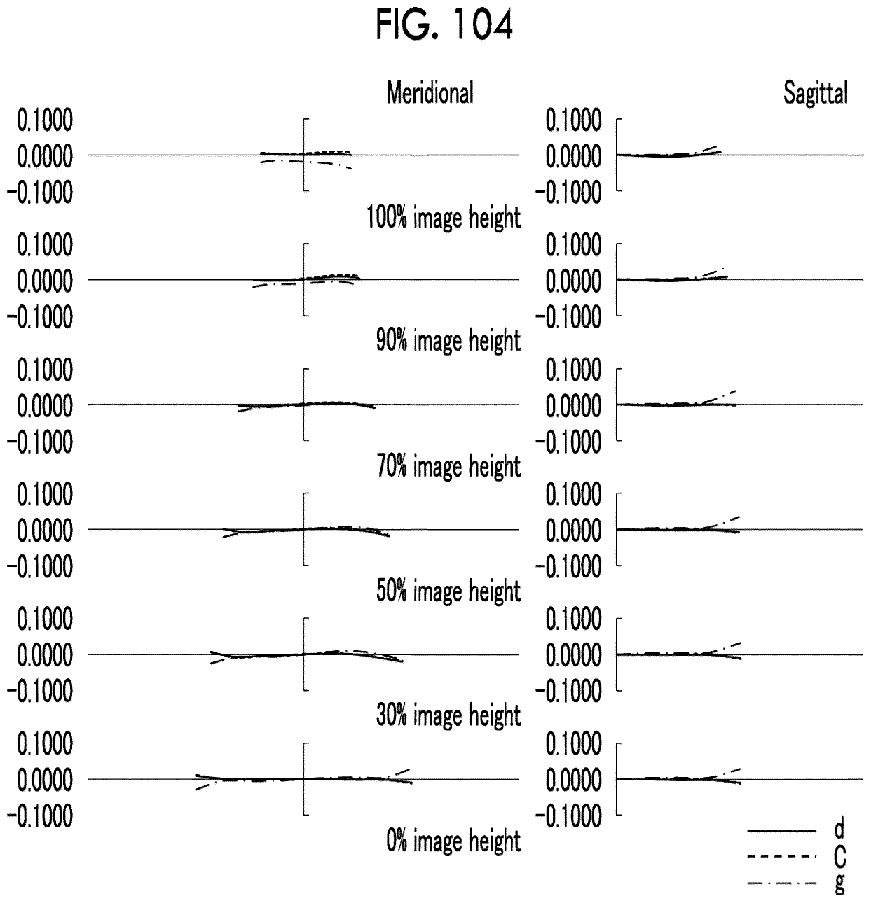

### EMBODIMENT FOR CARRYING OUT THE INVENTION

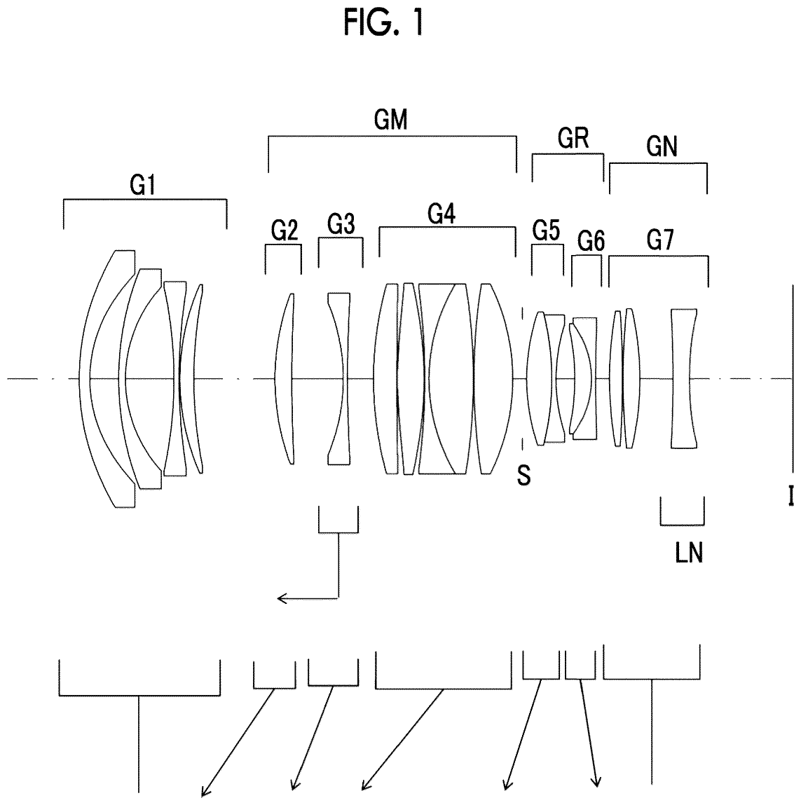

As can be seen from lens configuration diagrams shown in FIGS. 1, 14, 27, 40, 53, 66, 79, and 92, a zoom lens according to the present invention includes, in order from an object side: a first lens group G1 having a negative refractive power; a middle lens group GM having a positive refractive power as a whole; a rear lens group GR; and a final lens group GN, in which the middle lens group GM includes three or more lens groups and includes a focus lens group that moves along an optical axis during focusing from infinity to a short distance, the rear lens group GR includes one or more lens groups, a distance between each of the groups changes during zooming from a wide-angle end to a telephoto end, the middle lens group GM moves toward the object side, and a distance between the middle lens group GM and the rear lens group GR is widened, and the first lens group G1 and the final lens group GN are fixed in any of zooming and focusing.

A negative-dominant zoom lens in which a lens group having a negative refractive power is disposed closest to the object side is known. In the present invention, the middle lens group GM having a positive refractive power is disposed on the image side of the first lens group G1 having a negative refractive power, and the middle lens group GM moves to the object side during zooming from the wide-angle end to the telephoto end to perform the main zooming action. The rear lens group GR is disposed on the image side of the middle lens group GM such that the distance between the rear lens group GR and the middle lens group GM is increased during zooming from the wide-angle end to the telephoto end. The rear lens group GR assists in correcting aberrations during zooming, which is advantageous for achieving high performance.

In a case where the aperture ratio is further increased with the above-described configuration, the lens diameter is increased as a whole. In a case where the first lens group G1 is increased in size, the weight is increased, and in a case where the first lens group G1 is moved by zooming or focusing, the center of gravity is moved greatly, and the operability is deteriorated. Therefore, it is desirable that the first lens group G1 remains stationary in both the zooming and the focusing. This contributes to improvement of operability. In addition, there is also an advantage that the leading end portion of the optical system is not extended and the sturdiness can be enhanced.

In addition, it is desirable that the final lens group GN closest to the image side is fixed in both the zooming and the focusing. In a case where the lens diameter is increased due to the adaptation to a large aperture ratio or a large format camera, it is difficult to secure a space for disposing a substrate around a mount. By fixing the final lens group GN, the configuration around the mount is simplified, and the substrate is easily disposed.

In addition, the middle lens group GM is a group that is mainly responsible for the zooming action, and a large number of lenses are required for aberration correction. However, by dividing the middle lens group GM into a plurality of groups, it is possible to form a lightweight lens group having a small number of lenses. In particular, in a case where the middle lens group GM includes three or more lens groups, there is an advantage in correcting aberration during zooming, and it is easy to increase the aperture ratio. Furthermore, in a case where a part of a lightweight lens group formed by dividing the middle lens group GM into a plurality of groups is used as the focus lens group, it is also advantageous for realizing fast and quiet auto focus.

Furthermore, it is desirable that the zoom lens of the embodiment of the present invention satisfies Conditional Expression (1).

$$- 1.5 < f 1 / ft < - 0.7 \qquad ( 1 )$$

Here,
f1 is a focal length of the first lens group G1, and
ft is a focal length of the entire system in the telephoto end and the infinity focusing state.

Conditional Expression (1) stipulates a preferable condition for the refractive power of the first lens group G1. By satisfying Conditional Expression (1), it is possible to increase the aperture ratio of the optical system while suppressing the total lens length and various aberrations.

In a case where the negative refractive power of the first lens group G1 exceeds the upper limit of Conditional Expression (1), the effect of divergence of the on-axis light flux by the first lens group G1 is increased, and particularly, the diameter of the middle lens group GM is increased at the telephoto end, which causes the product outer diameter to be enlarged. In addition, since the diameter of the focus lens group is also increased, the weight of the focus lens group is increased, which is not preferable because it is disadvantageous for realizing high-speed auto focus. On the other hand, in a case where the result of Conditional Expression (1) is below the lower limit and the negative refractive power of the first lens group G1 is weakened, it is difficult to ensure the back focus.

In addition, it is preferable to set the lower limit value of Conditional Expression (1) to −1.30 and the upper limit value thereof to −0.75, since the above-described effect can be more reliably achieved.

Furthermore, in the zoom lens according to the embodiment of the present invention, it is desirable that the first lens group G1 includes two or more negative lenses. In a case where the first lens group G1 has one negative lens, the off-axis rays need to be strongly bent by one negative lens. Therefore, aberrations generated on each surface increase, and it is difficult to correct field curvature and distortion. By disposing two or more negative lenses in the first lens group G1, there is an advantage in correcting various aberrations.

Furthermore, it is desirable that the zoom lens of the embodiment of the present invention satisfies Conditional Expression (2) shown below.

$$vdG1\_ 2 > 57. \qquad ( 2 )$$

Here,
vdG1_2 is the second largest Abbe number among negative lenses arranged in first lens group G1.

In a case where there are two or more negative lenses having the largest Abbe number in the first lens group G1, the largest Abbe number is denoted by vdG1_2.

Conditional Expression (2) stipulates a preferable condition for the Abbe number of the negative lens disposed in the first lens group G1, and is effective in suppressing the lateral chromatic aberration. In a case where a lens having the second largest Abbe number among the negative lenses disposed in the first lens group G1 satisfies Conditional Expression (2), two or more negative lenses satisfying Conditional Expression (2) are present in the first lens group G1.

In a case where the Abbe number of the negative lens of the first lens group G1 is reduced below the lower limit of Conditional Expression (2), it is difficult to correct the lateral chromatic aberration. In a case where there is one or less negative lenses satisfying Conditional Expression (2), the ability to correct the lateral chromatic aberration is insufficient. Therefore, it is desirable to have two or more negative lenses satisfying Conditional Expression (2).

In addition, it is preferable to set the lower limit value of Conditional Expression (2) to 60.0 in order to more reliably achieve the above-described effect.

Furthermore, in the zoom lens of the embodiment of the present invention, it is desirable that the final lens LN closest to the image side in the final lens group GN has a negative refractive power. Since the first lens group G1 is a negative zoom lens having a negative refractive power, the symmetry of the refractive power is strengthened by setting the final lens LN to have a negative refractive power, and there is an advantage in correcting distortion.

Furthermore, it is desirable that the zoom lens of the embodiment of the present invention satisfies Conditional Expression (3) shown below.

$$0. < ( RLN 1 + RLN 2 ) / ( RLN 1 - RLN 2 ) < 1. \qquad ( 3 )$$

Here,
RLN1 is a curvature radius of the object side surface of the final lens LN, and
RLN2 is a curvature radius of the image side surface of the final lens LN.

Conditional Expression (3) stipulates a preferable condition for the shape of the final lens LN. By satisfying Conditional Expression (3), there is an advantage in correcting field curvature and distortion.

In a case where the final lens LN has a meniscus shape by exceeding the upper limit of Conditional Expression (3), the ability to correct field curvature is insufficient. On the other hand, in a case where the curvature of the object side surface of the final lens LN becomes steeper than the curvature of the image side surface by setting below the lower limit of Conditional Expression (3), the ability to correct distortion becomes insufficient.

In addition, it is preferable to set the lower limit value of Conditional Expression (3) to 0.1 and the upper limit value thereof to 0.9, since the above-described effect can be more reliably achieved.

Furthermore, in the zoom lens according to the embodiment of the present invention, it is desirable that the middle lens group GM includes the second lens group G2 having a positive refractive power and the third lens group G3 having a negative refractive power in order from the object side, and at least one of the second lens group G2 or the third lens group G3 is moved along the optical axis in a case of focusing from the infinity to the short distance. It is effective to reduce the diameter in order to make the focus lens group as light as possible. In addition, since the first lens group G1 causes the on-axis light flux to diverge with a negative refractive power, the on-axis light flux become thicker and the lens diameter becomes larger in a case where the distance from the first lens group G1 to the focus lens group is increased. Therefore, it is preferable to use the second lens group G2 or the third lens group G3 as the focus lens group as close to the first lens group G1 as possible for weight reduction.

Furthermore, in the zoom lens of the embodiment of the present invention, it is desirable to have the fourth lens group G4 having a positive refractive power on the image side of the second lens group G2 having a positive refractive power and the third lens group G3 having a negative refractive power. By converging the luminous fluxes diverged by the third lens group G3 having a negative refractive power by the fourth lens group G4 on the image side, it is possible to prevent the outer diameter of the optical system from becoming large.

Furthermore, it is desirable that the zoom lens of the embodiment of the present invention satisfies Conditional Expression (4) shown below.

$$- 2. < f 2 / f 3 < - 1. \qquad ( 4 )$$

Here,
f2 is a focal length of the second lens group G2, and
f3 is a focal length of the third lens group G3.

Conditional Expression (4) stipulates preferable conditions for the refractive powers of the second lens group G2 and the third lens group G3. The condition expression (4) is effective for ensuring the distance between the lens groups and suppressing the product outer diameter.

In a case where the positive refractive power of the second lens group G2 is increased or the negative refractive power of the third lens group G3 is reduced by exceeding the upper limit of Conditional Expression (4), the object side principal point of a combined system of the second lens group G2 and the third lens group G3 moves to the image side, and it is difficult to secure the distance between the first lens group G1 and the second lens group G2 at the telephoto end. On the other hand, in a case where the negative refractive power of the third lens group G3 is increased resulting the ratio below the lower limit of Conditional Expression (4), the eccentricity sensitivity of the third lens group G3 is deteriorated, and the influence on the optical performance in a case where the amount of eccentricity of the third lens group G3 is changed due to the shake during focusing or the difference in the posture of the lens barrel is increased. Further, in a case where the positive refractive power of the second lens group G2 is weak, the combined system with the third lens group G3 has a strong negative refractive power, and the effect of the uplift of the on-axis light flux is strengthened. Therefore, the lens diameter of the lens group on the image side of the third lens group G3 increases, and the product outer diameter is enlarged.

In addition, it is preferable to set the lower limit value of Conditional Expression (4) to −1.9 and the upper limit value thereof to −1.1, since the above-described effect can be more reliably achieved.

Further, in order to reduce the weight of the focus lens group, it is desirable that the second lens group G2 and the third lens group G3 each includes two or fewer lenses. By suppressing the number of lenses to two or less, the length of the lens group in the optical axis direction is suppressed, which is advantageous for suppressing the total length of the product.

Furthermore, it is desirable that the zoom lens of the embodiment of the present invention satisfies Conditional Expression (5) shown below.

$$0.7 < ( β Mt / β Mw ) / ( ft / fw ) < 1.2 \qquad ( 5 )$$

Here,
BMw is an imaging magnification of the middle lens group GM in the wide-angle end and the infinity focusing state,
BMt is an imaging magnification of the middle lens group GM in the telephoto end and the infinity focusing state,
fw is a focal length of the entire system in the wide-angle end and the infinity focusing state, and
ft is a focal length of the entire system in the telephoto end and the infinity focusing state.

Conditional Expression (5) stipulates a preferable condition regarding the ratio at which the middle lens group GM contributes to the zooming from the wide-angle end to the telephoto end. By satisfying Conditional Expression (5), it is possible to suppress fluctuation in aberrations during zooming while suppressing the total length of the optical system.

In a case where the magnification burden of the middle lens group GM is increased by exceeding the upper limit of Conditional Expression (5), it is necessary to enhance the refractive power of the middle lens group GM or to increase the movement amount thereof. In a case where the refractive power of the middle lens group GM increases, the amount of occurrence of aberration increases. Therefore, it is necessary to increase the number of lenses in order to achieve high performance. In a case where the middle lens group GM that has become heavy due to an increase in the number of lenses is moved greatly, the movement of the center of gravity during zooming becomes large, which is not preferable. Further, the sensitivity to manufacturing errors also deteriorates due to the excessive enhancement in the refractive power of the middle lens group GM. On the other hand, in a case where the variable magnification burden of the middle lens group GM is reduced below the lower limit of Conditional Expression (5), the ratio at which the rear lens group GR assists in zooming must be increased, and it is necessary to enhance the refractive power of the rear lens group GR or to increase the movement amount thereof. It is necessary to increase the number of lenses in order to achieve high performance in a state where the refractive power of the rear lens group GR is enhanced. An increase in the number of lenses or an increase in the amount of movement of the rear lens group GR affects the total length of the optical system, and it is difficult to achieve reduction in the total length.

In addition, it is preferable to set the lower limit value of Conditional Expression (5) to 0.8 and the upper limit value thereof to 1.1, since the above-described effect can be more reliably achieved.

Furthermore, in the zoom lens according to the embodiment of the present invention, it is desirable that the middle lens group GM includes six or more lenses. Since the middle lens group GM has a strong refractive power because of the main zooming action, it is advantageous to dispose six or more lenses to suppress fluctuation in aberrations while increasing the aperture ratio. In a case where the number of lenses included in the middle lens group GM is less than six, it is difficult to correct spherical aberration.

In the zoom lens according to the embodiment of the present invention, a boundary between the middle lens group GM and the rear lens group GR is a location where the lateral magnification of the rear lens group GR is maximized. Accordingly, the middle lens group GM having a relatively strong positive refractive power moves to the object side during zooming to play a main zooming action, and the distance between the middle lens group GM and the rear lens group GR is widened during zooming from the wide-angle end to the telephoto end, so that the rear lens group GR plays a role of assisting aberration correction during zooming, and the role sharing is clarified, and it is easy to perform aberration correction.

Furthermore, in the zoom lens of the embodiment of the present invention, it is desirable that the aperture diaphragm S is disposed in the rear lens group GR. In the configuration of the present invention, since the on-axis ray is deflected by the first lens group G1 having a negative refractive power, the axial marginal ray height is high in the middle lens group GM. In a case where the diaphragm is disposed here, the diaphragm diameter is increased, and the product outer diameter is increased and heavy. On the other hand, in a case where the diaphragm is disposed in the final lens group GN, the position of the diaphragm is too close to the image surface. Therefore, vignetting occurs in a case where the effective diameter of the first lens group is not increased. Therefore, in a case where a diaphragm is disposed in the rear lens group GR, the axial marginal rays are converged by the middle lens group GM having a positive refractive power. Thus, it is possible to prevent the stop from being increased in size while suppressing an increase in the effective diameter of the first lens group.

Next, lens configurations of examples according to the zoom lens of the present invention will be described. In the following description, the lens configuration will be described in order from the object side to the image side. In addition, in the lens configuration diagram at each example, I is an image sensor, and the one-dot chain line passing through the center is the optical axis.

### Example 1

FIG. 1 is a lens configuration diagram at a zoom lens in Example 1 of the present invention. The zoom lens in Example 1 includes a first lens group G1 having a negative refractive power, a second lens group G2 having a positive refractive power, a third lens group G3 having a negative refractive power, a fourth lens group G4 having a positive refractive power, a fifth lens group G5 having a negative refractive power, a sixth lens group G6 having a negative refractive power, and a seventh lens group G7 having a positive refractive power. During zooming from the wide-angle end to the telephoto end, the distances between the groups change, all the groups from the second lens group G2 to the fifth lens group G5 move toward the object side, and the sixth lens group G6 moves toward the image surface side. The aperture diaphragm S is provided on the object side of the fifth lens group G5 and moves integrally with the fifth lens group G5 during zooming. During focusing from the infinite distance object to the close distance object, the third lens group G3 moves toward the object side along the optical axis. The first lens group G1 and the seventh lens group G7 are fixed in both the zooming and the focusing. In the present example, the middle lens group GM includes the second lens group G2, the third lens group G3, and the fourth lens group G4; the rear lens group GR includes the fifth lens group G5 and the sixth lens group G6; and the final lens group GN corresponds to the seventh lens group G7.

The first lens group G1 includes a negative meniscus lens with both surfaces having a predetermined aspherical shape and a convex surface facing the object side, a negative meniscus lens with a convex surface facing the object side, a biconcave lens, and a positive meniscus lens with a convex surface facing the object side.

The second lens group G2 includes a positive meniscus lens with a convex surface facing the object side.

The third lens group G3 includes a biconcave lens.

The fourth lens group G4 includes a positive meniscus lens with a convex surface facing the object side, a biconvex lens with both surfaces having a predetermined aspherical shape, a cemented lens composed of a biconcave lens and a biconvex lens, and a biconvex lens.

The fifth lens group G5 includes an aperture diaphragm S, and a cemented lens composed of a biconvex lens and a biconcave lens.

The sixth lens group G6 includes a cemented lens composed of a positive meniscus lens with a concave surface facing the object side and a biconcave lens.

The seventh lens group G7 includes a biconvex lens, a biconvex lens, and a biconcave lens with both surfaces having a predetermined aspherical shape. The final lens LN corresponds to a biconcave lens disposed closest to the image side in the seventh lens group G7.

### Example 2

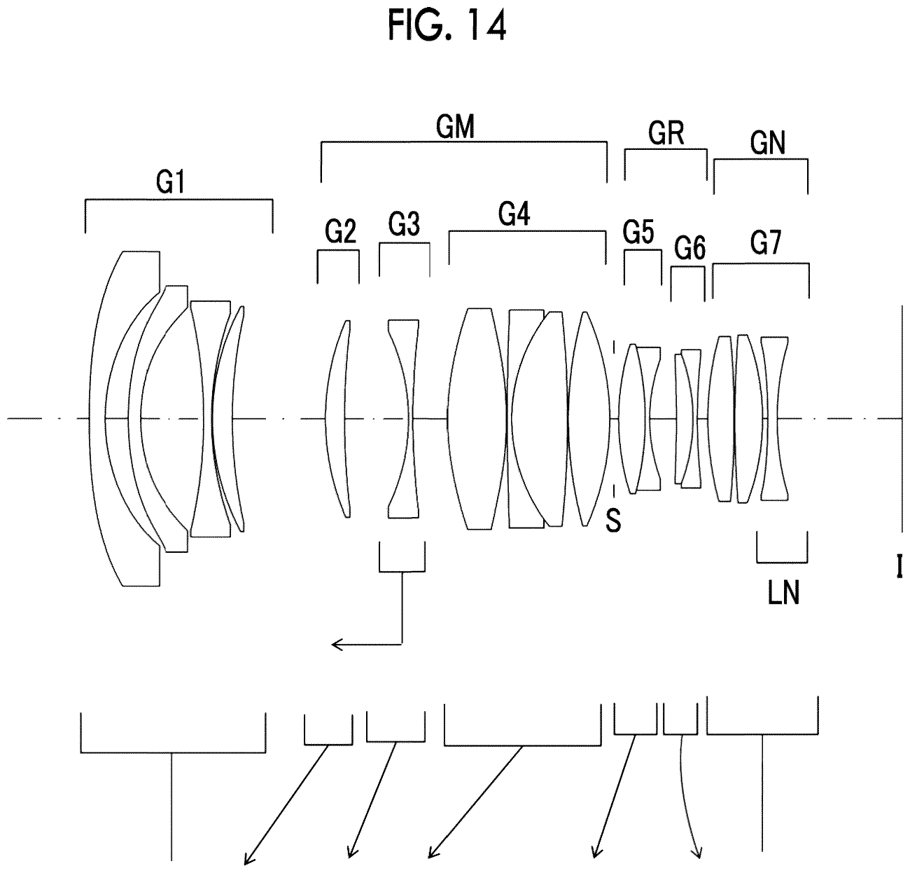

FIG. 14 is a lens configuration diagram at a zoom lens in Example 2 of the present invention. The zoom lens in Example 2 includes a first lens group G1 having a negative refractive power, a second lens group G2 having a positive refractive power, a third lens group G3 having a negative refractive power, a fourth lens group G4 having a positive refractive power, a fifth lens group G5 having a negative refractive power, a sixth lens group G6 having a negative refractive power, and a seventh lens group G7 having a positive refractive power. During zooming from the wide-angle end to the telephoto end, the distances between the groups change, all of the groups from the second lens group G2 to the fifth lens group G5 move toward the object side, and the sixth lens group G6 moves toward the object side from the wide-angle end to the middle focal length and moves toward the image surface side from the middle focal length to the telephoto end. The aperture diaphragm S is provided on the object side of the fifth lens group G5 and moves integrally with the fifth lens group G5 during zooming. During focusing from the infinite distance object to the close distance object, the third lens group G3 moves toward the object side along the optical axis. The first lens group G1 and the seventh lens group G7 are fixed in both the zooming and the focusing. In the present example, the middle lens group GM includes the second lens group G2, the third lens group G3, and the fourth lens group G4; the rear lens group GR includes the fifth lens group G5 and the sixth lens group G6; and the final lens group GN corresponds to the seventh lens group G7.

The first lens group G1 includes a negative meniscus lens with both surfaces having a predetermined aspherical shape and a convex surface facing the object side, a negative meniscus lens with both surfaces having a predetermined aspherical shape and a convex surface facing the object side, a biconcave lens, and a positive meniscus lens with a convex surface facing the object side.

The second lens group G2 includes a positive meniscus lens with a convex surface facing the object side.

The third lens group G3 includes a biconcave lens.

The fourth lens group G4 includes a biconvex lens with both surfaces having a predetermined aspherical shape, a cemented lens including a negative meniscus lens with a convex surface facing the object side and a biconvex lens, and a biconvex lens.

The fifth lens group G5 includes an aperture diaphragm S, and a cemented lens composed of a biconvex lens and a biconcave lens.

The sixth lens group G6 includes a cemented lens composed of a positive meniscus lens with a concave surface facing the object side and a biconcave lens.

The seventh lens group G7 includes a biconvex lens, a biconvex lens, and a biconcave lens with both surfaces having a predetermined aspherical shape. The final lens LN corresponds to a biconcave lens disposed closest to the image side in the seventh lens group G7.

### Example 3

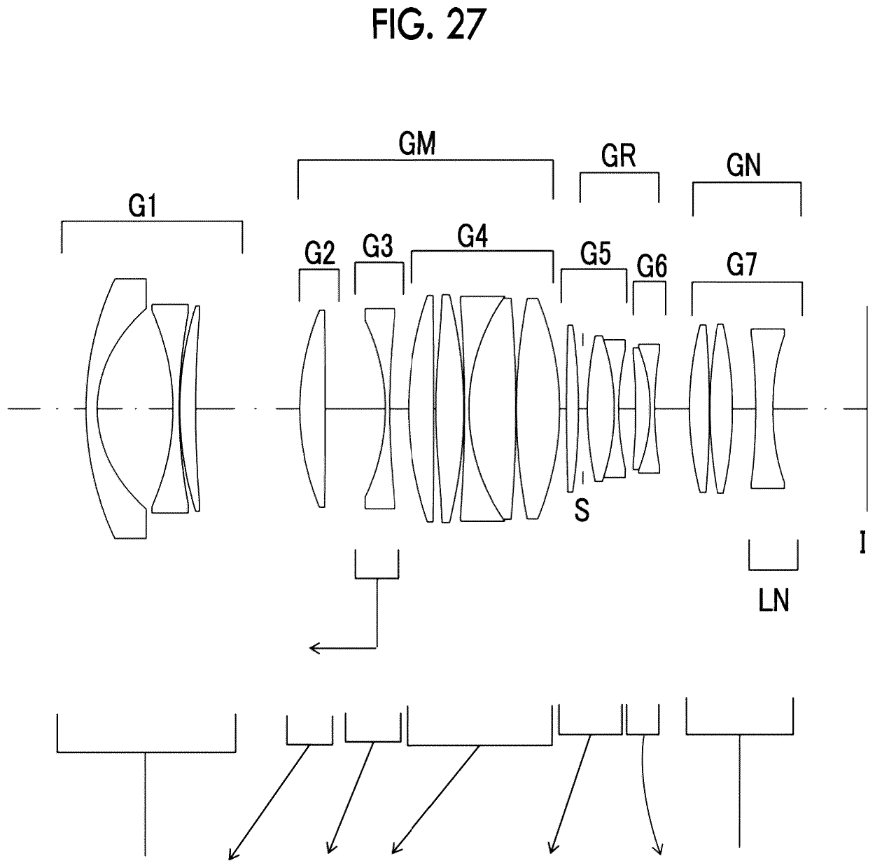

FIG. 27 is a lens configuration diagram at a zoom lens in Example 3 of the invention. The zoom lens in Example 3 includes the first lens group G1 having a negative refractive power, the second lens group G2 having a positive refractive power, the third lens group G3 having a negative refractive power, the fourth lens group G4 having a positive refractive power, the fifth lens group G5 having a negative refractive power, the sixth lens group G6 having a negative refractive power, and the seventh lens group G7 having a positive refractive power. During zooming from the wide-angle end to the telephoto end, the distances between the groups change, all of the groups from the second lens group G2 to the fifth lens group G5 move toward the object side, and the sixth lens group G6 moves toward the object side from the wide-angle end to the middle focal length and moves toward the image surface side from the middle focal length to the telephoto end. The aperture diaphragm S is provided inside the fifth lens group G5 and moves integrally with the fifth lens group G5 during zooming. During focusing from the infinite distance object to the close distance object, the third lens group G3 moves toward the object side along the optical axis. The first lens group G1 and the seventh lens group G7 are fixed in both the zooming and the focusing. In the present example, the middle lens group GM includes the second lens group G2, the third lens group G3, and the fourth lens group G4; the rear lens group GR includes the fifth lens group G5 and the sixth lens group G6; and the final lens group GN corresponds to the seventh lens group G7.

The first lens group G1 includes a negative meniscus lens with both surfaces having a predetermined aspherical shape and a convex surface facing the object side, a biconcave lens, and a positive meniscus lens with a convex surface facing the object side.

The second lens group G2 includes a biconvex lens.

The third lens group G3 includes a biconcave lens.

The fourth lens group G4 includes a biconvex lens, a biconvex lens with both surfaces having a predetermined aspherical shape, a cemented lens including a biconcave lens and a biconvex lens, and a biconvex lens.

The fifth lens group G5 includes a biconvex lens, an aperture diaphragm S, and a cemented lens composed of a biconvex lens and a biconcave lens.

The sixth lens group G6 includes a cemented lens composed of a positive meniscus lens with a concave surface facing the object side and a biconcave lens.

The seventh lens group G7 includes a biconvex lens, a biconvex lens, and a biconcave lens with both surfaces having a predetermined aspherical shape. The final lens LN corresponds to a biconcave lens disposed closest to the image side in the seventh lens group G7.

### Example 4

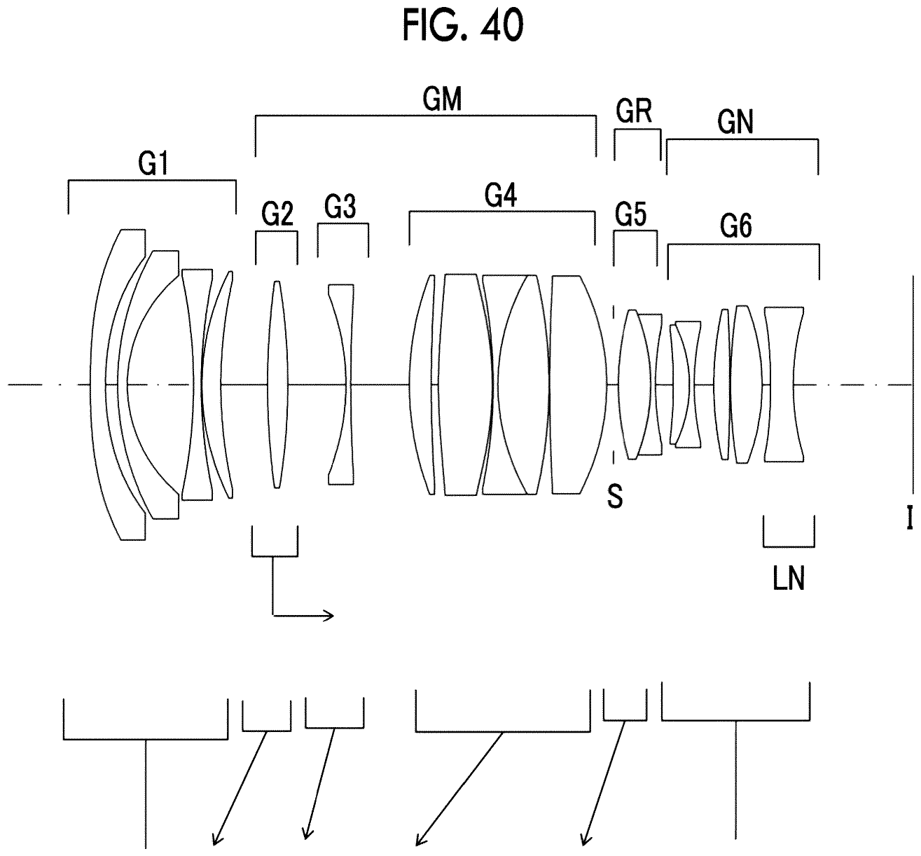

FIG. 40 is a lens configuration diagram at a zoom lens of Example 4 of the invention. The zoom lens of Example 4 includes the first lens group G1 having a negative refractive power, the second lens group G2 having a positive refractive power, the third lens group G3 having a negative refractive power, the fourth lens group G4 having a positive refractive power, the fifth lens group G5 having a negative refractive power, and the sixth lens group G6 having a positive refractive power. During zooming from the wide-angle end to the telephoto end, the distances between the groups change, and all the groups from the second lens group G2 to the fifth lens group G5 move toward the object side. The aperture diaphragm S is provided on the object side of the fifth lens group G5 and moves integrally with the fifth lens group G5 during zooming. During focusing from the infinite distance object to the close distance object, the second lens group G2 moves toward the image surface side along the optical axis. The first lens group G1 and the sixth lens group G6 are fixed in any of zooming and focusing. In the present example, the middle lens group GM includes the second lens group G2, the third lens group G3, and the fourth lens group G4; the rear lens group GR includes the fifth lens group G5; and the final lens group GN corresponds to the sixth lens group G6.

The first lens group G1 includes a negative meniscus lens with both surfaces having a predetermined aspherical shape and a convex surface facing the object side, a negative meniscus lens with a convex surface facing the object side, a biconcave lens, and a positive meniscus lens with a convex surface facing the object side.

The second lens group G2 includes a biconvex lens.

The third lens group G3 includes a biconcave lens.

The fourth lens group G4 includes a positive meniscus lens with a convex surface facing the object side, a biconvex lens with both surfaces having a predetermined aspherical shape, a cemented lens composed of a biconcave lens and a biconvex lens, and a biconvex lens.

The fifth lens group G5 includes an aperture diaphragm S, and a cemented lens composed of a biconvex lens and a biconcave lens.

The sixth lens group G6 includes a cemented lens composed of a positive meniscus lens with a concave surface facing the object side and a biconcave lens, a biconvex lens, and a biconcave lens with both surfaces having a predetermined aspherical shape. The final lens LN corresponds to a biconcave lens disposed closest to the image side in the sixth lens group G6.

### Example 5

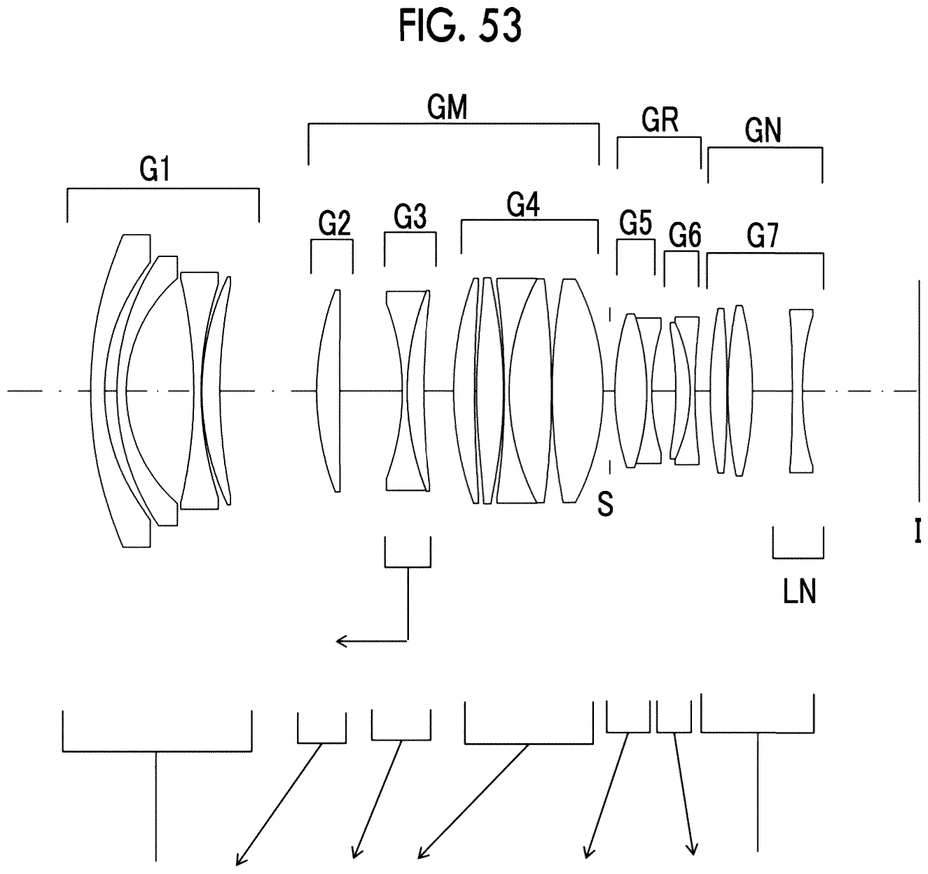

FIG. 53 is a lens configuration diagram at a zoom lens of Example 5 of the invention. The zoom lens of Example 5 includes the first lens group G1 having a negative refractive power, the second lens group G2 having a positive refractive power, the third lens group G3 having a negative refractive power, the fourth lens group G4 having a positive refractive power, the fifth lens group G5 having a negative refractive power, the sixth lens group G6 having a negative refractive power, and the seventh lens group G7 having a positive refractive power. During zooming from the wide-angle end to the telephoto end, the distances between the groups change, all the groups from the second lens group G2 to the fifth lens group G5 move toward the object side, and the sixth lens group G6 moves toward the image surface side. The aperture diaphragm S is provided on the object side of the fifth lens group G5 and moves integrally with the fifth lens group G5 during zooming. During focusing from the infinite distance object to the close distance object, the third lens group G3 moves toward the object side along the optical axis. The first lens group G1 and the seventh lens group G7 are fixed in both the zooming and the focusing. In the present example, the middle lens group GM includes the second lens group G2, the third lens group G3, and the fourth lens group G4; the rear lens group GR includes the fifth lens group G5 and the sixth lens group G6; and the final lens group GN corresponds to the seventh lens group G7.

The first lens group G1 includes a negative meniscus lens with both surfaces having a predetermined aspherical shape and a convex surface facing the object side, a negative meniscus lens with a convex surface facing the object side, a biconcave lens, and a positive meniscus lens with a convex surface facing the object side.

The second lens group G2 includes a positive meniscus lens with a convex surface facing the object side.

The third lens group G3 includes a cemented lens composed of a biconcave lens and a positive meniscus lens having a convex surface toward the object side.

The fourth lens group G4 includes a positive meniscus lens with a convex surface facing the object side, a biconvex lens with both surfaces having a predetermined aspherical shape, a cemented lens composed of a biconcave lens and a biconvex lens, and a biconvex lens.

The fifth lens group G5 includes an aperture diaphragm S, and a cemented lens composed of a biconvex lens and a biconcave lens.

The sixth lens group G6 includes a cemented lens composed of a positive meniscus lens with a concave surface facing the object side and a biconcave lens.

The seventh lens group G7 includes a biconvex lens, a biconvex lens, and a biconcave lens with both surfaces having a predetermined aspherical shape. The final lens LN corresponds to a biconcave lens disposed closest to the image side in the seventh lens group G7.

### Example 6

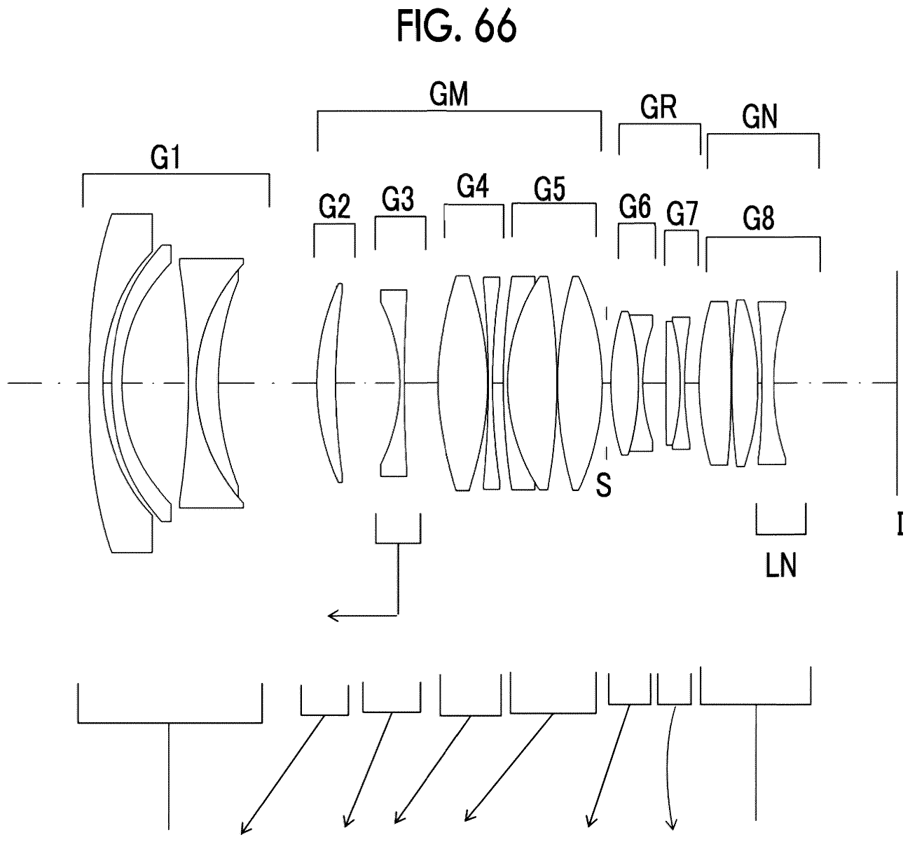

FIG. 66 is a lens configuration diagram at a zoom lens of Example 6 of the invention. The zoom lens of Example 6 includes a first lens group G1 having a negative refractive power, a second lens group G2 having a positive refractive power, a third lens group G3 having a negative refractive power, a fourth lens group G4 having a positive refractive power, a fifth lens group G5 having a positive refractive power, a sixth lens group G6 having a negative refractive power, a seventh lens group G7 having a negative refractive power, and an eighth lens group G8 having a positive refractive power. During zooming from the wide-angle end to the telephoto end, the distances between the groups change; all of the groups from the second lens group G2 to the sixth lens group G6 move toward the object side; and the seventh lens group G7 moves toward the object side from the wide-angle end to the middle focal length, and moves toward the image surface side from the middle focal length to the telephoto end. The aperture diaphragm S is provided on the object side of the sixth lens group G6 and moves integrally with the sixth lens group G6 during zooming. During focusing from the infinite distance object to the close distance object, the third lens group G3 moves toward the object side along the optical axis. The first lens group G1 and the eighth lens group G8 are fixed in both the zooming and the focusing. In the present example, the middle lens group GM includes the second lens group G2, the third lens group G3, the fourth lens group G4, and the fifth lens group G5, the rear lens group GR includes the sixth lens group G6 and the seventh lens group G7, and the final lens group GN corresponds to the eighth lens group G8.

The first lens group G1 includes a negative meniscus lens with both surfaces having a predetermined aspherical shape and a convex surface facing the object side, a negative meniscus lens with both surfaces having a predetermined aspherical shape and a convex surface facing the object side, a cemented lens composed of a biconcave lens and a positive meniscus lens with a convex surface facing the object side.

The second lens group G2 includes a positive meniscus lens with a convex surface facing the object side.

The third lens group G3 includes a biconcave lens.

The fourth lens group G4 includes a biconvex lens with both surfaces having a predetermined aspherical shape, and a biconcave lens.

The fifth lens group G5 includes a cemented lens composed of a negative meniscus lens convex toward the object side and a biconvex lens, and a biconvex lens.

The sixth lens group G6 includes an aperture diaphragm S and a cemented lens composed of a biconvex lens and a biconcave lens.

The seventh lens group G7 includes a cemented lens composed of a biconvex lens and a biconcave lens.

The eighth lens group G8 includes a biconvex lens, a biconvex lens, and a biconcave lens with both surfaces having a predetermined aspherical shape. The final lens LN corresponds to a biconcave lens disposed closest to the image side in the eighth lens group G8.

### Example 7

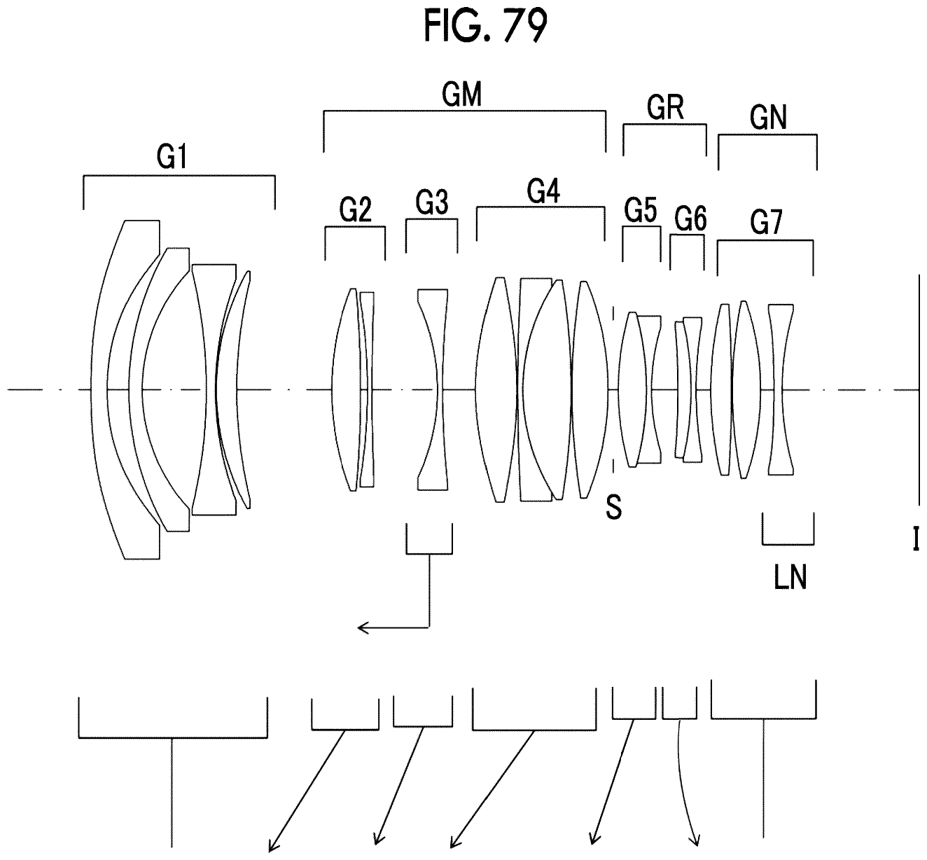

FIG. 79 is a diagram showing a lens configuration of a zoom lens of Example 7 of the invention. The zoom lens of Example 7 includes the first lens group G1 having a negative refractive power, the second lens group G2 having a positive refractive power, the third lens group G3 having a negative refractive power, the fourth lens group G4 having a positive refractive power, the fifth lens group G5 having a negative refractive power, the sixth lens group G6 having a negative refractive power, and the seventh lens group G7 having a positive refractive power. During zooming from the wide-angle end to the telephoto end, the distances between the groups change, all of the groups from the second lens group G2 to the fifth lens group G5 move toward the object side, and the sixth lens group G6 moves to the object side from the wide-angle end to the middle focal length and then moves to the image surface side from the middle focal length to the telephoto end. The aperture diaphragm S is provided on the object side of the fifth lens group G5 and moves integrally with the fifth lens group G5 during zooming. During focusing from the infinite distance object to the close distance object, the third lens group G3 moves toward the object side along the optical axis. The first lens group G1 and the seventh lens group G7 are fixed in both the zooming and the focusing. In the present example, the middle lens group GM includes the second lens group G2, the third lens group G3, and the fourth lens group G4; the rear lens group GR includes the fifth lens group G5 and the sixth lens group G6; and the final lens group GN corresponds to the seventh lens group G7.

The first lens group G1 includes a negative meniscus lens with both surfaces having a predetermined aspherical shape and a convex surface facing the object side, a negative meniscus lens with a convex surface facing the object side, a biconcave lens, and a positive meniscus lens with a convex surface facing the object side.

The second lens group G2 includes a biconvex lens, and a biconcave lens.

The third lens group G3 includes a biconcave lens.

The fourth lens group G4 includes a biconvex lens with both surfaces having a predetermined aspherical shape, a cemented lens composed of a negative meniscus lens with a convex surface facing the object side and a biconvex lens, and a biconvex lens.

The fifth lens group G5 includes an aperture diaphragm S, and a cemented lens composed of a biconvex lens and a biconcave lens.

The sixth lens group G6 includes a cemented lens composed of a positive meniscus lens with a concave surface facing the object side and a biconcave lens.

The seventh lens group G7 includes a biconvex lens, a biconvex lens, and a biconcave lens with both surfaces having a predetermined aspherical shape. The final lens LN corresponds to a biconcave lens disposed closest to the image side in the seventh lens group G7.

### Example 8

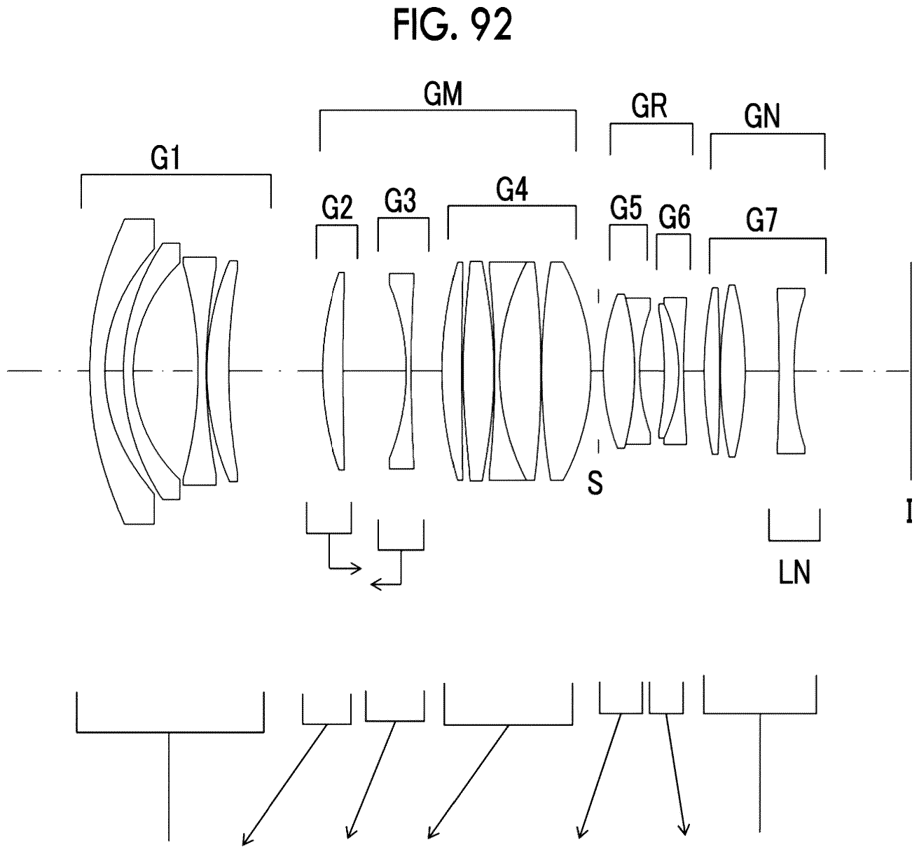

FIG. 92 is a lens configuration diagram at a zoom lens of Example 8 of the invention. The zoom lens of Example 8 includes the first lens group G1 having a negative refractive power, the second lens group G2 having a positive refractive power, the third lens group G3 having a negative refractive power, the fourth lens group G4 having a positive refractive power, the fifth lens group G5 having a negative refractive power, the sixth lens group G6 having a negative refractive power, and the seventh lens group G7 having a positive refractive power. During zooming from the wide-angle end to the telephoto end, the distances between the groups change, all of the groups from the second lens group G2 to the fifth lens group G5 move toward the object side, and the sixth lens group G6 moves toward the image surface side. The aperture diaphragm S is provided on the object side of the fifth lens group G5 and moves integrally with the fifth lens group G5 during zooming. During focusing from the infinite distance object to the close distance object, the second lens group G2 moves toward the image surface side along the optical axis, and the third lens group G3 moves to the object side along the optical axis. The first lens group G1 and the seventh lens group G7 are fixed in both the zooming and the focusing. In the present example, the middle lens group GM includes the second lens group G2, the third lens group G3, and the fourth lens group G4; the rear lens group GR includes the fifth lens group G5 and the sixth lens group G6; and the final lens group GN corresponds to the seventh lens group G7.

The first lens group G1 includes a negative meniscus lens with both surfaces having a predetermined aspherical shape and a convex surface facing the object side, a negative meniscus lens with a convex surface facing the object side, a biconcave lens, and a positive meniscus lens with a convex surface facing the object side.

The second lens group G2 includes a positive meniscus lens with a convex surface facing the object side.

The third lens group G3 includes a biconcave lens.

The fourth lens group G4 includes a positive meniscus lens with a convex surface facing the object side, a biconvex lens with both surfaces having a predetermined aspherical shape, a cemented lens composed of a biconcave lens and a biconvex lens, and a biconvex lens.

The fifth lens group G5 includes an aperture diaphragm S, and a cemented lens composed of a biconvex lens and a biconcave lens.

The sixth lens group G6 includes a cemented lens composed of a positive meniscus lens with a concave surface facing the object side and a biconcave lens.

The seventh lens group G7 includes a biconvex lens, a biconvex lens, and a biconcave lens with both surfaces having a predetermined aspherical shape. The final lens LN corresponds to a biconcave lens disposed closest to the image side in the seventh lens group G7.

Specific numerical data of each example of the zoom lens according to the embodiment of the present invention will be shown below.

In [Surface data], the surface number is the number of a lens surface or an aperture diaphragm S counted from the object side, r is a curvature radius of each surface, d is a distance between surfaces, nd is a refractive index at a d line (wavelength of 587.56 nm), and vd is an Abbe number at the d line.

An asterisk (*) attached to a surface number indicates that the lens surface shape is an aspherical shape. In addition, BF represents a back focus.

The (diaphragm) attached to the surface number indicates that the aperture diaphragm S is located at that position. A curvature radius with respect to the plane or the aperture diaphragm S is denoted by ∞ (infinity).

[Aspherical surface data] shows values of each coefficient for giving the aspherical shape of the lens surface denoted by * in [Surface data]. In a case where a displacement from the optical axis in a direction perpendicular to the optical axis is y, a displacement (sag) from an intersection of the optical axis and the aspherical surface in an optical axis direction is z, a curvature radius of a reference spherical surface is r, a conic coefficient is K, and aspherical coefficients of fourth order, sixth order, . . . , and twentieth order are A4, A6, . . . , and A20, respectively, coordinates of the aspherical surface are represented by the following expression.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12} + A 14 {y}^{14} + A 16 {y}^{16} + A 18 {y}^{18} + A 20 {y}^{20}$$

[Various types of data] indicate values such as a zoom ratio and a focal length in each focal length state.

The [Variable distance data] shows the variable distance and the BF value in each focal length state.

The [Lens group data] shows the surface number closest to the object side configuring each lens group and the total focal length of the entire group.

In addition, in all the values of the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system.

In addition, in the aberration diagrams corresponding to the respective examples, d, g, and C represent a d line, a g line, and a C line, respectively, and ΔS and ΔM represent a sagittal image surface and a meridional image surface, respectively.

### Numerical Example 1

Unit: mm
[Surface data]

| Surface number | r | d | nd | vd |
|---|---|---|---|---|
| Object | (d0) | | | |
| surface ∞ | | | | |
| 1* | 62.8412 | 2.5000 | 1.69350 | 53.18 |
| 2* | 33.7141 | 6.8143 | | |
| 3 | 69.5030 | 1.6000 | 1.55200 | 70.70 |
| 4 | 32.0589 | 11.4771 | | |
| 5 | −100.6393 | 1.2000 | 1.59349 | 67.00 |
| 6 | 131.3025 | 0.2000 | | |
| 7 | 55.0603 | 3.3027 | 1.94594 | 17.98 |
| 8 | 105.6073 | (d8) | | |
| 9 | 57.1246 | 4.1036 | 1.72916 | 54.67 |
| 10 | 370.9703 | (d10) | | |
| 11 | −46.6108 | 1.0000 | 1.70300 | 52.38 |
| 12 | 316.5784 | (d12) | | |
| 13 | 82.6292 | 5.5014 | 2.00100 | 29.13 |
| 14 | 1000.0000 | 0.1500 | | |
| 15* | 113.6023 | 6.2500 | 1.85135 | 40.10 |
| 16* | −85.0000 | 0.1500 | | |
| 17 | −161.1335 | 1.0000 | 1.75520 | 27.53 |
| 18 | 43.4754 | 10.4757 | 1.55032 | 75.50 |
| 19 | −138.4530 | 0.1500 | | |
| 20 | 145.7610 | 9.1551 | 1.48071 | 85.29 |
| 21 | −50.0098 | (d21) | | |
| 22 | ∞ | 1.0000 | | |
| (diaphragm) | | | | |
| 23 | 48.4843 | 5.9411 | 1.55032 | 75.50 |
| 24 | −63.0665 | 1.0000 | 1.84666 | 23.78 |
| 25 | 41.9346 | (d25) | | |
| 26 | −54.6452 | 3.8799 | 1.59282 | 68.62 |
| 27 | −21.9774 | 1.0000 | 1.61340 | 44.27 |
| 28 | 392.2475 | (d28) | | |
| 29 | 91.5064 | 3.0439 | 1.98612 | 16.48 |
| 30 | −237.3723 | 0.1500 | | |
| 31 | 160.0150 | 3.9676 | 1.87070 | 40.73 |
| 32 | −71.3877 | 7.8385 | | |
| 33* | −266.3635 | 3.9000 | 1.80610 | 40.73 |
| 34* | 101.2174 | (BF) | | |
| image | ∞ | | | |
| surface | | | | |

[Aspherical surface data]

| | Surface 1 | Surface 2 | Surface 15 | Surface 16 | Surface 33 |
|---|---|---|---|---|---|
| K | −0.42595 | 0.01244 | 0.00000 | 0.00000 | 0.00000 |
| A4 | 3.19947E−06 | 2.50431E−06 | −2.95295E−06 | 1.50717E−06 | 5.31830E−06 |
| A6 | 4.62317E−09 | 4.40329E−09 | −1.06620E−09 | −1.33491E−09 | −2.40499E−08 |
| A8 | −6.84866E−11 | −6.90636E−11 | 6.01008E−12 | 6.00753E−12 | 3.63138E−13 |
| A10 | 2.57540E−13 | 1.99490E−13 | −6.93914E−15 | −7.78748E−15 | 8.24299E−14 |
| A12 | −5.43557E−16 | −2.59035E−16 | −1.84198E−17 | −7.70817E−18 | −1.23832E−16 |
| A14 | 7.14031E−19 | 1.13939E−19 | 4.86069E−20 | 2.17147E−20 | 0.00000E+00 |
| A16 | −5.84993E−22 | 1.47896E−23 | −3.15520E−23 | −1.06508E−23 | 0.00000E+00 |
| A18 | 2.74723E−25 | 0.00000E+00 | 0.00000E+00 | 0.00000E+00 | 0.00000E+00 |
| A20 | −5.60150E−29 | 0.00000E+00 | 0.00000E+00 | 0.00000E+00 | 0.00000E+00 |

| | 34 surface |
|---|---|
| K | 0.00000 |
| A4 | 1.39286E−05 |
| A6 | −1.66494E−08 |
| A8 | −5.42999E−11 |
| A10 | 4.53620E−13 |
| A12 | −1.57009E−15 |
| A14 | 2.86549E−18 |
| A16 | −1.95585E−21 |
| A18 | 0.00000E+00 |
| A20 | 0.00000E+00 |

[Various types of data]

| | |
|---|---|
| Zoom ratio | 1.51 |

| | Wide angle | Middle | Telephoto |
|---|---|---|---|
| Focal length | 28.84 | 35.06 | 43.66 |
| F number | 1.86 | 1.86 | 1.86 |
| Total angle of view 2ω | 75.19 | 62.38 | 50.51 |
| Image height Y | 21.63 | 21.63 | 21.63 |
| Total length of lens | 168.66 | 168.66 | 168.66 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d8 | 19.1743 | 11.2712 | 3.5000 |
| d10 | 12.0903 | 14.6497 | 14.1166 |
| d12 | 6.1487 | 4.1025 | 2.8831 |
| d21 | 2.3000 | 6.6293 | 11.3402 |
| d25 | 4.4326 | 7.8911 | 14.0817 |
| d28 | 3.2698 | 2.8719 | 1.4941 |
| BF | 24.4912 | 24.4912 | 24.4912 |

In a case of photographing magnification 1:40

| | | | |
|---|---|---|---|
| d0 | 1105.8626 | 1354.7984 | 1700.3387 |
| d8 | 19.1743 | 11.2712 | 3.5000 |
| d10 | 11.3155 | 13.9869 | 13.5524 |
| d12 | 6.9235 | 4.7652 | 3.4473 |
| d21 | 2.3000 | 6.6293 | 11.3402 |
| d25 | 4.4326 | 7.8911 | 14.0817 |
| d28 | 3.2698 | 2.8719 | 1.4941 |
| BF | 24.4912 | 24.4912 | 24.4912 |

[Lens group data]

| Group | Starting surface | Focal length |
|---|---|---|
| G1 | 1 | −46.04 |
| G2 | 9 | 92.09 |
| G3 | 11 | −57.73 |
| G4 | 13 | 32.98 |
| G5 | 22 | −80.77 |
| G6 | 26 | −74.48 |
| G7 | 29 | 40.70 |

### Numerical Example 2

Unit: mm
[Surface data]

| Surface number | r | d | nd | vd |
|---|---|---|---|---|
| Object | ∞ | (d0) | | |
| surface | | | | |
| 1* | 175.6195 | 3.2188 | 1.69350 | 53.18 |
| 2* | 38.6465 | 4.6809 | | |
| 3* | 61.8505 | 2.5198 | 1.59201 | 67.02 |
| 4* | 37.2488 | 12.7752 | | |
| 5 | −96.6987 | 1.6000 | 1.49700 | 81.61 |
| 6 | 61.7440 | 0.1500 | | |
| 7 | 47.7086 | 4.0295 | 1.92286 | 20.88 |
| 8 | 95.9441 | (d8) | | |
| 9 | 50.0000 | 3.8501 | 1.83481 | 42.72 |
| 10 | 155.0631 | (d10) | | |
| 11 | −40.3089 | 0.9000 | 1.61340 | 44.27 |
| 12 | 157.5857 | (d12) | | |
| 13* | 53.8625 | 11.8461 | 1.85135 | 40.10 |
| 14* | −67.4806 | 0.1500 | | |
| 15 | 550.8385 | 0.9000 | 1.80000 | 29.84 |
| 16 | 34.5485 | 11.2421 | 1.59282 | 68.62 |
| 17 | −207.2689 | 0.1500 | | |
| 18 | 80.3648 | 8.3437 | 1.48071 | 85.29 |
| 19 | −52.3655 | (d19) | | |
| 20 | ∞ | 0.9000 | | |
| (diaphragm) | | | | |
| 21 | 50.1862 | 5.3447 | 1.48071 | 85.29 |
| 22 | −59.0132 | 0.9000 | 1.72825 | 28.32 |
| 23 | 34.9946 | (d23) | | |
| 24 | −240.5948 | 3.3078 | 1.49700 | 81.61 |
| 25 | −37.6917 | 0.9000 | 1.65412 | 39.68 |
| 26 | 121.1138 | (d26) | | |
| 27 | 63.0453 | 5.2892 | 1.94594 | 17.98 |
| 28 | −179.1150 | 0.1500 | | |
| 29 | 237.1249 | 5.6413 | 1.77250 | 49.63 |
| 30 | −47.9368 | 1.0765 | | |
| 31* | −115.9631 | 1.9088 | 1.80610 | 40.73 |
| 32* | 64.7407 | (BF) | | |
| image | ∞ | | | |
| surface | | | | |

[Aspherical surface data]

| | 1 surface | 2 surface | 3 surface | 4 surface | 13 surface |
|---|---|---|---|---|---|
| K | 8.28836 | 0.00000 | 0.35877 | 0.00000 | 0.00000 |
| A4 | 4.81552E−06 | 2.86558E−06 | 7.61058E−06 | 1.15632E−05 | −4.15242E−06 |
| A6 | −6.06818E−09 | −6.03010E−09 | −1.62747E−08 | −1.24378E−08 | 1.18236E−09 |
| A8 | 7.32458E−12 | 8.92771E−12 | 3.59158E−11 | 3.07916E−11 | 2.03139E−12 |
| A10 | −5.21062E−15 | 1.07998E−14 | −3.15307E−14 | −4.17458E−14 | 0.00000E+00 |
| A12 | 1.63460E−18 | −1.49185E−17 | 0.00000E+00 | 0.00000E+00 | 0.00000E+00 |

| | 14 surfaces | 31 surfaces | 32 surfaces |
|---|---|---|---|
| K | 0.00000 | 0.00000 | 0.00000 |
| A4 | 2.38768E−06 | −1.45417E−07 | 9.85508E−06 |
| A6 | −7.38320E−10 | −3.12416E−08 | −2.50647E−08 |
| A8 | 3.35215E−12 | 3.25289E−11 | 2.81686E−11 |
| A10 | 0.00000E+00 | 0.00000E+00 | 0.00000E+00 |
| A12 | 0.00000E+00 | 0.00000E+00 | 0.00000E+00 |

[Various types of data]

| | |
|---|---|
| Zoom ratio | 1.57 |

| | Wide angle | Middle | Telephoto |
|---|---|---|---|
| Focal length | 24.72 | 29.82 | 38.82 |
| F number | 1.86 | 1.86 | 1.86 |
| Total angle of view 2ω | 85.45 | 71.84 | 55.91 |
| Image height Y | 21.63 | 21.63 | 21.63 |
| Total length of lens | 164.03 | 164.03 | 164.03 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d8 | 18.7777 | 11.8537 | 3.5000 |
| d10 | 12.8935 | 15.8557 | 16.0246 |
| d12 | 6.9584 | 4.5468 | 2.4885 |
| d19 | 0.9000 | 4.2517 | 8.5205 |
| d23 | 5.3985 | 7.6001 | 14.5477 |
| d26 | 2.1153 | 2.9352 | 1.9620 |
| BF | 25.2096 | 25.2096 | 25.2096 |

In a case of photographing magnification 1:40

| | | | |
|---|---|---|---|
| d0 | 947.0854 | 1151.0626 | 1511.9902 |
| d8 | 18.7777 | 11.8537 | 3.5000 |
| d10 | 12.2762 | 15.3274 | 15.5936 |
| d12 | 7.5756 | 5.0751 | 2.9195 |
| d19 | 0.9000 | 4.2517 | 8.5205 |
| d23 | 5.3985 | 7.6001 | 14.5477 |
| d26 | 2.1153 | 2.9352 | 1.9620 |
| BF | 25.2096 | 25.2096 | 25.2096 |

[Lens group data]

| Group | Starting surface | Focal length |
|---|---|---|
| G1 | 1 | −39.41 |
| G2 | 9 | 86.95 |
| G3 | 11 | −52.24 |
| G4 | 13 | 28.98 |
| G5 | 20 | −68.96 |
| G6 | 24 | −85.49 |
| G7 | 27 | 46.55 |

### Numerical Example 3

Unit: mm
[Surface data]

| Surface | | | | |
|---|---|---|---|---|
| number | r | d | nd | vd |
| Object | (d0) | | | |
| surface ∞ | | | | |
| 1* | 72.7404 | 2.5000 | 1.59201 | 67.02 |
| 2* | 26.8534 | 16.9134 | | |
| 3 | −53.0602 | 1.4000 | 1.61997 | 63.88 |
| 4 | 115.1537 | 0.1500 | | |
| 5 | 75.9031 | 3.5248 | 1.94594 | 17.98 |
| 6 | 262.1067 | (d6) | | |
| 7 | 57.3272 | 5.7198 | 1.70300 | 52.38 |
| 8 | −1468.0937 | (d8) | | |
| 9 | −45.4258 | 1.0000 | 1.65844 | 50.86 |
| 10 | 185.1358 | (d10) | | |
| 11 | 77.1076 | 5.6006 | 1.91082 | 35.25 |
| 12 | −1971.5067 | 0.4916 | | |
| 13* | 123.6521 | 6.2500 | 1.85135 | 40.10 |
| 14* | −95.1170 | 0.1500 | | |
| 15 | −316.1223 | 1.0000 | 1.74077 | 27.76 |
| 16 | 43.3771 | 10.4687 | 1.55032 | 75.50 |
| 17 | −286.7891 | 0.1500 | | |
| 18 | 128.2806 | 9.6229 | 1.49700 | 81.61 |
| 19 | −64.1796 | (d19) | | |
| 20 | 551.1609 | 2.6678 | 1.55397 | 71.76 |
| 21 | −135.5689 | 1.0000 | | |
| 22 | ∞ | 1.0000 | | |
| (diaphragm) | | | | |
| 23 | 76.9783 | 6.0111 | 1.55032 | 75.50 |
| 24 | −50.3799 | 1.0000 | 1.92119 | 23.96 |
| 25 | 62.7566 | (d25) | | |
| 26 | −129.5027 | 3.2188 | 1.55032 | 75.50 |
| 27 | −37.9790 | 1.0000 | 1.61340 | 44.27 |
| 28 | 78.9789 | (d28) | | |
| 29 | 74.7276 | 4.4496 | 1.98612 | 16.48 |
| 30 | −229.3531 | 0.1500 | | |
| 31 | 104.2405 | 5.0988 | 1.76385 | 48.49 |
| 32 | −86.1034 | 5.2227 | | |
| 33* | −134.6538 | 3.8503 | 1.80610 | 40.73 |
| 34* | 71.0603 | (BF) | | |
| image | ∞ | | | |
| surface | | | | |

[Aspherical surface data]

| | 1 surface | 2 surface | 13 surface | 14 surface | 33 surface |
|---|---|---|---|---|---|
| K | −1.32185 | −0.01863 | 0.00000 | 0.00000 | 0.00000 |
| A4 | 2.52291E−06 | −1.92779E−07 | −3.00986E−06 | 8.88334E−07 | 3.87114E−06 |
| A6 | −2.23915E−09 | 2.66457E−09 | −5.89472E−11 | −7.99717E−10 | −1.90089E−08 |
| A8 | −9.22253E−12 | −5.02266E−11 | −2.88854E−12 | −1.83314E−12 | 1.89250E−11 |
| A10 | 3.11359E−14 | 1.09736E−13 | 7.72533E−15 | 6.33449E−15 | −1.29806E−14 |
| A12 | −3.50316E−17 | −9.70686E−17 | −4.56627E−18 | −3.85109E−18 | 0.00000E+00 |
| A14 | 1.40886E−20 | 0.00000E+00 | 0.00000E+00 | 0.00000E+00 | 0.00000E+00 |

| | 34 surface |
|---|---|
| K | 0.00000 |
| A4 | 1.13079E−05 |
| A6 | −1.47420E−08 |
| A8 | 1.60794E−11 |
| A10 | −1.66539E−14 |
| A12 | 0.00000E+00 |
| A14 | 0.00000E+00 |

[Various types of data]

| | |
|---|---|
| Zoom ratio | 1.57 |

| | Wide angle | Middle | Telephoto |
|---|---|---|---|
| Focal length | 30.88 | 35.69 | 48.48 |
| F number | 1.86 | 1.86 | 1.86 |
| Total angle of view 2ω | 73.11 | 62.81 | 46.05 |
| Image height Y | 21.63 | 21.63 | 21.63 |
| Total length of lens | 174.77 | 174.77 | 174.78 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d6 | 23.2844 | 16.3368 | 3.5000 |
| d8 | 13.4095 | 15.2114 | 14.3989 |
| d10 | 4.2954 | 3.6722 | 3.2920 |
| d19 | 1.5500 | 4.6952 | 11.9169 |
| d25 | 3.7924 | 6.1380 | 13.5272 |
| d28 | 7.7825 | 8.0605 | 7.4792 |
| BF | 21.0500 | 21.0500 | 21.0500 |

In a case of photographing magnification 1:40

| | | | |
|---|---|---|---|
| d0 | 1186.9374 | 1379.8682 | 1893.6821 |
| d6 | 23.2844 | 16.3368 | 3.5000 |
| d8 | 12.6898 | 14.5788 | 13.9055 |
| d10 | 5.0151 | 4.3048 | 3.7855 |
| d19 | 1.5500 | 4.6952 | 11.9169 |
| d25 | 3.7924 | 6.1380 | 13.5272 |
| d28 | 7.7825 | 8.0605 | 7.4792 |
| BF | 21.0500 | 21.0500 | 21.0500 |

[Lens group data]

| Group | Starting surface | Focal length |
|---|---|---|
| G1 | 1 | −42.33 |
| G2 | 7 | 78.60 |
| G3 | 9 | −55.30 |
| G4 | 11 | 33.77 |
| G5 | 20 | −116.94 |
| G6 | 26 | −72.52 |
| G7 | 29 | 48.82 |

### Numerical Example 4

Unit: mm
[Surface data]

| Surface | | | | |
|---|---|---|---|---|
| number | r | d | nd | vd |
| Object | (d0) | | | |
| surface ∞ | | | | |
| 1* | 158.4085 | 3.1378 | 1.69350 | 53.18 |
| 2* | 58.6578 | 2.5000 | | |
| 3 | 56.0610 | 2.0000 | 1.61997 | 63.88 |
| 4 | 29.2384 | 13.6544 | | |
| 5 | −107.5990 | 1.6000 | 1.61997 | 63.88 |
| 6 | 106.6667 | 0.1500 | | |
| 7 | 51.9869 | 3.8874 | 1.94594 | 17.98 |
| 8 | 97.6675 | (d8) | | |
| 9 | 159.6771 | 4.1822 | 1.81600 | 46.62 |
| 10 | −131.6527 | (d10) | | |
| 11 | −49.1740 | 1.0000 | 1.76385 | 48.49 |
| 12 | 329.1747 | (d12) | | |
| 13 | 62.6924 | 4.5207 | 1.88100 | 40.14 |
| 14 | 319.9991 | 1.4935 | | |
| 15* | 124.6808 | 11.0241 | 1.85108 | 40.12 |
| 16* | −66.8239 | 0.1500 | | |
| 17 | −105.9516 | 1.0000 | 1.72825 | 28.32 |
| 18 | 45.0463 | 10.5246 | 1.55032 | 75.50 |
| 19 | −98.8414 | 0.1500 | | |
| 20 | 431.0136 | 11.7395 | 1.55397 | 71.76 |
| 21 | −47.9183 | (d21) | | |
| 22 | ∞ | 1.0000 | | |
| (diaphragm) | | | | |
| 23 | 55.8267 | 6.7168 | 1.55032 | 75.50 |
| 24 | −40.5425 | 1.0000 | 1.85883 | 30.00 |
| 25 | 60.0420 | (d25) | | |
| 26 | −94.7190 | 3.2945 | 1.57144 | 71.61 |
| 27 | −28.1463 | 1.0000 | 1.60342 | 38.01 |
| 28 | 54.0238 | 4.0472 | | |
| 29 | 71.7642 | 3.3101 | 1.94594 | 17.98 |
| 30 | −284.2638 | 0.1500 | | |
| 31 | 103.9551 | 6.4920 | 1.83400 | 37.34 |
| 32 | −44.8608 | 1.7741 | | |
| 33* | −111.7094 | 4.6794 | 1.80610 | 40.73 |
| 34* | 58.7605 | (BF) | | |
| image | ∞ | | | |
| surface | | | | |

[Aspherical surface data]

| | Surface 1 | Surface 2 | Surface 15 | Surface 16 | Surface 33 |
|---|---|---|---|---|---|
| K | 0.00000 | 0.00000 | 0.00000 | 0.00000 | 0.00000 |
| A4 | 4.69562E−06 | 4.69560E−06 | −3.18717E−06 | 1.84191E−06 | −1.71829E−06 |
| A6 | −3.68771E−09 | −2.59530E−09 | −4.61571E−11 | 9.78127E−11 | −2.51984E−08 |
| A8 | 3.75879E−12 | 3.62499E−12 | 1.92620E−12 | 2.27963E−12 | 1.85179E−11 |
| A10 | −2.46887E−15 | −2.20139E−15 | 0.00000E+00 | 0.00000E+00 | 0.00000E+00 |
| A12 | 6.54735E−19 | 0.00000E+00 | 0.00000E+00 | 0.00000E+00 | 0.00000E+00 |

| | 34 surface |
|---|---|
| K | 0.00000 |
| A4 | 8.66839E−06 |
| A6 | −2.52264E−08 |
| A8 | 2.10638E−11 |
| A10 | 0.00000E+00 |
| A12 | 0.00000E+00 |

[Various types of data]

| | |
|---|---|
| Zoom ratio | 1.51 |

| | Wide angle | Middle | Telephoto |
|---|---|---|---|
| Focal length | 28.85 | 34.93 | 43.65 |
| F number | 1.86 | 1.86 | 1.86 |
| Total angle of view 2ω | 75.96 | 62.93 | 50.54 |
| Image height Y | 21.63 | 21.63 | 21.63 |
| Total length of lens | 169.80 | 169.80 | 169.80 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d8 | 9.6328 | 5.5335 | 3.5003 |
| d10 | 12.1320 | 14.3924 | 12.4689 |
| d12 | 12.0652 | 7.4078 | 2.5000 |
| d21 | 1.4000 | 4.7773 | 8.9948 |
| d25 | 3.6846 | 6.8036 | 11.4505 |
| BF | 24.7114 | 24.7114 | 24.7114 |

In a case of photographing magnification 1:40

| | | | |
|---|---|---|---|
| d0 | 1104.4175 | 1349.1052 | 1698.4065 |
| d8 | 11.5983 | 7.1915 | 4.8447 |
| d10 | 10.1665 | 12.7343 1 | 1.1246 |
| d12 | 12.0652 | 7.4078 | 2.5000 |
| d21 | 1.4000 | 4.7773 | 8.9948 |
| d25 | 3.6846 | 6.8036 | 11.4505 |
| BF | 24.7114 | 24.7114 | 24.7114 |

[Lens group data]

| Group | Starting surface | Focal length |
|---|---|---|
| G1 | 1 | −46.78 |
| G2 | 9 | 89.00 |
| G3 | 11 | −55.95 |
| G4 | 13 | 33.15 |
| G5 | 22 | −90.09 |
| G6 | 26 | 131.38 |

### Numerical Example 5

Unit: mm
[Surface data]

| Surface | | | | |
|---|---|---|---|---|
| number | r | d | nd | vd |
| Object | (d0) | | | |
| surface ∞ | | | | |
| 1* | 95.4476 | 2.8000 | 1.69350 | 53.18 |
| 2* | 42.7004 | 2.5001 | | |
| 3 | 48.2745 | 1.9000 | 1.55200 | 70.70 |
| 4 | 30.3400 | 13.7098 | | |
| 5 | −98.3978 | 1.5000 | 1.59349 | 67.00 |
| 6 | 69.2811 | 0.1500 | | |
| 7 | 54.0201 | 3.6539 | 1.94594 | 17.98 |
| 8 | 106.6149 | (d8) | | |
| 9 | 57.4746 | 4.7246 | 1.72916 | 54.67 |
| 10 | 3049.2390 | (d10) | | |
| 11 | −50.8811 | 1.0000 | 1.70154 | 41.15 |
| 12 | 55.5124 | 3.4052 | 1.77047 | 29.74 |
| 13 | 156.5356 | (d13) | | |
| 14 | 66.2068 | 4.2342 | 1.91082 | 35.25 |
| 15 | 290.3463 | 0.4366 | | |
| 16* | 114.9141 | 5.4541 | 1.85108 | 40.12 |
| 17* | −88.3955 | 0.1500 | | |
| 18 | −157.4833 | 1.0000 | 1.72825 | 28.32 |
| 19 | 48.8079 | 8.6020 | 1.55032 | 75.50 |
| 20 | −172.0320 | 0.1500 | | |
| 21 | 117.3905 | 10.3208 | 1.45860 | 90.19 |
| 22 | −48.6001 | (d22) | | |
| 23 | ∞ | 1.0000 | | |
| (diaphragm) | | | | |
| 24 | 51.4101 | 6.4819 | 1.55032 | 75.50 |
| 25 | −49.5975 | 1.0000 | 1.85478 | 24.80 |
| 26 | 43.0890 | (d26) | | |
| 27 | −67.8016 | 2.8774 | 1.59282 | 68.62 |
| 28 | −33.0837 | 1.0000 | 1.61340 | 44.27 |
| 29 | 117.5712 | (d29) | | |
| 30 | 89.0690 | 3.4343 | 1.98612 | 16.48 |
| 31 | −203.5393 | 0.1500 | | |
| 32 | 89.9935 | 5.0130 | 1.81600 | 46.62 |
| 33 | −71.4049 | 8.2339 | | |
| 34* | −242.8360 | 2.0664 | 1.80610 | 40.73 |
| 35* | 78.8468 | (BF) | | |
| image | ∞ | | | |
| surface | | | | |

[Aspherical surface data]

| | Surface 1 | Surface 2 | Surface 16 | Surface 17 | Surface 34 |
|---|---|---|---|---|---|
| K | 0.00000 | 0.00000 | 0.00000 | 0.00000 | 0.00000 |
| A4 | 3.67142E−06 | 3.30429E−06 | −3.02126E−06 | 1.57456E−06 | 8.98285E−06 |
| A6 | −4.73370E−09 | −4.04569E−09 | −1.45149E−09 | −1.42264E−09 | −4.93588E−08 |
| A8 | 3.79551E−12 | 7.54794E−13 | 2.47699E−12 | 2.81789E−12 | 5.10479E−11 |
| A10 | −2.26030E−15 | −7.99250E−16 | 0.00000E+00 | 0.00000E+00 | 0.00000E+00 |
| A12 | 6.36996E−19 | 0.00000E+00 | 0.00000E+00 | 0.00000E+00 | 0.00000E+00 |

| | 35 surfaces |
|---|---|
| K | 0.00000 |
| A4 | 1.83832E−05 |
| A6 | −4.59065E−08 |
| A8 | 5.08853E−11 |
| A10 | 0.00000E+00 |
| A12 | 0.00000E+00 |

[Various types of data]

| | |
|---|---|
| Zoom ratio | 1.51 |

| | Wide angle | Middle | Telephoto |
|---|---|---|---|
| Focal length | 28.85 | 34.74 | 43.65 |
| F number | 1.86 | 1.86 | 1.86 |
| Total angle of view2ω | 76.05 | 63.32 | 50.53 |
| Image height Y | 21.63 | 21.63 | 21.63 |
| Total length of lens | 168.50 | 168.50 | 168.50 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d8 | 19.6531 | 11.3661 | 3.5000 |
| d10 | 12.7208 | 15.2882 | 14.7120 |
| d13 | 6.0493 | 4.6251 | 3.2564 |
| d22 | 1.4000 | 5.5541 | 11.0359 |
| d26 | 4.9170 | 8.1820 | 13.7036 |
| d29 | 3.0939 | 2.8185 | 1.6261 |
| BF | 23.7172 | 23.7172 | 23.7172 |

In a case of photographing magnification 1:40

| | | | |
|---|---|---|---|
| d0 | 1104.4566 | 1340.5701 | 1698.5073 |
| d8 | 19.6531 | 11.3661 | 3.5000 |
| d10 | 11.8864 | 14.5802 | 14.1258 |
| d13 | 6.8836 | 5.3331 | 3.8426 |
| d22 | 1.4000 | 5.5541 | 11.0359 |
| d26 | 4.9170 | 8.1820 | 13.7036 |
| d29 | 3.0939 | 2.8185 | 1.6261 |
| BF | 23.7172 | 23.7172 | 23.7172 |

[Lens group data]

| Group | Starting surface | Focal length |
|---|---|---|
| G1 | 1 | −43.55 |
| G2 | 9 | 80.28 |
| G3 | 11 | −56.76 |
| G4 | 14 | 32.75 |
| G5 | 23 | −71.14 |
| G6 | 27 | −68.00 |
| G7 | 30 | 36.94 |

### Numerical Example 6

Unit: mm
[Surface data]

| Surface | | | | |
|---|---|---|---|---|
| number | r | d | nd | vd |
| Object | (d0) | | | |
| surface ∞ | | | | |
| 1* | 214.4813 | 2.9004 | 1.69350 | 53.18 |
| 2* | 46.1965 | 1.8288 | | |
| 3* | 60.4817 | 2.2000 | 1.59201 | 67.02 |
| 4* | 41.0054 | 13.8206 | | |
| 5 | −162.5716 | 1.6000 | 1.49700 | 81.61 |
| 6 | 36.3963 | 4.5897 | 1.92286 | 20.88 |
| 7 | 57.5758 | (d7) | | |
| 8 | 50.0849 | 3.9180 | 1.83481 | 42.72 |
| 9 | 135.3956 | (d9) | | |
| 10 | −37.8690 | 0.9000 | 1.61340 | 44.27 |
| 11 | 315.0424 | (d11) | | |
| 12* | 56.1261 | 10.2707 | 1.85135 | 40.10 |
| 13* | −57.5994 | 0.1500 | | |
| 14 | −215.6171 | 0.9000 | 1.64769 | 33.84 |
| 15 | 144.3980 | (d15) | | |
| 16 | 141.4326 | 0.9000 | 1.80000 | 29.84 |
| 17 | 40.3988 | 10.2430 | 1.55032 | 75.50 |
| 18 | −127.9767 | 0.1500 | | |
| 19 | 80.2060 | 9.2661 | 1.48071 | 85.29 |
| 20 | −52.6130 | (d20) | | |
| 21 | ∞ | 0.9000 | | |
| (diaphragm) | | | | |
| 22 | 51.9735 | 5.7169 | 1.48071 | 85.29 |
| 23 | −53.1568 | 0.9000 | 1.74077 | 27.76 |
| 24 | 36.0203 | (d24) | | |
| 25 | 1347.1378 | 2.9303 | 1.49700 | 81.61 |
| 26 | −51.8880 | 0.9000 | 1.65412 | 39.68 |
| 27 | 74.0671 | (d27) | | |
| 28 | 61.7138 | 6.6387 | 1.94594 | 17.98 |
| 29 | −193.2019 | 0.1500 | | |
| 30 | 150.5369 | 5.4082 | 1.77250 | 49.63 |
| 31 | −54.2750 | 0.8499 | | |
| 32* | −300.0000 | 2.5062 | 1.80610 | 40.73 |
| 33* | 54.1984 | (BF) | | |
| image | ∞ | | | |
| surface | | | | |

[Aspherical surface data]

| | 1 surface | 2 surface | 3 surface | 4 surface | 12 surface |
|---|---|---|---|---|---|
| K | −22.00362 | 0.00000 | 1.49222 | 0.00000 | 0.00000 |
| A4 | 2.04562E−06 | 2.94297E−06 | 5.88995E−06 | 4.51938E−06 | −4.17716E−06 |
| A6 | −8.27556E−10 | −6.26872E−09 | −6.26269E−09 | 4.63180E−09 | 5.67456E−10 |
| A8 | 3.63705E−13 | 1.23231E−11 | 9.54129E−12 | −9.65526E−12 | 2.04941E−12 |
| A10 | −1.27327E−16 | −7.28332E−15 | −7.06530E−15 | 1.83871E−15 | 0.00000E+00 |
| A12 | 3.42673E−20 | 6.96303E−19 | 0.00000E+00 | 0.00000E+00 | 0.00000E+00 |

| | 13 surfaces | 32 surfaces | 33 surfaces |
|---|---|---|---|
| K | 0.00000 | 0.00000 | 0.00000 |
| A4 | 2.62844E−06 | −2.42175E−06 | 6.21081E−06 |
| A6 | −1.50606E−09 | −1.72567E−08 | −1.24109E−08 |
| A8 | 3.33229E−12 | 1.13344E−11 | 7.85935E−12 |
| A10 | 0.00000E+00 | 0.00000E+00 | 0.00000E+00 |
| A12 | 0.00000E+00 | 0.00000E+00 | 0.00000E+00 |

[Various types of data]

| | |
|---|---|
| Zoom ratio | 1.66 |

| | Wide angle | Middle | Telephoto |
|---|---|---|---|
| Focal length | 24.72 | 29.84 | 41.00 |
| F number | 1.86 | 1.86 | 1.86 |
| Full angle of view 2ω | 86.64 | 72.59 | 53.35 |
| Image height Y | 21.63 | 21.63 | 21.63 |
| Total length of lens | 168.00 | 168.00 | 168.00 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d7 | 20.4639 | 12.8159 | 3.5295 |
| d9 | 13.3078 | 15.9680 | 14.2121 |
| d11 | 7.0445 | 4.8985 | 2.5994 |
| d15 | 2.2176 | 2.7321 | 3.0553 |
| d20 | 0.9000 | 4.8441 | 11.4048 |
| d24 | 4.8511 | 6.8808 | 13.8837 |
| d27 | 3.0342 | 3.6797 | 3.1343 |
| BF | 25.6419 | 25.6419 | 25.6419 |

In a case of photographing magnification 1:40

| | | | |
|---|---|---|---|
| d0 | 946.6421 | 1151.8197 | 1599.7326 |
| d7 | 20.4639 | 12.8159 | 3.5295 |
| d9 | 12.6962 | 15.4401 | 13.7865 |
| d11 | 7.6562 | 5.4264 | 3.0250 |
| d15 | 2.2176 | 2.7321 | 3.0553 |
| d20 | 0.9000 | 4.8441 | 11.4048 |
| d24 | 4.8511 | 6.8808 | 13.8837 |
| d27 | 3.0342 | 3.6797 | 3.1343 |
| BF | 25.6419 | 25.6419 | 25.6419 |

[Lens group data]

| Group | Starting surface | Focal length |
|---|---|---|
| G1 | 1 | −38.53 |
| G2 | 8 | 93.27 |
| G3 | 10 | −55.06 |
| G4 | 12 | 45.57 |
| G5 | 16 | 54.45 |
| G6 | 21 | −65.57 |
| G7 | 25 | −87.00 |
| G8 | 28 | 43.10 |

### Numerical Example 7

Unit: mm
[Surface data]

| Surface | | | | |
|---|---|---|---|---|
| number | r | d | nd | vd |
| Object | (d0) | | | |
| surface ∞ | | | | |
| 1* | 151.2935 | 3.1469 | 1.59201 | 67.02 |
| 2* | 45.2619 | 4.2544 | | |
| 3 | 55.0000 | 2.6207 | 1.51680 | 64.20 |
| 4 | 34.0938 | 12.5765 | | |
| 5 | −98.0840 | 1.8000 | 1.55032 | 75.50 |
| 6 | 60.7277 | 0.1500 | | |
| 7 | 47.5967 | 4.0234 | 1.92286 | 20.88 |
| 8 | 90.1388 | (d8) | | |
| 9 | 54.5729 | 5.6886 | 1.83481 | 42.72 |
| 10 | −218.8108 | 1.3561 | | |
| 11 | −109.4054 | 0.9000 | 1.68893 | 31.16 |
| 12 | 463.2564 | (d12) | | |
| 13 | −40.5579 | 1.0000 | 1.61340 | 44.27 |
| 14 | 171.7313 | (d14) | | |
| 15* | 53.7420 | 8.0508 | 1.85135 | 40.10 |
| 16* | −81.7253 | 0.1500 | | |
| 17 | 385.7122 | 1.0000 | 1.77047 | 29.74 |
| 18 | 38.4652 | 9.4584 | 1.59282 | 68.62 |
| 19 | −130.4543 | 0.1500 | | |
| 20 | 130.7756 | 7.0947 | 1.45860 | 90.19 |
| 21 | −55.2486 | (d21) | | |
| 22 | ∞ | 1.0000 | | |
| (diaphragm) | | | | |
| 23 | 55.5821 | 5.5016 | 1.49700 | 81.61 |
| 24 | −56.9481 | 1.0000 | 1.78472 | 25.72 |
| 25 | 42.3391 | (d25) | | |
| 26 | −139.5559 | 2.6016 | 1.49700 | 81.61 |
| 27 | −59.9232 | 1.0000 | 1.67300 | 38.26 |
| 28 | 77.1324 | (d28) | | |
| 29 | 71.1197 | 4.0378 | 1.94594 | 17.98 |
| 30 | −257.8344 | 0.1868 | | |
| 31 | 88.3966 | 5.5155 | 1.80610 | 40.73 |
| 32 | −53.9988 | 2.6345 | | |
| 33* | −198.4404 | 1.6147 | 1.80610 | 40.73 |
| 34* | 59.4646 | (BF) | | |
| image | ∞ | | | |
| surface | | | | |

[Aspherical surface data]

| | Surface 1 | Surface 2 | Surface 15 | Surface 16 | Surface 33 |
|---|---|---|---|---|---|
| K | 0.00000 | 0.00000 | 0.00000 | 0.00000 | 0.00000 |
| A4 | 7.81541E−06 | 8.14455E−06 | −3.69821E−06 | 2.29659E−06 | −3.47887E−06 |
| A6 | −9.93809E−09 | −7.63347E−09 | 4.45971E−10 | −1.03287E−09 | −2.64534E−08 |
| A8 | 7.52865E−12 | 1.42939E−12 | 1.16423E−12 | 1.96655E−12 | 2.95296E−11 |
| A10 | −3.60632E−15 | −1.55413E−16 | 0.00000E+00 | 0.00000E+00 | 0.00000E+00 |
| A12 | 8.33833E−19 | 0.00000E+00 | 0.00000E+00 | 0.00000E+00 | 0.00000E+00 |

| | 34 surface |
|---|---|
| K | 0.00000 |
| A4 | 5.66543E−06 |
| A6 | −2.37242E−08 |
| A8 | 2.51244E−11 |
| A10 | 0.00000E+00 |
| A12 | 0.00000E+00 |

[Various types of data]

| | |
|---|---|
| Zoom ratio | 1.51 |

| | Wide angle | Middle | Telephoto |
|---|---|---|---|
| Focal length | 28.85 | 34.97 | 43.65 |
| F number | 1.86 | 1.86 | 1.86 |
| Total angle of view 2ω | 76.25 | 63.04 | 50.53 |
| Image height Y | 21.63 | 21.63 | 21.63 |
| Total length of lens | 162.33 | 162.33 | 162.33 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d8 | 18.6422 | 10.6242 | 3.5907 |
| d12 | 12.8154 | 16.2059 | 16.2423 |
| d14 | 6.4537 | 4.3583 | 2.6081 |
| d21 | 1.0000 | 4.8080 | 8.8997 |
| d25 | 5.1875 | 7.5926 | 13.0126 |
| d28 | 2.8817 | 3.3916 | 2.6272 |
| BF | 26.8359 | 26.8359 | 26.8359 |

In a case of photographing magnification 1:40

| | | | |
|---|---|---|---|
| d0 | 1102.9005 | 1347.8982 | 1695.9129 |
| d8 | 18.6422 | 10.6242 | 3.5907 |
| d12 | 12.0729 | 15.5787 | 15.7213 |
| d14 | 7.1963 | 4.9854 | 3.1291 |
| d21 | 1.0000 | 4.8080 | 8.8997 |
| d25 | 5.1875 | 7.5926 | 13.0126 |
| d28 | 2.8817 | 3.3916 | 2.6272 |
| BF | 26.8359 | 26.8359 | 26.8359 |

[Lens group data]

| Group | Starting surface | Focal length |
|---|---|---|
| G1 | 1 | −45.75 |
| G2 | 9 | 85.28 |
| G3 | 13 | −53.39 |
| G4 | 15 | 28.90 |
| G5 | 22 | −72.32 |
| G6 | 26 | −65.23 |
| G7 | 29 | 39.13 |

### Numerical Example 8

Unit: mm
[Surface data]

| Surface | | | | |
|---|---|---|---|---|
| number | r | d | nd | vd |
| Object | ∞ | (d0) | | |
| surface | | | | |
| 1* | 82.5266 | 3.0487 | 1.69350 | 53.18 |
| 2* | 36.2990 | 3.7884 | | |
| 3 | 46.7945 | 2.0001 | 1.55200 | 70.70 |
| 4 | 30.5078 | 13.2730 | | |
| 5 | −80.2645 | 1.6514 | 1.59349 | 67.00 |
| 6 | 112.2046 | 0.1500 | | |
| 7 | 57.7050 | 4.4915 | 1.94594 | 17.98 |
| 8 | 123.9598 | (d8) | | |
| 9 | 60.9931 | 4.3075 | 1.75500 | 52.32 |
| 10 | 717.4604 | (d10) | | |
| 11 | −47.8401 | 1.0000 | 1.71700 | 47.98 |
| 12 | 312.3310 | (d12) | | |
| 13 | 81.4410 | 3.9454 | 1.95375 | 32.32 |
| 14 | 925.4696 | 0.3086 | | |
| 15* | 118.8010 | 6.2885 | 1.85135 | 40.10 |
| 16* | −88.7875 | 0.1500 | | |
| 17 | −200.2821 | 1.0000 | 1.72825 | 28.32 |
| 18 | 48.1183 | 8.4664 | 1.55032 | 75.50 |
| 19 | −189.7894 | 0.1500 | | |
| 20 | 138.4636 | 10.0407 | 1.45860 | 90.19 |
| 21 | −46.7727 | (d21) | | |
| 22 | ∞ | 1.0000 | | |
| (diaphragm) | | | | |
| 23 | 44.8318 | 6.3865 | 1.55032 | 75.50 |
| 24 | −60.8773 | 1.0000 | 1.84666 | 23.78 |
| 25 | 37.4078 | (d25) | | |
| 26 | −68.1433 | 2.9314 | 1.58913 | 61.25 |
| 27 | −32.9603 | 1.0000 | 1.61340 | 44.27 |
| 28 | 163.3201 | (d28) | | |
| 29 | 89.7384 | 3.1704 | 1.98612 | 16.48 |
| 30 | −370.7990 | 0.1500 | | |
| 31 | 90.6033 | 5.0445 | 1.88100 | 40.14 |
| 32 | −74.4172 | 6.9034 | | |
| 33* | −261.5985 | 3.0493 | 1.80610 | 40.73 |
| 34* | 80.4965 | (BF) | | |
| image | ∞ | | | |
| surface | | | | |

[Aspherical surface data]

| | Surface 1 | Surface 2 | Surface 15 | Surface 16 | Surface 33 |
|---|---|---|---|---|---|
| K | 0.00000 | 0.00000 | 0.00000 | 0.00000 | 0.00000 |
| A4 | 4.45612E−06 | 4.19561E−06 | −3.01951E−06 | 1.60051E−06 | 9.31498E−06 |
| A6 | −7.35312E−09 | −7.83666E−09 | 5.57287E−10 | 3.70925E−10 | −4.11172E−08 |
| A8 | 6.53333E−12 | 3.54901E−12 | −8.89539E−13 | −2.92734E−13 | 4.80031E−11 |
| A10 | −3.48030E−15 | −2.27814E−15 | 3.41066E−15 | 3.16457E−15 | −3.23261E−14 |
| A12 | 8.19092E−19 | 0.00000E+00 | −3.99452E−18 | −3.96270E−18 | 0.00000E+00 |

| | 34 surface |
|---|---|
| K | 0.00000 |
| A4 | 1.85247E−05 |
| A6 | −3.87392E−08 |
| A8 | 5.45102E−11 |
| A10 | −5.04663E−14 |
| A12 | 0.00000E+00 |

[Various types of data]

| | |
|---|---|
| Zoom ratio | 1.51 |

| | Wide angle | Middle | Telephoto |
|---|---|---|---|
| Focal length | 28.85 | 34.86 | 43.65 |
| F number | 1.86 | 1.86 | 1.86 |
| Total angle of view 2ω | 75.49 | 62.78 | 50.53 |
| Image height Y | 21.63 | 21.63 | 21.63 |
| Total length of lens | 167.96 | 167.96 | 167.96 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d8 | 19.1974 | 11.3471 | 3.5000 |
| d10 | 12.9069 | 15.5491 | 14.9091 |
| d12 | 6.3179 | 4.5085 | 3.3586 |
| d21 | 1.5500 | 5.4832 | 9.8349 |
| d25 | 5.1477 | 8.8955 | 16.2294 |
| d28 | 4.2072 | 3.5436 | 1.4950 |
| BF | 23.9358 | 23.9358 | 23.9358 |

In a case of photographing magnification 1:40

| | | | |
|---|---|---|---|
| d0 | 1105.8040 | 1346.7088 | 1699.9441 |
| d8 | 19.2374 | 11.4271 | 3.6720 |
| d10 | 12.0656 | 14.8055 | 14.2268 |
| d12 | 7.1191 | 5.1721 | 3.8689 |
| d21 | 1.5500 | 5.4832 | 9.8349 |
| d25 | 5.1477 | 8.8955 | 16.2294 |
| d28 | 4.2072 | 3.5436 | 1.4950 |
| BF | 23.9358 | 23.9358 | 23.9358 |

[Lens group data]

| Group | Starting surface | Focal length |
|---|---|---|
| G1 | 1 | −45.91 |
| G2 | 9 | 88.04 |
| G3 | 11 | −57.79 |
| G4 | 13 | 32.56 |
| G5 | 22 | −72.77 |
| G6 | 26 | −75.58 |
| G7 | 29 | 39.07 |

In addition, a list of corresponding values of the conditional expressions in each of these examples is shown.

TABLE 1

| | Conditional | | | | | | | | |
|---|---|---|---|---|---|---|---|---|---|
| | Expression/Example | EX1 | EX2 | EX3 | EX4 | EX5 | EX6 | EX7 | EX8 |
| (1) | −1.50 < f1/ft < −0.70 | −1.054 | −1.015 | −0.873 | −1.072 | −0.998 | −0.940 | −1.048 | −1.052 |
| (2) | vdG1 2 > 57.0 | 67.00 | 67.02 | 63.88 | 63.88 | 67.00 | 67.02 | 67.02 | 67.00 |
| (3) | 0.0 < (RLN1 + RLN2)/ | 0.45 | 0.28 | 0.31 | 0.31 | 0.51 | 0.69 | 0.54 | 0.53 |
| | (RLN1 − RLN2) < 1.0 | | | | | | | | |
| (4) | −2.0 < f2/f3 < −1.0 | −1.60 | −1.66 | −1.42 | −1.59 | −1.41 | −1.69 | −1.60 | −1.52 |
| (5) | 0.7 < (βMt/βMw)/ | 0.94 | 0.93 | 0.95 | 0.95 | 0.94 | 0.93 | 0.95 | 0.93 |
| | (ft/fw) < 1.2 | | | | | | | | |

The description of the above-mentioned examples describes an example of the zoom lens according to the embodiment of the present invention, and the present invention is not limited to the present example within a range not departing from the spirit of the present invention. Various design changes, modifications, combinations, and sub-combinations can be made, all of which are included in the scope of the present invention.

### DESCRIPTION OF REFERENCE NUMERALS AND SIGNS

G1: first lens group
G2: second lens group
G3: third lens group
G4: fourth lens group
G5: fifth lens group
G6: sixth lens group
G7: seventh lens group
G8: eighth lens group
GM: middle lens group
GR: rear lens group
GN: final lens group
LN: final lens
S: aperture diaphragm
I: image sensor

1. A zoom lens comprising, in order from an object side:
a first lens group G1 having a negative refractive power;
a middle lens group GM having a positive refractive power as a whole;
a rear lens group GR; and
a final lens group GN, wherein
the middle lens group GM includes three or more lens groups and includes a focus lens group that moves along an optical axis during focusing from infinity to a short distance,
the rear lens group GR includes one or more lens groups,
a distance between each of the groups changes during zooming from a wide-angle end to a telephoto end, the middle lens group GM moves toward the object side, and a distance between the middle lens group GM and the rear lens group GR is widened, and
the first lens group G1 and the final lens group GN are fixed in any of zooming and focusing.

2. The zoom lens according to claim 1, wherein
Conditional Expression (1) is satisfied,
$$- 1.5 < f 1 / ft < - 0.7 \qquad ( 1 )$$
where,
f1 is a focal length of the first lens group G1, and
ft is a telephoto end and a focal length of an entire system in an infinity focusing state.

3. The zoom lens according to claim 1, wherein
the first lens group G1 includes two or more negative lenses.

4. The zoom lens according to claim 3, wherein
Conditional Expression (2) is satisfied,
$$vdG1\_ 2 > 57. \qquad ( 2 )$$
where,
vdG1_2 is a second largest Abbe number among Abbe numbers of negative lenses arranged in the first lens group G1, and
in a case where two or more negative lenses having a largest Abbe number in the first lens group G1 are present, the largest Abbe number is stipulated by vdG1_2.

5. The zoom lens according to claim 1, wherein
a final lens LN closest to an image side in the final lens group GN has a negative refractive power, and Conditional Expression (3) is satisfied,
$$0. < ( RLN 1 + RLN 2 ) / ( RLN 1 - RLN 2 ) < 1. \qquad ( 3 )$$
where,
RLN1 is a curvature radius of an object side surface of the final lens LN, and
RLN2 is a curvature radius of an image side surface of the final lens LN.

6. The zoom lens according to claim 1, wherein
the middle lens group GM includes, in order from the object side, a second lens group G2 having a positive refractive power and a third lens group G3 having a negative refractive power, and at least one of the second lens group G2 or the third lens group G3 moves along an optical axis during focusing from the infinity to the short distance.

7. The zoom lens according to claim 6, wherein
the middle lens group GM includes a fourth lens group G4 having a positive refractive power.

8. The zoom lens according to claim 6, wherein
Conditional Expression (4) is satisfied,
$$- 2. < f 2 / f 3 < - 1. \qquad ( 4 )$$
where,
f2 is a focal length of the second lens group G2, and
f3 is a focal length of the third lens group G3.

9. The zoom lens according to claim 6, wherein
the second lens group G2 and the third lens group G3 each includes two or less lenses.

10. The zoom lens according to claim 1, wherein
Conditional Expression (5) is satisfied,
$$0.7 < ( β Mt / β Mw ) / ( ft / fw ) < 1.2 \qquad ( 5 )$$
where,
BMw is an imaging magnification of the middle lens group GM in a wide-angle end and an infinity focusing state,
BMt is an imaging magnification of the middle lens group GM in a telephoto end and an infinity focusing state,
fw is a focal length of an entire system in the wide-angle end and an infinity focusing state, and
ft is a focal length of the entire system in the telephoto end and an infinity focusing state.

11. The zoom lens according to claim 1, wherein
the middle lens group GM has six or more lenses.

12. The zoom lens according to claim 1, wherein
a boundary between the middle lens group GM and the rear lens group GR is a location where a lateral magnification of the rear lens group GR is maximum.

13. The zoom lens according to claim 1, wherein
the rear lens group GR includes an aperture diaphragm S.
